(19) United States
(12) Patent Application Publication
(10) Pub. No.: US 2012/0264884 A1
(43) Pub. Date: Oct. 18, 2012

(54) Amphiphobic Surfaces from Block Copolymers

(76) Inventors: Guojun Liu, Kingston (CA); Dean Xiong, Kingston (CA)

(21) Appl. No.: 13/445,430

(22) Filed: Apr. 12, 2012

(30) Foreign Application Priority Data
Apr. 12, 2011 (CN) 201110090620.5
May 20, 2011 (CN) 201110131477.X

(51) Int. Cl. C08F 220/68

(52) U.S. Cl. 525/276

(57) ABSTRACT

Provided are amphiphobic block copolymers, methods for preparing amphiphobic block copolymers, and applications thereof. Amphiphobic block copolymers can be used to prepare amphiphobic coatings on material surfaces, such as glass, printing paper or fabric. Amphiphobic block copolymers can also be used to coat particles, e.g., silica nanoparticles, which are then used to coat material surfaces. Such coated particles and uses thereof are also provided herein.

### FIELD OF THE INVENTION

This invention relates to amphiphobic block copolymers, methods for preparing same, and applications thereof for preparing amphiphobic surfaces. In particular, the invention relates to fluorinated, crosslinkable amphiphobic block copolymers.

### BACKGROUND OF THE INVENTION

Perfluorinated hydrocarbons and fluorinated polymers such as Teflon® possess low surface tension. Common liquids such as water and oil do not spread on these surfaces, which are considered to be amphiphobic, i.e., both hydrophobic (water-repelling) and lipophobic or oleophobic (fat- or oil-repelling). There are few examples of naturally-occurring amphiphobic surfaces.

Water droplets generally have contact angles 90° or larger on hydrophobic surfaces. Superhydrophobic surfaces comprise a material that allows water droplets to roll off easily when tilted at an angle of 10° or less relative to a horizontal surface, and have contact angles 150° or larger (Wang, S, and Jiang, L., Adv. Mater., 2007, 19: 3423-3424). In addition, the difference between advancing and receding contact angles (contact angle hysteresis) is small. When oil droplets also demonstrate this phenomenon or are repelled similarly on the surface of a particular material, the material is considered to be amphiphobic or superamphiphobic. Superamphiphobic materials have excellent repellent properties and are often referred to as “self-cleaning”.

One key criterion for amphiphobicity is that surface energy of a material is lower than surface energy of water or oil (Nosonovsky, M. and Bhushan, B., J. Phys.: Condens. Matter, 2008, 20; Bico, J. et al., Europhys. Lett, 1999, 47: 220-226; Chen, W. et al., Langmuir, 1999, 15: 3395-3399). Consequently, low-surface-energy fluorinated compounds or polymers are often used to prepare amphiphobic surfaces. However fluorinated compounds or polymers are expensive. A typical way to prepare a fluorinated surface is therefore to graft only a thin layer of a fluorinated compound onto a substrate without changing the bulk composition of the substrate. This can, for example, be achieved using coupling agents such as 1H,1H,2H,2H-perfluorodecyltriethoxysilane or 2-(perfluorooctyl)ethyl triethoxysilane (CF₃(CF₂)₇CH₂CH₂Si(OC₂H₅)₃ or FOETREOS). FOETREOS grafts onto a solid substrate because of a sol-gel reaction of reactive triethoxysilane groups. To modify silica or glass substrates that bear surface silanol groups (Si—OH), one can graft onto them a 2-(perfluorooctyl)ethyl triethoxysilane (CF₃(CF₂)₇CH₂CH₂Si(OC₂H₅)₃ (FOETREOS) layer (Sun, T. et al., J. Am. Chem. Soc., 2003, 125: 14996-14997). FOETREOS grafts onto these substrates because of the reactive triethoxysilane (TREOS) groups; TREOS undergoes sol-gel reactions, which involve hydrolysis of ethoxy groups to yield silanols and then condensation of different silanol groups to produce siloxane linkages (Si—O—Si) (Brinker, C. J. and Scherer, G. W., Sol-Gel Science: The Physics and Chemistry of Sol-Gel Processing, Academic Press, Inc.: Boston, 1990).

However, there are disadvantages for monolayer coatings prepared from FOETREOS and its analogues. First, a dense and uniform monolayer may not form. As in the case of FOETREOS, one silane group is tied to a long fluorinated tail, and steric hindrance associated with formation of a dense FOETREOS monolayer is large. Second, the monolayer may not be very stable or robust. Ideally, each tail in a FOETREOS layer is held on to the substrate or other reacted FOETREOS molecules by 3 siloxane bonds. Due to steric hindrance, not all of the siloxane bonds can be formed. Further, siloxane bonds are labile to hydrolysis, which leads to detachment of the tails. Third, a monolayer made of less than 10 CF₂ units is very thin, and can be easily penetrated by contaminants, etchants and stains.

Random copolymers containing fluorinated and crosslinkable units have been reported. Copolymers from vinylidene fluoride (CH₂═CF₂) and 1,1,2-trifluorovinyl-ethyl-trialkoxysilanes (CF₂═CF—(CH₂)₃Si(OR)₃) (Guiot, J. et al., Polym. Sci.: Part A: Polym. Chem., 2006, 44: 3896; US Patent Application Publication 2003/0176608A1); copolymers of tetrafluoroethylene (CF₂═CF₂) and 1,1,2-trifluorovinyl-ethyl-trialkoxysilanes (Japanese Patent No. 3-17087-A); and copolymers of hexafluoropropylene (CF₂═CF—CF₃) and 1,1,2-trifluorovinyl-ethyl-trialkoxysilanes (Japanese Patent No. 3-17088-A), have been reported. Preparations of fluorinated polymers or crosslinkable polymers have also been reported, but the two types of polymers have not been connected together or prepared in combination to yield block copolymers. Also, there have been reports on preparation of block copolymers containing either a fluorinated block or a crosslinkable block. Hirao et al. (Hirao, A. et al., Progr. Polym. Sci., 2005, 30:111-182) reviewed synthesis of some block copolymers containing fluorinated blocks. Block copolymers containing readily crosslinkable blocks have also been used by some groups (Templin, M. et al., Science, 1997, 278:1795-1798; Du, J. Z. et al., Chem. Int. Ed., 2004, 43:5084-5087; Guo, A. et al., Macromolecules, 1996, 29:2487-2493).

There is a need therefore for amphiphobic surface coatings which overcome at least some of the above-mentioned shortcomings of monolayer coatings. For example, it would be desirable to provide amphiphobic surface coatings which can endow materials with excellent hydrophobic and oleophobic properties and which are more robust or stable than available monolayer coatings.

### SUMMARY OF THE INVENTION

We report herein that some or all of the above shortcomings of small molecule coupling agents can be overcome using amphiphobic block copolymers containing at least one fluorinated polymer block and at least one anchoring polymer block, the at least one anchoring polymer block being capable of undergoing inter-polymer crosslinking, and optionally capable of covalently grafting with a substrate.

According to one aspect of the invention, there are provided herein amphiphobic block copolymers, e.g., amphiphobic fluorinated crosslinkable block copolymers. Methods for preparing amphiphobic block copolymers and applications thereof are also provided.

Amphiphobic block copolymers described herein provide certain advantages in comparison to amphiphobic surface coatings available in the art. For example, an amphiphobic block copolymer described herein may have one or more of the following properties: (1) it may be able to endow materials with excellent hydro/oleophobic properties; (2) it may be secured to a surface layer via grafting and/or crosslinking (for example, both fluorinated blocks and anchoring, e.g., crosslinkable blocks, may be simultaneously introduced into an amphiphobic block copolymer, such that while making use of fluorinated blocks to impart a material with amphiphobicity, a surface layer is also secured with grafting onto the surface and/or with internal cross-linking networks); (3) its production may be controlled to provide a copolymer with a precise structure, which can be used to impart a material with precision performance parameters (for example, controlled radical polymerization and/or living anionic polymerization may be used to prepare an amphiphobic block copolymer, which allows parameters such as polymer chain length, number of polymer blocks and so on to be precisely controlled); (4) it may provide amphiphobic coatings which are highly stable and/or durable, i.e., do not readily come off or degenerate; (5) it may allow for amphiphobic block copolymer monolayer coatings, which reduce coating consumption and are more economical; and/or (6) it may be provided as a Volatile Organic Compound (VOC)-free aqueous formulation or coated particle(s).

In many embodiments, amphiphobic block copolymers of the invention are amphiphobic diblock copolymers. In some embodiments, amphiphobic block copolymers of the invention are amphiphobic triblock copolymers.

In an embodiment, there are provided amphiphobic block copolymers comprising at least one fluorinated polymer block and at least one anchoring polymer block, wherein the at least one anchoring polymer block is capable of undergoing inter-polymer crosslinking, and optionally capable of covalently grafting with a substrate. An amphiphobic block copolymer may be, e.g., an amphiphobic diblock copolymer or an amphiphobic triblock copolymer. In some embodiments, the at least one anchoring polymer block comprises a grafting unit. In some embodiments, the at least one anchoring polymer block comprises a sol-gel forming unit, which is capable of undergoing inter-polymer crosslinking and covalently grafting with a substrate.

Amphiphobic block copolymers may comprise crosslinkable units which are photocrosslinkable, crosslinkable by sol-gel formation, thermo crosslinkable, redox crosslinkable and/or UV-crosslinkable. In some embodiments, crosslinkable blocks require an additive(s) for crosslinking.

Amphiphobic block copolymers may further comprise an end group (E) at the terminus of the at least one fluorinated polymer block. E may be, for example, fluorinated alkyl, CF₃(CF₂)₇CH₂CH₂, CF₃(CF₂)₅CH₂CH₂, C₈F₁₇(CH₂)₂O(CH₂)₃, CF₃(CF₂)₇CH₂CH₂OOCCH(CH₃), CF₃(CF₂)₅CH₂CH₂OOCCH(CH₃), CF₃(CF₂)₇CH₂CH₂OOCC(CH₃)₂, CF₃(CF₂)₅CH₂CH₂OOCC(CH₃)₂, H, OH, NH₂, SH, CO₂H, glycidyl, ketone, aldehyde, ester, aliphatic (e.g., alkyl), an adamantane group, a cyclodextrin group, an azobenzene group, Br, or Cl.

In some embodiments, fluorinated polymer blocks comprise 2-(perfluorooctyl)ethyl methacrylate (FOEMA) or 2-(perfluorohexyl)ethyl methacrylate. In some embodiments, fluorinated polymer blocks comprise fluorinated poly(alkyl acrylate), fluorinated poly(alkyl methacrylate), fluorinated poly(aryl acrylate), fluorinated poly(aryl methacrylate), fluorinated polystyrene, fluorinated poly(alkyl styrene), fluorinated poly(α-methyl styrene), fluorinated poly(alkyl α-methyl styrene), poly(tetrafluoroethylene), poly(hexafluoropropylene), fluorinated poly(alkyl acrylamide), fluorinated poly(vinyl alkyl ether), fluorinated poly(vinyl pyridine), fluorinated polyether, fluorinated polyester or fluorinated polyamide.

In an embodiment, an amphiphobic block copolymer has the structure shown in Formula X:

Aₘ-(FL)ₙ-E (X)

wherein A is an anchoring monomer unit; FL is a fluorinated monomer unit; E is an optional end group; m is 1 or greater than 1; and n is 1 or greater than 1; wherein A is capable of undergoing inter-polymer crosslinking, and optionally capable of covalently grafting with a substrate.

In an embodiment, an amphiphobic block copolymer has the structure shown in Formula XI:

(Xₓ-G_{100%-x})ₘ-(FL)ₙ-E (XI)

wherein X is a monomer unit that can undergo inter-polymer crosslinking; G is a grafting unit that can undergo a grafting reaction with a substrate; FL is a fluorinated monomer unit; E is an optional end group; x is from 0% to 100%; m is 1 or greater than 1; and n is 1 or greater than 1. In some embodiments, x is 1% or greater and less than 100%. In some embodiments, G is selected from the group consisting of anhydrides, acrylates, methacrylates, acid chlorides, glycidyl groups, silyl halide groups, epoxide groups, isocyanate groups and succinimide groups.

In an embodiment, an amphiphobic block copolymer has the structure shown in Formula XIII:

Xₘ-(FL)ₙ-E (XIII)

wherein X is a monomer unit that can undergo inter-polymer crosslinking; FL is a fluorinated monomer unit; E is an optional end group; m is 1 or greater than 1; and n is 1 or greater than 1.

In an embodiment, an amphiphobic block copolymer has the structure shown in Formula XIIa:

(S^{I1}ₓ—S^{I2}_{100%-x})ₘ—(FL)ₙ-E (XIIa)

wherein S^{I1} and S^{I2} are sol-gel forming monomer units that can undergo inter-polymer crosslinking, and S^{I1} and S^{I2} are the same or different; FL is a fluorinated monomer unit; E is an optional end group; x is from 0% to 100%; m is 1 or greater than 1; and n is 1 or greater than 1. In an embodiment, (S^{I1}ₓ—S^{I2}_{100%-x})ₘ has the formula:

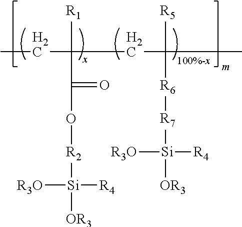

wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring, or methylene; x is from 0% to 100% or x is greater than 1%; and m is 1 or greater than 1. In an embodiment, S^{I1} and S^{I2} are the same. In an embodiment, S^{I1} and S^{I2} are different.

In an embodiment, an amphiphobic block copolymer has the structure shown in Formula XIIb:

S^{I}ₘ—(FL)ₙ-E (XIIb)

wherein S^{I} is a sol-gel forming monomer unit that can undergo inter-polymer crosslinking; FL is a fluorinated monomer unit; E is an optional end group; m is 1 or greater than 1; and n is 1 or greater than 1.

In an embodiment, an amphiphobic block copolymer has the structure shown in Formula I:

(S^{I}ₖ—Xₗ)ₘ—(FL)ₙ-E (I)

wherein S^{I} is a sol-gel forming monomer unit that can undergo inter-polymer crosslinking, X is a monomer unit that can undergo inter-polymer crosslinking, and S^{I} and X are not the same when both are present; FL is a fluorinated monomer unit; E is an optional end group; m is 1 or greater than 1; l is 0, 1 or greater than 1, k is 0, 1 or greater than 1, and l and k are not both zero; and n is 1 or greater than 1. In some embodiments, 1<k<200; 1<l<200; 1<m<200; and/or 1<n<200. In some embodiments, l is 0 and k is 1 or greater than 1. In some embodiments, m>>1, k<l and l=100%−k. In some embodiments, m is 10, n is 10, or both m and n are 10. In some embodiments, k is 0 and l is 1 or greater than 1. In some embodiments, m is 1 or greater than 1; n is 1 or greater than 1; l is 1 or greater than 1; and k is 1 or greater than 1.

A, X, S^{I1}, S^{I2} and/or S^{I} may be photocrosslinkable, crosslinkable by sol-gel formation, thermo crosslinkable, redox crosslinkable and/or UV-crosslinkable. In some embodiments, A, X, S^{I1}, S^{I2} and/or S^{I} require an additive(s) for crosslinking. In some embodiments, E is fluorinated alkyl, CF₃(CF₂)₇CH₂CH₂, C₈F₁₇(CH₂)₂O(CH₂)₃, alkyl, ester, H, Br or Cl. In some embodiments, S^{I} is a trialkoxysilane-containing unit, a dialkoxysilane-containing unit, or an IPSMA (3-(triisopropyloxysilyl)propyl methacrylate) unit. In some embodiments, X is photocrosslinkable, e.g., X may be 2-cinnamoyloxyethyl methacrylate (CEMA) or 2-cinnamoyloxyethyl acrylate (CEA). In some embodiments, FL is 2-(perfluorooctyl)ethyl methacrylate (FOEMA).

In some embodiments, E is fluorinated. E may be, for example, CF₃(CF₂)₇CH₂CH₂ or C₈F₁₇(CH₂)₂O(CH₂)₃. In other embodiments, E is not fluorinated. E may be, for example, alkyl, H, Br or CI.

In an embodiment, an amphiphobic block copolymer has the structure of Formula II:

S^{I}ₖ—(FL)ₙ-E (II)

wherein n is 1 or greater than 1; and k is 1 or greater than 1.

In an embodiment, an amphiphobic block copolymer comprises PIPSMA-b-PFOEMA.

In an embodiment, an amphiphobic block copolymer has the structure of Formula III:

Xₗ—(FL)ₙ-E (III)

wherein n is 1 or greater than 1; and l is 1 or greater than 1.

In an embodiment, an amphiphobic block copolymer comprises PCEMA-b-PFOEMA.

In an embodiment, an amphiphobic block copolymer has the structure of Formula IV:

S^{I}ₖ—Xₗ-(FL)ₙ-E (IV)

wherein n is 1 or greater than 1; l is 1 or greater than 1; and k is 1 or greater than 1.

In an embodiment, an amphiphobic block copolymer comprises PIPSMA-b-PCEMA-b-PF₈ H₂MA.

In an embodiment, an amphiphobic block copolymer comprises the structure of PIPSMA-b-PFOEMA:

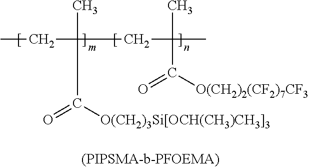

wherein m is 1 or greater than 1 and n is 1 or greater than 1.

In an embodiment, an amphiphobic block copolymer comprises the structure of P(IPSMA-r-CEMA)-b-PFOEMA:

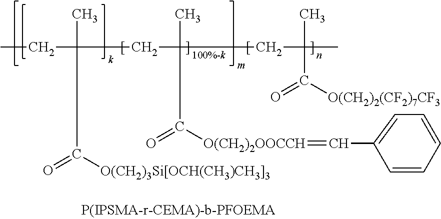

wherein m is 1 or greater than 1; n is 1 or greater than 1; k is from 0% to 100%; and r denotes random.

In an embodiment, an amphiphobic block copolymer comprises the structure of Formula V:

S^{I}ₘ-(FL)ₙ (V)

wherein:
S^{I} has the structure shown in Formula VI:

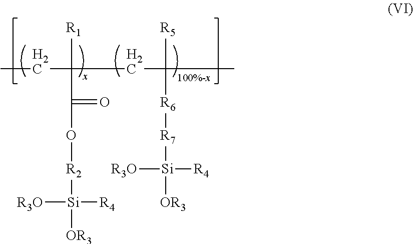

wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring or methylene; FL is (heptadecafluorooctyl)ethyl methacrylate; 1<m<200; 1<n<200; and x is between 0 and 100%. In an embodiment, S^{I} is 3-(triisopropyloxysilyl)propyl methacrylate.

In an embodiment, crosslinkable polymer blocks in amphiphobic block copolymers of the invention comprise a polyacetal polymer, a polyacrolein polymer, a poly(methyl isopropenyl ketone) polymer, a poly(vinyl methyl ketone) polymer, an aldehyde-terminated poly(ethylene glycol) polymer, a carbonylimidazole-activated polymer, a carbonyldiimidazole-terminated poly(ethylene glycol) polymer, a poly(acrylic anhydride) polymer, a poly(alkalene oxide/maleic anhydride) copolymer, a poly(azelaic anhydride) polymer, a poly(butadiene/maleic anhydride) copolymer, a poly(ethylene/maleic anhydride) copolymer, a poly(maleic anhydride) polymer, a poly(maleic anhydride/1-octadecene) copolymer, a poly(vinyl methyl ether/maleic anhydride) copolymer, a poly(styrene/maleic anhydride) copolymer, a poly(acrylolyl chloride) polymer, a poly(methacryloyl chloride) polymer, a chlorine-terminated polydimethylsiloxane polymer, a polyethylene-chlorinated polymer, a polyisoprene-chlorinated polymer, a polypropylene-chlorinated polymer, a poly(vinyl chloride) polymer, an epoxy-terminated polymer, an epoxide-terminated poly(ethylene glycol) polymer, an isocyanate-terminated polymer, an isocyanate-terminated poly(ethylene glycol) polymer, an oxirane functional polymer, a poly(glycidyl methacrylate) polymer, a hydrazide-functional polymer, a poly(acrylic hydrazide/methyl acrylate) copolymer, a succinimidyl ester polymer, a succinimidyl ester-terminated poly(ethylene glycol) polymer, a tresylate-activated polymer, a tresylate-terminated poly(ethylene glycol) polymer, a vinyl sulfone-terminated polymer, and/or a vinyl sulfone-terminated poly(ethylene glycol) polymer.

In an embodiment, at least one monomer unit in a crosslinkable polymer block in an amphiphobic block copolymer of the invention is photocrosslinkable. In an embodiment, at least one monomer unit in a crosslinkable polymer block is a trialkoxysilane-bearing block or trialkoxysilane.

In an aspect, there are provided herein amphiphobic coatings, e.g., on a substrate, comprising amphiphobic block copolymers of the invention. A substrate may be, for example, a particle, such as a silica particle.

In an aspect, there are provided herein methods for preparing an amphiphobic coating on a substrate, comprising: (a) solubilizing or dispersing an amphiphobic block copolymer in a solvent, optionally in the presence of a plasticizer and/or a different additive; (b) applying the solubilized or dispersed amphiphobic block copolymer to the substrate; (c) drying the substrate, such that the substrate is coated with the amphiphobic block copolymer; and (d) optionally heating the substrate or exposing the substrate to UV light so that the coating anneals. In an embodiment, a solvent is an organic solvent. A solvent may be, for example, trifluorotoluene (TFT) or tetrahydrofuran (THF). In an embodiment, a solvent is an aqueous solvent. A solvent may be, for example, water. In an embodiment, an amphiphobic block copolymer is solubilized or dispersed in the presence of a plasticizer, such as, e.g., dimethyl phthalate. In an embodiment, an amphiphobic block copolymer is solubilized or dispersed in the presence of an additive, such as, e.g., a thermo-initiator, a photo-initiator, a fluorinated initiator, a dihalogenated hydrocarbon, a diamine, a UV-absorber, a softener, a surfactant, an acid, a base or an anti-static compound. In an embodiment, a solubilized or dispersed amphiphobic block copolymer is applied to a substrate by spraying, brushing, painting, wiping, sponging, printing, stamping, rolling, dipping, spin-coating or electrostatic spraying, or a substrate is dipped or soaked in a solution containing a solubilized or dispersed amphiphobic block copolymer. A substrate may be dried, for example, by air-drying, by heating, by spontaneous solvent or water evaporation, or by solvent distillation. In an embodiment, a substrate is exposed to UV-light during or after drying.

In an embodiment, a substrate is a particle, and an amphiphobic coated particle is prepared. A particle may be, e.g., a silica particle, such that an amphiphobic coated silica particle is prepared. In an embodiment, methods provided herein further comprise a step of applying an amphiphobic coated particle or an amphiphobic coated silica particle to a second substrate, such that an amphiphobic coating is prepared on the second substrate. Methods may further comprise a step of solubilizing or dispersing an amphiphobic coated particle or an amphiphobic coated silica particle in a second solvent or in a formulation, before applying the amphiphobic coated particle or the amphiphobic coated silica particle to a second substrate. In some embodiments, particles or silica particles have a diameter of from about 0.01 to about 100 micrometers, from about 0.05 to about 60 micrometers, from about 0.1 to about 30 micrometers, or about 100 nanometers.

In an embodiment, a substrate is metal, metal oxide, ceramic, concrete, glass, masonry, stone, wood, wood composite, wood laminate, cardboard, paper, printing paper, semiconductor, plastic, rubber, leather or suede. In an embodiment, a second substrate is metal, metal oxide, ceramic, concrete, glass, masonry, stone, wood, wood composite, wood laminate, cardboard, paper, printing paper, semiconductor, plastic, rubber, leather, suede, fabric, fiber or textile. In an embodiment, a substrate is a fabric, fiber or textile. A fabric, fiber or textile may comprise, e.g., cotton, wool, polyester, linen, ramie, acetate, rayon, nylon, silk, jute, velvet, army fabric or vinyl. In an embodiment, a fabric, fiber or textile comprises natural fibers, synthetic fibers, or a mixture thereof. In an embodiment, a fabric, fiber or textile comprises cotton.

In an aspect, there are provided amphiphobic coatings prepared by methods described herein. In an embodiment, amphiphobic coatings are superhydrophobic and/or superoleophobic. In an embodiment, an amphiphobic coating has a water contact angle that is greater than about 90°, about 100°, about 110°, about 120°, about 130°, about 140°, about 150°, about 160°, about 165°, about 170°, or about 175°, when measured at 18° C. to 23° C. In an embodiment, an amphiphobic coating has an oil contact angle that is greater than about 90°, about 100°, about 110°, about 120°, about 130°, about 140°, about 150°, about 160°, about 165°, about 170°, or about 175°, when measured at 18° C. to 23° C. In an embodiment, an amphiphobic coating (i.e., an amphiphobic block copolymer coating) is an amphiphobic block copolymer monolayer on a substrate. In an embodiment, an amphiphobic coating has a thickness of about 3 nm to about 15 nm, about 3 nm to about 10 nm, about 3 nm, about 4 nm, about 5 nm, about 6 nm, about 7 nm, about 8 nm, about 10 nm, about 13 nm, about 15 nm, or about 20 nm.

In an embodiment, amphiphobic coatings have anti-wetting properties, anti-icing properties, anti-chemical adhesion properties, anti-corrosion properties, anti-bacterial properties, anti-fingerprint marking properties, and/or self-cleaning properties. In an embodiment, amphiphobic coatings are resistant to spills, stains, soiling, and/or etching. In an embodiment, amphiphobic coatings retain amphiphobicity after about 20, about 30, about 40, about 50, about 60, about 100, about 200, or more cycles of washing.

In an aspect, there are provided articles coated with amphiphobic block copolymers of the invention. There are also provided articles comprising amphiphobic coatings of the invention and articles prepared by methods described herein. In an embodiment, an article is a metal plate, a metal sheet, a metal ribbon, a wire, a cable, a box, an insulator for electric equipment wires or cables, a roofing material, a shingle, insulation, a pipe, cardboard, glass shelving, glass plates, printing paper, metal adhesive tape, plastic adhesive tape, paper adhesive tape, or fiber glass adhesive tape. In an embodiment, an article is a canvas, a tablecloth, a napkin, a kitchen apron, a lab coat, an insignia, a tie, a sock, hosiery, underwear, a garment, a jacket, a coat, a shirt, a pair of pants, a bathing suit, a shoe, upholstery, a curtain, a drapery, a handkerchief, a flag, a parachute, a backpack, a bedding item, a bedsheet, a bedspread, a comforter, a blanket, a pillow, a pillow covering, a fabric for outdoor furniture, a tent, car upholstery, a floor covering, a carpet, an area rug, a throw rug, or a mat.

In an embodiment, an article of the invention's breathability, flexibility, softness, feel and/or hand is substantially the same as that of an uncoated article. In an embodiment, an article of the invention has improved cleanability, durability, resistance to soiling, and/or resistance to stains, compared to an uncoated article.

In an aspect, there are provided compositions for applying amphiphobic coatings to substrates, comprising an amphiphobic block copolymer of the invention and a solvent, and optionally a plasticizer and/or another additive. In an embodiment, a solvent is an organic solvent. A solvent may be, for example, trifluorotoluene (TFT) or tetrahydrofuran (THF). In an embodiment, a solvent is an alkane, an alkene, an aromatic, an alcohol, an ether, a ketone, an ester, a halogenated alkane, a halogenated alkene, a halogenated aromatic, a halogenated alcohol, a halogenated ether, a halogenated ketone, a halogenated ester, or a combination thereof. In an embodiment, a solvent is an aqueous solvent. A solvent may be, for example, water. In an embodiment, a composition comprises a plasticizer. In an embodiment, a plasticizer is not water soluble and a composition is in an aqueous solution.

In some embodiments, a composition comprises a silica particle which has been coated with an amphiphobic block copolymer of the invention. In an embodiment, silica particles comprise about 90% of a composition on a weight basis.

In an embodiment, a composition is a coating formulation. In an embodiment, a composition comprises a coloring agent. A composition or coating formulation may be, for example, a water-based paint, an oil-based paint, a varnish, a finish, a resin, a polish, a paste, a wax or a gel. In an embodiment, an amphiphobic block copolymer comprises about 0.1% to about 5%, about 1% to about 15%, about 1% to about 3%, about 1% to about 5%, about 6% to about 10%, about 1% to about 15%, or about 0.5% to about 1% of a composition on a weight basis.

In an aspect, there are provided kits comprising compositions of the invention and instructions for use thereof to apply amphiphobic coatings to a substrate.

In an aspect, there are provided fabrics, fibers or textiles prepared by methods described herein. There are also provided fabrics, fibers or textiles comprising amphiphobic block copolymers of the invention or amphiphobic coatings of the invention. In an embodiment, a fabric, fiber or textile of the invention is superhydrophobic and/or superoleophobic. In an embodiment, a fabric, fiber or textile of the invention has improved resistance to soiling, improved resistance to stains, improved cleanability, improved alkaline resistance, improved acid resistance, and/or improved durability, compared to an uncoated fabric, fiber or textile. In an embodiment, a fabric, fiber or textile of the invention's breathability, flexibility, softness, feel and/or hand is substantially the same as that of an uncoated fabric, fiber or textile.

In an aspect, there are provided articles comprising fabrics, fibers or textiles of the invention. In an embodiment, an article is a canvas, a tablecloth, a napkin, a kitchen apron, a lab coat, an insignia, a tie, a sock, hosiery, underwear, a garment, a jacket, a coat, a shirt, a pair of pants, a bathing suit, a shoe, upholstery, a curtain, a drapery, a handkerchief, a flag, a parachute, a backpack, a bedding item, a bedsheet, a bedspread, a comforter, a blanket, a pillow, a pillow covering, a fabric for outdoor furniture, a tent, car upholstery, a floor covering, a carpet, an area rug, a throw rug, or a mat.

In an embodiment, a fabric, fiber or textile or an article of the invention retains amphiphobicity after 30 or more, or 100 or more, cycles of washing.

In an embodiment, a fabric, fiber or textile or an article of the invention repels oil or grease; resists soiling; resists wrinkling; has increased durability to dry cleaning and laundering compared to an uncoated fabric, fiber or textile or article; requires less cleaning than an uncoated fabric, fiber or textile or article; and/or dries faster than an uncoated fabric, fiber or textile or article. In an embodiment, a fabric, fiber or textile or article is or comprises cotton, wool, polyester, linen, ramie, acetate, rayon, nylon, silk, jute, velvet, army fabric or vinyl.

In an aspect, there are provided paints comprising amphiphobic block copolymers of the invention or compositions of the invention. In an embodiment, a paint is latex-based or water-based. In an embodiment, a paint is oil-based.

In an embodiment, an amphiphobic block copolymer comprises poly(3(triisopropyloxysilyl))propyl methacrylate-block-poly(heptadecaperfluorooctyl)ethyl methacrylate, wherein the number of repeat units of both monomers is about 10.

In an aspect, there are provided particles coated with amphiphobic block copolymers of the invention. In an embodiment, a particle is a silica particle, a nanoparticle, a metal oxide particle, a clay particle, a metal particle, wood dust, a cement particle, a salt particle, a ceramic particle, a sand particle, a mineral particle, a polymer particle or a microsphere.

In an embodiment, there is provided an amphiphobic fluorinated crosslinkable block copolymer having the structure shown in Formula I:

(S^{I})ₖ—(FL)ₙ (Ia)

wherein S^{I} is a sol-gel forming block, and is a structural unit containing two or three alkoxysilanes, and/or has the structure shown in Formula VI:

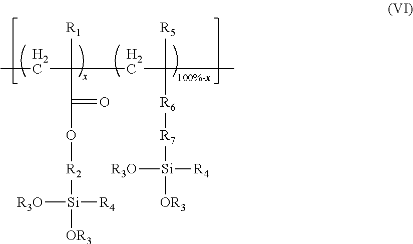

wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring or methylene; wherein FL is a fluorinated block, and is a structural monomer containing the element fluorine; 1<k<200; 1<n<200; and x is between 0 and 100%. In an embodiment, FL is (heptadecafluorooctyl)ethyl methacrylate or 2-(perfluorooctyl)ethyl methacrylate (FOEMA). In an embodiment, S^{I} is 3-(triisopropyloxysilyl))propyl methacrylate (IPSMA):

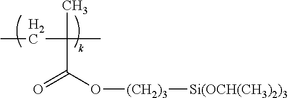

In an embodiment, an amphiphobic fluorinated crosslinkable block copolymer is poly(3(triisopropyloxysilyl))propyl methacrylate-block-poly(heptadecaperfluorooctyl)ethyl methacrylate, wherein the number of repeat units of both monomers is 10 (also referred to as (IPSMA)₁₀-(FOEMA)₁₀.

Amphiphobic block copolymers, e.g., amphiphobic fluorinated crosslinkable block copolymers, can be prepared through methods known in the art, such as controlled radical polymerization (e.g., atom transfer radical polymerization) and/or living anionic polymerization.

In an embodiment, poly(3-(triisopropyloxysilyl))propyl methacrylate-block-poly(heptadecafluorooctyl)ethyl methacrylate is prepared by the method of: at −78° C., adding 0.19 mL of 1,1-diphenylethylene to 250 mL anhydrous tetrahydrofuran, and thereafter adding 0.6 mL of a 1.4 mol/L hexane solution of sec-butyllithium; after 15 minutes, adding 2.59 mL of 3-(triisopropyloxysilyl)propyl methacrylate and polymerizing for 2 hours before adding 2.60 mL (heptadecafluorooctyl)ethyl methacrylate, polymerizing for a further 2 hours, and then adding 1.0 mL of anhydrous methanol to terminate polymerization; after raising the reaction temperature to 23° C., vacuum distilling to concentrate to 100 mL, and thereafter precipitating the polymer in methanol, filtering and drying to yield poly(3-(triisopropyloxysilyl))propylmethacrylate-block-poly(heptadecafluorooctyl)ethyl methacrylate.

In some embodiments, an amphiphobic fluorinated crosslinkable block copolymer is a white powder at room temperature, with density between 1.2 and 1.9 g/cm³. In some embodiments, a fluorinated block is insoluble in water, methanol, ethanol and other non-fluorinated organic solvents, and soluble in fluorinated organic solvents such as α,α,α-trifluorotoluene, and perfluorocyclohexane. Generally, when n in a polymer is less than 20, the fluorinated block is more likely to be soluble in general organic solvents such as tetrahydrofuran and chloroform.

Amphiphobic fluorinated crosslinkable block copolymers may be used in numerous applications, such as preparation of amphiphobic coatings on glass surfaces, printing paper, textiles, metals, particles, fibers, internal surfaces of tubular structures or cavities, wood, stone, clay, ceramics, or on polymers.

In an embodiment, an amphiphobic fluorinated crosslinkable block copolymer is used to prepare an amphiphobic coating on surfaces of glass or printing paper by a method comprising the steps of: (1) placing silica nanoparticles in α,α,α-trifluorotoluene, and carrying out ultrasonic dispersion, to obtain a silica nanoparticle dispersion; (2) while stirring, adding amphiphobic fluorinated crosslinkable block copolymer solution to the silica nanoparticle solution, followed by tetrahydrofuran, hydrochloric acid solution and water; reacting for 7 to 12 hours at 20 to 25° C., centrifuging the reaction product, and removing sediment to yield a modified silica nanoparticle crude product; (3) washing the modified silicasilica nanoparticle crude product with α,α,α-trifluorotoluene and then drying to obtain modified silica nanoparticles; and (4) dispersing the modified silica nanoparticles into α,α,α-trifluorotoluene to make up solution dispersion having modified silica nanoparticles in a concentration of 0.5 to 5 mg/mL; either directly adding the solution dropwise to a glass slide and after solvent evaporation forming a superamphiphobic coating on the surfaces of the glass slide; or, directly immersing printing paper in the solution, removing the sheets of paper and drying them to form a superamphiphobic coating on the surfaces thereof.

In an embodiment, during Step (2) of the above method, said amphiphobic fluorinated crosslinkable block copolymer has a 8 to 35% mass ratio relative to the silica nanoparticles, and said amphiphobic fluorinated crosslinkable block copolymer solution is a tetrahydrofuran solution having an amphiphobic fluorinated crosslinkable block copolymer concentration of 5.0 mg/mL. In another embodiment, during Step (2) of the above method, said tetrahydrofuran is present in the reaction system in a concentration of 9% by volume, and the molar ratio of IPSMA units, water and hydrochloric acid is 1:2:1 respectively, wherein said hydrochloric acid solution is a tetrahydrofuran solution having a hydrogen chloride concentration of 0.2 mol/L; and said reaction time is 10 hours. In another embodiment of the above method, the temperature used for drying the crude product in Step (3) is 100° C., and drying time is 2 hours; and in said α,α,α-trifluorotoluene solution of modified silica nanoparticles in Step (4), the concentration of modified silica nanoparticles is 2 mg/mL.

In an embodiment, reaction time in Step (2) is 10 hours. In an embodiment, in Step (3), the temperature used for drying said crude product is 100° C., and/or drying time is 2 hours. In Step (4), in an embodiment, said α,α,α-trifluorotoluene solution of modified silica nanoparticles has a concentration of modified silica nanoparticles of 2 mg/mL.

In an embodiment, amphiphobic coatings are prepared in a two-step process. First, silica nanoparticles are modified with an amphiphobic fluorinated crosslinkable block copolymer, wherein: (1) silica nanoparticles are placed in α,α,α-trifluorotoluene, and ultrasonic dissolution is carried out to obtain a silica nanoparticle solution; (2) while stirring, amphiphobic fluorinated crosslinkable block copolymer solution is added to the silica nanoparticle solution, followed by tetrahydrofuran, hydrochloric acid solution and water, before reacting for 7 to 12 hours at 20 to 25° C., centrifuging the reaction product, and removing sediment to yield a modified silica nanoparticle crude product; and (3) the modified silica nanoparticle crude product is washed with α,α,α-trifluorotoluene and then dried to obtain modified silica nanoparticles in the form of a white powder. Second, an amphiphobic coating is prepared using the polymer modified particles, wherein: (4) the modified silica nanoparticles are dispersed into α,α,α-trifluorotoluene to make up a solution having a modified silica nanoparticle concentration of 0.5 to 5 mg/mL; and (5) either the solution is directly added dropwise to a glass slide, after which solvent evaporation forms an amphiphobic coating on surfaces of the glass slide, or printing paper is directly immersed in the solution, and the sheets of paper are removed and dried to form an amphiphobic coating on surfaces thereof.

In an embodiment, amphiphobic fluorinated crosslinkable block copolymers are first used to coat particles, and then the coated particles are used to coat another substrate.

Silica nanoparticles recited in Step (1) of the above methods are prepared for example using the Stöber process (Stöber, W. et al., J. Colloid Interf. Sci., 1968, 26: 62). In isopropyl alcohol and with an aqueous ammonia catalyst, tetraethyl siloxane hydrolysis can yield silica nanoparticles of a certain particle size; the product is then centrifuged, separated and washed three times with isopropyl alcohol to remove the catalyst, unreacted reactants and by-products, before being vacuum dried to obtain a white powder.

In another embodiment, amphiphobic coatings are directly prepared from amphiphobic block copolymers on a surface of an object whose surface properties need to be modified.

In an aspect, anchoring or crosslinkable copolymer blocks provided herein can be grafted onto substrates or attached by means of crosslinking reactions. Numerous factors may be used to induce polymers to undergo crosslinking on a substrate, e.g., a particle; non-limiting examples of such factors include exposure to certain wavelengths of light, exposure to acids, or exposure to alkali substances. Crosslinking reactions may take place between structural units of a polymer chain, or grafting reactions may take place between a polymer chain and a substrate, e.g., a particle. Many structural units in a polymer chain are capable of being crosslinked and/or grafted. More than one of these may react with a substrate, such that a polymer film is grafted extremely firmly onto the substrate. Fluorinated polymer blocks may also extend from crosslinked parts to completely cover a material surface, thereby giving the material dense and durable coverage with low surface energy. At the same time, lengths of fluorinated blocks and anchoring blocks, e.g., crosslinkable blocks, may be adjusted as required; for example, length of anchoring blocks may be increased to enhance interactions between polymer and substrate, or to strengthen internal crosslinked networks, while length of fluorinated blocks may be increased to reinforce thickness of a fluorinated polymer film.

### BRIEF DESCRIPTION OF THE DRAWINGS

For a better understanding of the invention and to show more clearly how it may be carried into effect, reference is now made by way of example to the accompanying drawings, which illustrate aspects and features according to embodiments of the present invention, and in which:

FIG. 1 shows an ¹H-NMR spectrum of a PIPSPMA-b-PFOMA amphiphobic diblock copolymer (copolymer P1) synthesized as described in Example 1.

FIG. 2 shows TEM images of silica particles before (a) and after (b) coating by P1 under standard conditions.

FIG. 3 shows a comparison of AFM topography images of silica particles before (a) and after (b) coating by P1 at m_{P}/m_{S}=0.17 under otherwise standard conditions.

FIG. 4 shows hydrodynamic diameter distributions of silica particles before (a) and after (b) P1 coating under standard conditions; the solvents used for these two samples were methanol and TFT, respectively.

FIG. 5 shows a comparison of TGA curves for silica particles, sol-gelled P1, and silica particles coated by P1 under standard conditions.

FIG. 6 shows effect of varying reaction time (left) and HCl to IPSMA molar ratio (n_{HCl}/n_{Si}; right) on amount of P1 grafted onto silica particles under otherwise standard conditions.

FIG. 7 shows effect of varying water to Si molar ratio (n_{H2O}/n_{Si}; left) and THF volume fraction (f_{THF}; right) on amount of polymer grafted on silica prepared under otherwise standard conditions.

FIG. 8 shows effect of varying P1 to silica mass ratio (m_{P}/m_{S}) on grafted polymer amount under otherwise standard conditions.

FIG. 9 shows XPS spectra of silica (bottom), P1-coated silica (middle), and P1 (top).

FIG. 10 shows diffuse reflectance infrared spectra of P1 (top), silica particles (middle), and silica particles coated with P1 (bottom) under standard conditions.

FIG. 11 shows an AFM topography image of a P1-coated silica particle film on a glass plate.

FIG. 12 shows photographs of water droplets sitting on glass-plate-backed films prepared from silica (a) and silica bearing 1.2% (b), 4.8% (c), and 5.8% (d) of grafted P1 polymer, respectively.

FIG. 13 shows variation of water (•), CH₂I₂ (o), and hexadecane (□) droplet contact angles as a function of mP/mS used in coating silica particles with P1; P1-silica particle coatings were applied onto glass microscope slides.

FIG. 14 shows photographs of cooking oil and water droplets on surfaces of uncoated (left) and P1-coated (right) printing paper.

FIG. 15 shows schematic structures of P1-grafted silica particles prepared at low (a) and high (b) P1 to SiO₂ mass feed ratios; also depicted are packing of rod-like perfluorooctylethyl (FOE) groups and a PFOEMA backbone at high P1 grafting densities (c).

FIG. 16 shows a photograph of a polymerization flask used for synthesis of the amphiphobic block copolymer P1 in Example 1.

FIG. 17 shows SEM (a, b, and d) and AFM (c) images of cotton fabric and cotton fibers; (a)-(c) show cotton fabric and fibers before coating by P1, and (d) shows cotton fibers after P1 coating.

FIG. 18 shows variation in scattering intensity from 2.0 mL of a P1 solution at 1.5 mg/mL in THF after addition of 0.1 mL of a 14.0-M ammonia solution; (a) and (b) show data from two different runs.

FIG. 19 shows a comparison of TGA traces of cotton and sol-gelled P1 (a) and of cotton coated at different P1 concentrations in THF (b).

FIG. 20 shows changes in grafted P1 amount with P1 coating solution concentration in THF determined before (•) and after (o) removal of physically deposited polymer by trifluorotoluene extraction overnight.

FIG. 21 shows XPS spectra of uncoated cotton, P1-coated cotton, and PFOEMA.

FIG. 22 shows images of droplets of different liquids on cotton fabrics coated under standard conditions with P1. The water droplet was pink because of rhodamine B impregnation.

FIG. 23 shows a comparison of water and pump oil droplets immediately and 20 min and 3 days after their application on P1-coated cotton fabrics.

FIG. 24 shows variation in water (a) and diiodomethane (b) contact and rolling angles as a function of grafted P1 polymer amount on cotton fabric.

FIG. 25 shows a photograph demonstrating plastron layer formation between water and P1-coated cotton fabric.

FIG. 26 shows changes in water rolling angles as a function of washing cycles for silica-coated, PFOEMA-coated and P1-coated cotton fabric; gray symbols after the arrows denote data obtained after a cycle involving stirring the washed fabrics in de-ionized water overnight.

FIG. 27 shows images of droplets of concentrated H₂SO₄ on uncoated cotton (left) and on cotton fabric coated with P1.

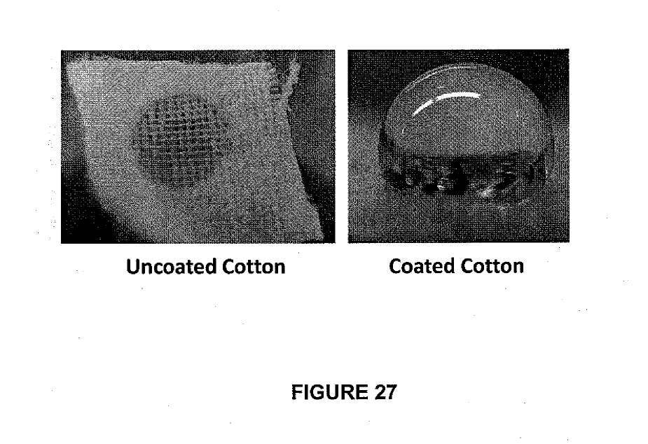

FIG. 28 shows photographs of H₂O (left), CH₂I₂ (middle), and CH₂Cl₂ (right) droplets on P1-coated cotton before (top row) and after (bottom row) stirring the cotton in 10 wt % detergent solution for 22 h.

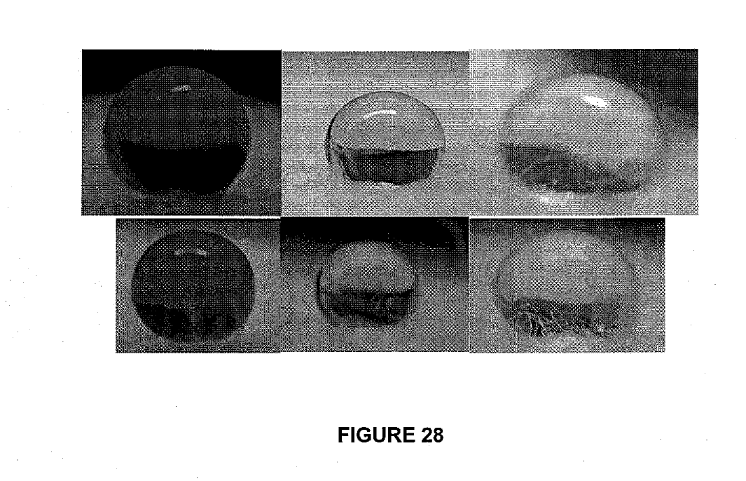

### DETAILED DESCRIPTION OF THE INVENTION

We provide herein amphiphobic block copolymers containing at least one fluorinated polymer block and at least one anchoring polymer block, and methods of use thereof for preparing amphiphobic surfaces and materials. Amphiphobic block copolymers of the invention can attach, via anchoring (e.g., crosslinkable or grafting) polymer blocks, onto surfaces of various substrates and confer amphiphobic properties on the substrates. Amphiphobic block copolymer monolayer coatings prepared using amphiphobic block copolymers and methods described herein are able to overcome at least some of the shortcomings of previous coatings, e.g., monolayer coatings.

Anchoring polymer blocks covalently graft onto a substrate surface and/or undergo inter-polymer crosslinking. An anchoring polymer block may thus comprise both crosslinkable blocks or units and grafting blocks or units. In some cases, a crosslinkable block may possess both crosslinking and grafting functionalities. In other cases, distinct crosslinking blocks or units and grafting blocks or units are included.

In other embodiments, anchoring polymer blocks undergo inter-polymer crosslinking without covalently grafting onto a substrate surface; in this case, anchoring blocks comprise crosslinkable blocks which do not possess grafting functionality. Such anchoring blocks are suitable for coating certain substrates where grafting is not required or not practical, such as particles or fibers. Without wishing to be bound by theory, inter-polymer crosslinking between crosslinkable blocks allows polymers to wrap around particles or fibers, eliminating the need for covalent grafting.

Without wishing to be bound by theory, crosslinkable blocks generally undergo ready crosslinking under irradiation or via moisture uptake from the atmosphere in the presence of a base or acid. A crosslinking reaction can thus occur among units of a crosslinkable block and/or between units of different crosslinkable blocks. In some embodiments, a crosslinkable block can also graft covalently to functional groups on a substrate surface. Grafting blocks, if present, covalently graft onto a substrate surface. Fluorinated blocks may extend from the substrate/anchoring block interface, providing low-energy, fluorinated blocks as an exposed top layer. Fluorinated blocks may thus remain on top of anchoring blocks and render oil and water repellence (amphiphobicity).

Amphiphobic block copolymer monolayer coatings of the invention can provide one or more advantages over previous monolayer coatings. For example, since the length of the two blocks (fluorinated polymer blocks and anchoring polymer blocks) can be adjusted independently, one can adjust binding strength to a substrate and thickness of a fluorinated layer independently. In an embodiment, amphiphobic block copolymer monolayer coatings are more robust or stable than those prepared from small-molecule coupling agents such as FOETROS, since the coatings are secured both via grafting and/or crosslinking with a substrate and via crosslinking between polymer chains. In other embodiments, amphiphobic surface coatings with a precise structure may be produced; for example, polymer chain length, number of polymer chains and/or other parameters may be controlled, allowing production of coatings with precision performance parameters. In further embodiments, amphiphobic surface coatings which are highly stable and/or durable (i.e., do not readily come off or degenerate) may be produced.

Amphiphobic block copolymers described herein provide certain advantages in comparison to amphiphobic surface coatings available in the art. For example, an amphiphobic block copolymer described herein may have one or more of the following properties: (1) it may be able to endow materials with excellent hydro/oleophobic properties; (2) it may be secured to a surface layer with crosslinking (for example, both fluorinated blocks and anchoring blocks may be simultaneously introduced into an amphiphobic block copolymer, such that while making use of fluorinated blocks to impart a material with amphiphobicity, the surface layer is also secured with crosslinking, optionally also with grafting); (3) its production may be controlled to provide a copolymer with a precise structure, which can be used to impart a material with precision performance parameters (for example, controlled radical polymerization and/or living anionic polymerization may be used to prepare an amphiphobic block copolymer, which allows parameters such as polymer chain length, number of polymer blocks and so on to be precisely controlled); (4) it may provide amphiphobic coatings which are highly stable and/or durable (i.e., do not readily come off or degenerate); and/or (5) it may be more cost-effective than existing coatings. For example, in an amphiphobic diblock copolymer, by tuning the lengths of two blocks independently, one can adjust separately the binding strength between a substrate and a coating, and the thickness of a fluorinated layer. Further, because of their inherent thickness and/or large number of crosslinkable units (e.g., trialkoxysilane units), amphiphobic block copolymer monolayer coatings may be more etchant-resistant than monolayers prepared from FOETREOS or other fluorinated small-molecule coupling agents.

In an embodiment, design and synthesis of an amphiphobic block copolymer comprising a fluorinated block and an anchoring block, e.g., a cross-linking block or a sol-gel forming block, is provided. It is shown further that, in some embodiments, under appropriate conditions, an anchoring block crosslinks onto silica particles, exposing a fluorinated block. We demonstrate that glass and paper substrates can be endowed with amphiphobic properties by coating with these silica particles. It is expected that any surface can be turned water and oil repellent by depositing these coated silica particles on it, and/or by directly depositing amphiphobic block copolymers of the invention.

Sol-gel processes are wet-chemical techniques widely used in the fields of materials science and ceramic engineering. Such methods are used primarily for the fabrication of materials starting from a colloidal solution (sol) that acts as the precursor for an integrated network (or gel) of either discrete particles or network polymers. In a sol-gel process, a fluid suspension of a colloidal solid (sol) gradually evolves towards the formation of a gel-like diphasic system containing both a liquid phase and a solid phase whose morphologies range from discrete particles to continuous polymer networks (for review, see Brinker, C. J. and Scherer, G. W., 1990, Sol-Gel Science: The Physics and Chemistry of Sol-Gel Processing, Academic Press, ISBN 0121349705; Hench, L. L. and West, J. K., 1990, The Sol-Gel Process, Chemical Reviews 90: 33). As used herein, “sol-gel forming” blocks or monomer units are blocks or monomer units which can undergo a sol-gel process to form a sol-gel state.

In one embodiment, we provide herein an amphiphobic diblock copolymer poly[3-(triisopropyloxysilyl)propyl methacrylate]-block-poly[2-(perfluorooctyl)ethyl methacrylate] (referred to herein as “PIPSMA-b-PFOEMA” or “P1”) and use thereof to prepare amphiphobic surfaces, including but not limited to coating of silica particles, glass, paper and textile fabrics. We report herein that depositing P1-coated silica particles onto glass or printing paper conferred amphiphobic properties on these surfaces, and show that films made of P1-coated silica particles were more resistant to NaOH etching than films made of FOETREOS-coated silica particles.

We report herein synthesis of an amphiphobic diblock copolymer, poly[3-(triisopropyloxysilyl)propyl methacrylate]-block-poly[2-(perfluorooctyl)ethyl methacrylate] (also referred to herein as “P1” or “PIPSMA-b-PFOEMA”), bearing a fluorinated PFOEMA block and an anchoring block, in this case a sol-gel forming PIPSMA block. P1 was synthesized by sequential anionic polymerization and was characterized. P1 was then used to coat silica particles. Factors affecting the amount of P1 grafted onto silica particles by sol-gel reactions of the PIPSMA block were investigated and coating conditions were optimized. At sufficiently high P1 to silica mass feed ratios, P1 chemically grafted onto silica surfaces to yield a monolayer. Monolayer formation was supported by results of thermogravimetric analyses, dynamic light scattering, atomic force microscopy, and transmission electron microscopy, and our X-ray photoelectron spectroscopy study suggested that the top of the monolayer comprised PFOEMA blocks. Depositing these particles onto microscope slides and printing paper yielded rugged silica films. These films were amphiphobic, and both water and oil droplets (e.g., cooking oil, diiodomethane, and hexadecane) possessed large contact angles on these coated surfaces. Films composed of P1-coated silica particles had substantial resistance to etching by aqueous NaOH solution.

“Contact angle” of water on a surface is the angle of the leading edge of a water droplet on the surface as measured from the center of the droplet. A surface with a contact angle of 180 degrees would mean that water sits on it as a perfect sphere. Hydrophobic surfaces generally have contact angles measured between about 90 degrees and 180 degrees. As used herein, a “hydrophobic” material or surface is one that results in a water droplet forming a surface contact angle of about 90° or greater at room temperature (about 18° C. to about 23° C.). A “superhydrophobic” material or surface is one that results in a water droplet forming a surface contact angle of about 150° or greater, at room temperature. Hydrophobic behavior is thus considered to include superhydrophobic behavior; as used herein, the term hydrophobic includes superhydrophobic, unless stated otherwise.

As used herein, an “oleophobic” or “lipophobic” material or surface is one that results in a droplet of oil (e.g., mineral oil, diiodomethane) forming a surface contact angle of about 90° or greater, at room temperature. The terms “oleophobic” and “lipophobic” are used interchangeably herein. “Superoleophobicity” means that an oil or diiodomethane droplet contact angle is about 150° or greater. In general, superoleophobicity is not as well-defined as superhydrophobicity because there are many different organic compounds such as diiodomethane, hexadecane, and cooking oil that can be called oils.

As used herein, an “amphiphobic” material or surface is one that is both hydrophobic and oleophobic or lipophobic. When the amphiphobic material or surface is superhydrophobic and superoleophobic, the material or surface is considered to be “superamphiphobic”. As used herein, amphiphobic behavior is considered to include superamphiphobic behavior, and the term amphiphobic includes superamphiphobic, unless stated otherwise.

In an embodiment, a material or surface is considered to be superamphiphobic when oil and water drops roll readily off the material or surface when the material or surface is tilted from the horizontal position at an angle of 10° or less.

It should be understood that the term “amphiphobic” is not limited to repelling only water and oil. In certain embodiments, an amphiphobic material or surface will repel not only water and oil but also other substances, such as fingerprints, salt, acid, base, bacteria, etc.

As used herein, “oil” refers to any substance that is liquid at ambient temperatures and does not mix with water but may mix with other oils and organic solvents. This general definition includes vegetable oils, plant oils, cooking oils, organic oils, mineral oils, volatile essential oils, petrochemical oils, petroleum-based oils, crude oils, naturally-occurring oils, synthetic oils and mixtures thereof. Oils may be clean or dirty. Oils may be found in a formulation with other substances, or may be pure or substantially pure.

In an embodiment, there are provided herein amphiphobic block copolymers comprising at least one fluorinated polymer block and at least one anchoring polymer block, wherein the at least one anchoring polymer block is capable of undergoing inter-polymer crosslinking, and optionally capable of covalently grafting with a substrate. Intra-polymer crosslinking may also occur. In many embodiments, amphiphobic block copolymers of the invention are amphiphobic diblock copolymers. In some embodiments, amphiphobic block copolymers are amphiphobic triblock copolymers.

In an embodiment, amphiphobic block copolymers of the invention have the structure shown in Formula X:

Aₘ-(FL)ₙ-E (X)

wherein A is an anchoring monomer unit; FL is a fluorinated monomer unit; E is an optional end group; m is 1 or greater than 1; and n is 1 or greater than 1; wherein A is capable of undergoing inter-polymer crosslinking, and optionally capable of covalently grafting with a substrate.

In an embodiment, amphiphobic block copolymers have the structure shown in Formula XI:

(Xₓ-G_{100%-x})ₘ-(FL)ₙ-E (XI)

wherein X denotes a monomer unit that can undergo inter-polymer crosslinking; G denotes a grafting unit that can undergo a grafting reaction with a substrate; FL denotes a fluorinated monomer unit; E denotes an optional end group; x is from 0% to 100%; m is 1 or greater than 1; and n is 1 or greater than 1.

In some embodiments, both X and G units are present.

In an embodiment of amphiphobic block copolymers according to the invention, a grafting unit G is maleic anhydride, glycidyl methacrylate or glycidyl acrylate. In another embodiment, a grafting unit G is selected from the groups consisting of anhydrides, acrylates, methacrylates, acid chlorides, glycidyl groups, silyl halide groups, triazole groups, epoxide groups, isocyanate groups and succinimide groups. In yet another embodiment, a grafting unit G is selected from: (i) aldehyde and ketone-functional polymers such as polyacetal polymers, polyacrolein polymers, poly(methyl isopropenyl ketone) polymers, poly(vinyl methyl ketone) polymers, aldehyde-terminated poly(ethylene glycol) polymers, carbonylimidazole-activated polymers, and carbonyldiimidazole-terminated poly(ethylene glycol) polymers; (ii) carboxylic acid anhydride-functional polymers such as poly(acrylic anhydride) polymers, poly(alkalene oxide/maleic anhydride) copolymers, poly(azelaic anhydride) polymers, poly(butadiene/maleic anhydride) copolymers, poly(ethylene/maleic anhydride) copolymers, poly(maleic anhydride) polymers, poly(maleic anhydride/1-octadecene) copolymers, poly(vinyl methyl ether/maleic anhydride) copolymers, and poly(styrene/maleic anhydride) copolymers; (iii) carboxylic acid chloride-functional polymers such as poly(acrylolyl chloride) polymers and poly(methacryloyl chloride) polymers; and (iv) chlorinated polymers such as chlorine-terminated polydimethylsiloxane polymers, chlorinated polyethylene polymers, chlorinated polyisoprene polymers, chlorinated polypropylene polymers, poly(vinyl chloride) polymers, epoxy-terminated polymers, epoxide-terminated poly(ethylene glycol) polymers, isocyanate-terminated polymers, isocyanate-terminated poly(ethylene glycol) polymers, oxirane functional polymers, poly(glycidyl methacrylate) polymers, hydrazide-functional polymers, poly(acrylic hydrazide/methyl acrylate) copolymers, succinimidyl ester polymers, succinimidyl ester-terminated poly(ethylene glycol) polymers, tresylate-activated polymers, tresylate-terminated poly(ethylene glycol) polymers, vinyl sulfone-terminated polymers and vinyl sulfone-terminated poly(ethylene glycol) polymers. In one embodiment, a grafting unit G is a sol-gel forming unit. In other embodiments, grafting to metal substrates is provided. Suitable groups that complex with metals include, without limitation, triazole groups, carboxyl groups, and amine groups.

In another embodiment, grafting units G are absent, and amphiphobic block copolymers have the structure shown in Formula XIII:

Xₘ-(FL)ₙ-E (XIII)

wherein X, FL, E, m and n are as defined above.

In another embodiment, an anchoring block (A) comprises a sol-gel forming monomer unit, which possesses both a crosslinking function and a grafting function. In this embodiment, amphiphobic block copolymers have the structure shown in Formula XIIa:

(S^{I1}ₓ—S^{I2}_{100%-x})ₘ—(FL)ₙ-E (XIIa)

wherein S^{I1} and S^{I2} denote different sol-gel forming monomer units, and FL, E, x, m and n are as defined above. (S^{I1}_{X}—S^{I2}_{100%-x})ₘ can, for example, have the following notation:

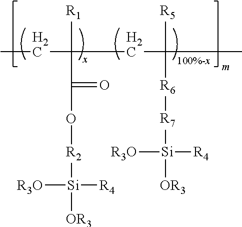

wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring, or methylene; x is 1% or greater than 1%; and m is 1 or greater than 1. In an embodiment, S^{I1} is the same as S^{I2}, and amphiphobic block copolymers have the structure shown in Formula XIIb:

S^{I}ₘ—(FL)ₙ-E (XIIb)

wherein S^{I} denotes a sol-gel forming monomer unit that can undergo inter-polymer crosslinking, and FL, E, m and n are as defined above.

In another embodiment, amphiphobic block copolymers comprise at least one fluorinated polymer block and at least one anchoring polymer block, wherein the anchoring block may comprise different crosslinkable monomer units. In this embodiment, amphiphobic block copolymers have the structure shown in Formula I:

(S^{I}ₖ—X_{I})ₘ-(FL)ₙ-E (I)

wherein S^{I} and X denote different monomer units that can undergo inter-polymer crosslinking, and S^{I} denotes a sol-gel forming monomer unit; FL is a fluorinated monomer unit; E is an optional end group; m is 1 or greater than 1; l is 0, 1 or greater than 1; k is 0, 1 or greater than 1; n is 1 or greater than 1; and/and k are not both zero. When S^{I} and X are both present, an amphiphobic block copolymer may comprise an S^{I} and X random copolymer block, or two separate S^{I} and X blocks. Such copolymers may provide high stability under basic or acidic conditions in the presence of moisture; since Si—O—Si bonds are known to be labile towards hydrolysis under basic or acidic conditions in the presence of moisture, crosslinked X units may provide extra resistance to hydrolysis.

In an embodiment of Formula I, 1<k<200. In another embodiment of Formula I, 1<l<200.

In some embodiments, for amphiphobic block copolymers of Formulae X, XI, XIII, XIIa, XIIb, and I: 1<m<200. In some embodiments, for amphiphobic block copolymers of Formulae X, XI, XIII, XIIa, XIIb, and I: 1<n<200. In some embodiments, for amphiphobic block copolymers of Formulae X, XI, XIII, XIIa, XIIb, and I: m is 10, n is 10, or both m and n are 10.

In an embodiment, crosslinkable units can be crosslinked by themselves without need for additives such as, for example, acids, bases, catalysts and/or initiators. Non-limiting examples include photocrosslinkable or UV-crosslinkable polymers that can be crosslinked when subject to photolysis. These polymers may contain, for example, cinnamate, coumarin, chalcone, diacetylene, anthracene, or maleimide pendant groups. 2-Cinnamoyloxyethyl methacrylate (CEMA) and 2-cinnamoyloxyethyl acrylate (CEA) are examples of such units. CEMA and CEA units in a polymer can absorb light and dimerize via a biradical mechanism. Dimerization of two CEMA or CEA units of different polymer chains leads to chain coupling, and the coupling of multiple chains leads eventually to a crosslinked polymer network. Polymers that bear pendant double bonds can also be crosslinked thermally. Heating a polymer can lead to radical formation, and the generated radicals can polymerize pendant double bonds of the polymer chains, resulting in polymer crosslinking. For example, a reaction between hydroxyl groups of poly(2-hydroxyethyl acrylate) and acryloyl chloride will introduce acrylate pendant groups. These acrylate pendant double bonds are very active and can be crosslinked readily by thermally-generated free radicals. These pendant groups can be crosslinked thermally at temperatures such as, for example, 120° C. without need for radical initiators. Therefore, it is expected that any polymer containing active pendant acrylate, methacrylate, and/or styryl units can be thermally crosslinkable. In an embodiment, a crosslinkable unit is crosslinked by UV light. In another embodiment, a crosslinkable unit is crosslinked thermally.

In another embodiment, crosslinkable units include polymers that require additive(s), e.g., acids, bases, catalysts, and/or initiators, for crosslinking. For example, PIPSMA can be crosslinked via sol-gel chemistry after the addition of an acid or base as the catalyst. Pendant double bonds of polybutadiene and polyisoprene are not as reactive as the double bonds of pendant acrylate or methacrylate units, and therefore to crosslink these double bonds, a thermo-initiator such as, for example, benzoyl peroxide or a photo-initiator such as, for example, 1-hydroxycyclohexyl phenyl ketone will need to be added before these polymers can be crosslinked thermally or photochemically. Another example is poly(vinyl pyridine), which can be crosslinked thermally in the presence of dihalogenated hydrocarbons such as, for example, 1,4-dibromobutane. Poly(acrylic acid) can be crosslinked using diamines such as, for example, 1,6-hexamethylene diamine via amidization. In some embodiments, crosslinkable units are redox-crosslinkable. For example, free radicals can be generated from a redox reaction and used to crosslink polymers such as polybutadiene and polyisoprene. A non-limiting example of such an initiating system is TEMED and ammonium persulfate.

In an embodiment, a crosslinkable unit is a trialkoxysilane-containing unit, a dialkoxysilane-containing unit, or an IPSMA (3-(triisopropyloxysilyl)propyl methacrylate) unit.

Non-limiting examples of grafting (G) monomer units include maleic anhydride, glycidyl methacrylate, and glycidyl acrylate units. Other examples include anhydrides, acrylates, methacrylates, acid chlorides, glycidyl groups, silyl halide groups, epoxide groups, isocyanate groups and succinimide groups.

In an embodiment, FL is 2-(perfluorooctyl)ethyl methacrylate (FOEMA), also called (heptadecafluorooctyl)ethyl methacrylate. In another embodiment, FL is 2-(perfluorohexyl)ethyl methacrylate.

In another embodiment, FL is fluorinated poly(alkyl acrylate) (for example, poly[2-(perfluorohexyl)ethyl acrylate]), fluorinated poly(alkyl methacrylate) (for example, poly[2-(perfluorohexyl)ethyl methacrylate]), fluorinated poly(aryl acrylate), fluorinated poly(aryl methacrylate), fluorinated polystyrene, fluorinated poly(alkyl styrene), fluorinated poly(α-methyl styrene), fluorinated poly(alkyl α-methyl styrene), poly(tetrafluoroethylene), poly(hexafluoropropylene), fluorinated poly(alkyl acrylamide), fluorinated poly(vinyl alkyl ether), fluorinated poly(vinyl pyridine), fluorinated polyether, fluorinated polyester or fluorinated polyamide.

In one embodiment, when FL is fluorinated poly(alkyl acrylate) or fluorinated poly(alkyl methacrylate), the alkyl groups can have the following structure: CF₃(CF₂)nCH₂CH₂—, where 0≦n≦20, 0≦n≦7 or 1≦n≦5.

In another embodiment, FL is (CF₃)₂CF(CF₂)₂CH₂CH₂—, where 0≦n≦20, 0≦n≦7 or 1≦n≦3.

In an embodiment, FL is a fluorinated monomer unit selected from the groups consisting of fluorinated acrylates, fluorinated diacrylates, fluorinated methacrylates, fluorinated dimethacrylates, fluorinated allyls, fluorinated vinyls, fluorinated maleates, and fluorinated itaconates.

In an embodiment, fluorinated polymer blocks in amphiphobic block copolymers of the invention comprise fluorinated polyacrylates. Fluorinated polyacrylates may comprise monomers such as, for example, fluorohexyl acrylate, fluoroaryl acrylate, 2-(perfluorooctyl)ethyl acrylate, heptafluorobutyl acrylate, 1H,1H,9H-hexadecafluorononyl acrylate, 2,2,3,4,4,4-hexafluorobutyl acrylate, hexafluoroisopropyl acrylate, 1H,1H,5H-octafluoropentyl acrylate, pentafluorobenzyl acrylate, pentafluorophenyl acrylate, perfluorocyclohexyl methyl acrylate, perfluoroheptoxypoly(propyloxy) acrylate, perfluorooctyl acrylate, 1H,1H-perfluorooctyl acrylate, 2,2,3,3-tetrafluoropropyl acrylate, 2,2,2-trifluoroethyl acrylate, 3-(trifluoromethyl)benzyl acrylate, 2-(N-butylperfluorooctanesulfamido) ethyl acrylate, 1H,1H,7H-dodecafluoroheptyl acrylate, 1H,1H,11H-eicosafluoroundecyl acrylate, trihydroperfluoroundecyl acrylate, trihydroperfluoroheptyl acrylate, and/or 2-(N-ethylperfluorooctane sulfamido) ethyl acrylate.

In another embodiment, fluorinated polymer blocks in amphiphobic block copolymers of the invention comprise fluorinated polymethacrylates. Fluorinated polymethacrylates may comprise monomers such as, for example, 2-(perfluorooctyl)ethyl methacrylate (FOEMA), fluorohexyl methacrylate, fluoroaryl methacrylate, 1H,1H,7H-dodecafluoroheptyl methacrylate, trihydroperfluoroheptyl methacrylate, trihydroperfluoroundecyl methacrylate, 2-(N-ethylperfluorooctane sulfamido) ethyl methacrylate, tetrahydroperfluorodecyl methacrylate, 1H,1H-heptafluoro-n-butyl methacrylate, 1H,1H,9H-hexadecafluorononyl methacrylate, 2,2,3,4,4,4-hexafluorobutyl methacrylate, hexafluoroisopropyl urethane of isocyanatoethyl methacrylate, 1H,1H,5H-octafluoropentyl methacrylate, pentafluorobenzyl methacrylate, pentafluorophenyl methacrylate, perfluorocyclohexylmethyl methacrylate, perfluoroheptoxypoly(propyloxy)methacrylate, 1H,1H-perfluorooctyl methacrylate, 2,2,3,3-tetrafluoropropyl methacrylate, 2,2,2-trifluoroethyl methacrylate, 3-(trifluoromethyl)benzyl methacrylate, and/or hexafluoroisopropyl methacrylate.

In another embodiment, fluorinated polymer blocks in amphiphobic block copolymers of the invention comprise fluorinated polydiacrylates. Fluorinated polydiacrylates may comprise monomers such as, for example, hexafluoro bisphenol diacrylate, 2,2,3,3,4,4,5,5-octafluoro-1,6-hexanediol diacrylate, polyperfluoroethylene glycol diacrylate, and/or 2,2,3,3-tetrafluoro-1,4-butanediol diacrylate.

In another embodiment, fluorinated polymer blocks in amphiphobic block copolymers of the invention comprise fluorinated polydimethacrylates. Fluorinated polydimethacrylates may comprise monomers such as, for example, hexafluoro bisphenol a dimethacrylate, 2,2,3,3,4,4,5,5-octafluoro-1,6-hexanediol dimethacrylate, perfluorocyclohexyl-1,4-dimethyl dimethacrylate, polyperfluoroethylene glycol dimethacrylate, and/or 2,2,3,3-tetrafluoro-1,4-butanediol dimethacrylate.

In another embodiment, fluorinated polymer blocks in amphiphobic block copolymers of the invention comprise fluorinated allyl polymer blocks. Fluorinated allyl polymer blocks may comprise monomers, such as, for example, allyl heptafluorobutyrate, allyl heptafluoroisopropyl ether, allyl 1H,1H-pentadecafluorooctyl ether, allylpentafluorobenzene, allyl perfluoroheptanoate, allyl perfluorononanoate, allyl perfluorooctanoate, allyl tetrafluoroethyl ether, and/or allyl trifluoroacetate.

In another embodiment, fluorinated polymer blocks in amphiphobic block copolymers of the invention comprise fluorinated itaconate polymer blocks. Fluorinated itaconate polymer blocks may comprise monomers such as, for example, bis(hexafluoroisopropyl) itaconate, bis(perfluorooctyl)itaconate, bis(trifluoroethyl) itaconate, mono-perfluorooctyl itaconate, trifluoroethyl acid itaconate, and/or hexafluoroisopropylitaconate.

In another embodiment, fluorinated polymer blocks in amphiphobic block copolymers of the invention comprise fluorinated maleate polymer blocks. Fluorinated maleate polymer blocks may comprise monomers such as, for example, bis(perfluorooctyl)maleate, bis(Hexafluoroisopropyl) maleate, bis(2,2,2-trifluoroethyl) maleate, mono-hexafluoroisopropyl maleate, mono-perfluorooctyl maleate, and/or mono-trifluoroethyl acid maleate.

In another embodiment, fluorinated polymer blocks in amphiphobic block copolymers of the invention comprise fluorinated polystyrene blocks. Fluorinated polystyrene blocks may comprise monomers such as, for example, fluoroalkyl styrene, fluoro-(α-methyl styrene), fluoroalkyl-α-methyl styrene, m-fluorostyrene, o-fluorostyrene, p-fluorostyrene, and/or pentafluorostyrene.

In another embodiment, fluorinated polymer blocks in amphiphobic block copolymers of the invention comprise fluorinated polyvinyl blocks. Fluorinated polyvinyl blocks may comprise monomers such as, for example, 1-(trifluoromethyl) vinyl acetate, 4-vinylbenzyl hexafluoroisopropyl ether, 4-vinylbenzyl perfluorooctanoate, 4-vinylbenzyl trifluoroacetate, vinyl heptafluorobutyrate, vinyl perfluoroheptanoate, vinyl perfluorononanoate, vinyl perfluorooctanoate, and/or vinyl trifluoroacetate.

In an embodiment, FL is a fluorinated monomer unit selected from 1H,1H-heptafluorobutylmethacrylamide, 2-N-heptafluorobutyrylamino-4,6-dichlorotriazine, epifluorohydrin, perfluorocyclopentene, tridecafluoro-1,1,2,2-tetrahydrooctyl-1,1-methyl dimethoxy silane, and tridecafluoro-1,1,2,2-tetrahydrooctyl-1-dimethyl methoxy silane.

In some embodiments of amphiphobic block copolymers of the invention, a fluorinated monomer unit FL comprises alkyl groups as defined herein. For example, fluorinated monomer units may comprise one or more alkyl groups having C₅ to C₂₀ alkyl, C₅ to C₁₀ alkyl, C₅ to C₈ alkyl, C₅ to C₁₅ alkyl, C₈ to C₂₀ alkyl, C₅ alkyl, C₆ alkyl, C₇ alkyl, C₈ alkyl, C₉ alkyl, or C₁₀ alkyl. Such alkyl groups may be substituted or unsubstituted. One or more hydrogen atoms of an alkyl group may be replaced by halogen atoms, such as fluorine, bromine or chlorine atoms. Alkyl groups may be “fluoroalkyl” groups, i.e., alkyl groups in which some or all of the hydrogen atoms have been replaced by fluorine atoms, or “perfluoroalkyl” groups, i.e., alkyl groups in which fluorine atoms have been substituted for each hydrogen atom. In a particular embodiment, a fluorinated monomer unit FL comprises a C₆ alkyl. In another particular embodiment, a fluorinated monomer unit FL comprises a C₈ alkyl. It should be understood that, as used herein, “unsubstituted” refers to any open valence of an atom being occupied by hydrogen.

E may be fluorinated or not fluorinated. In an embodiment, E is fluorinated and is a CF₃(CF₂)₇CH₂CH₂— or a C₅F₁₇(CH₂)₂O(CH₂)₃ unit. In one embodiment, E is a fluorinated alkyl, e.g., fluorinated C₄ to C₁₂ alkyl, C₆ alkyl, C₈ alkyl or C₁₀ alkyl. In another embodiment, E is not fluorinated and is aliphatic (e.g., alkyl, e.g., C₄ to C₁₂ alkyl, C₆ alkyl, C₈ alkyl or C₁₀ alkyl), H, Br or Cl. In a further embodiment, E is CF₃(CF₂)₇CH₂CH₂, CF₃(CF₂)₅CH₂CH₂, C₈F₁₇(CH₂)₂O(CH₂)₃, CF₃(CF₂)₇CH₂CH₂OOCCH(CH₃), CF₃(CF₂)₅CH₂CH₂OOCCH(CH₃), CF₃(CF₂)₇CH₂CH₂OOCC(CH₃)₂, CF₃(CF₂)₅CH₂CH₂OOCC(CH₃)₂, H, OH, NH₂, SH, CO₂H, glycidyl, ketone, aldehyde, aliphatic (e.g., alkyl), ester, an adamantane group, a cyclodextrin group, an azobenzene group, Br, or Cl.

In an embodiment of Formula I, m is 1; n is 1 or greater than 1; l is 0; and k is 1 or greater than 1. In this case, Formula I denotes an amphiphobic diblock copolymer of Formula II:

S^{I}ₖ—(FL)ₙ-E (II).

In an embodiment, an amphiphobic diblock copolymer of Formula II is PIPSMA-b-FOEMA.

In another embodiment of Formula I, m is 1; n is 1 or greater than 1; k is 0; and l is 1 or greater than 1. In this case, Formula I denotes an amphiphobic diblock copolymer of Formula III:

Xₗ—(FL)ₙ-E (III).

In an embodiment, an amphiphobic diblock copolymer of Formula III is PCEMA-b-PFOEMA.

In another embodiment of Formula I, m is 1; n is 1 or greater than 1; k is 1 or greater than 1; and l is 1 or greater than 1. In this case, Formula I denotes an amphiphobic triblock copolymer of Formula IV:

S^{I}ₖ—Xₗ—(FL)ₙ-E (IV).

In an embodiment, an amphiphobic triblock copolymer of Formula IV is PIPSMA-b-PCEMA-b-PFOEMA.

In another embodiment, an amphiphobic block copolymer has the structure of PIPSMA-b-PFOEMA:

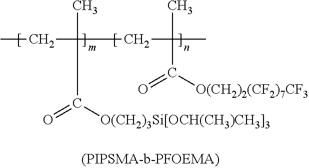

wherein m is 1 or greater than 1 and n is 1 or greater than 1.

In another embodiment, an amphiphobic block copolymer has the structure shown in Formula V:

S^{I}ₘ—(FL)ₙ (V)

wherein:
S^{I} has the structure shown in Formula VI:

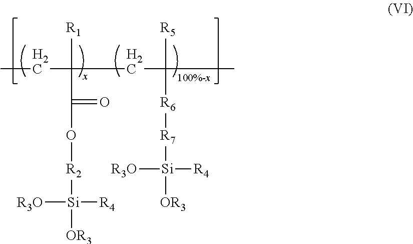

wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; and R₆ is an aromatic ring, pyridine ring, pyran ring, furan ring or methylene;
FL is (heptadecafluorooctyl)ethyl methacrylate;
1<m<200;
1<n<200; and
x is between 0 and 100%.

In another embodiment, an amphiphobic block copolymer of the invention has the structure of Formula Z:

Gₘ-(FL)ₙ-E (Z)

wherein G, FL, E, m and n are as defined above.

In an embodiment, an amphiphobic block copolymer has the structure shown in Formula V, wherein S^{I} is 3-(triisopropyloxysilyl)propyl methacrylate.

In another embodiment, an amphiphobic block copolymer is poly(3(triisopropyloxysilyl))propyl methacrylate-block-poly(heptadecaperfluorooctyl)ethyl methacrylate, wherein the number of repeat units of both monomers is 10.

“Alkyl” as used herein denotes a linear straight-chain or branched alkyl radical or a cyclic alkyl (cycloalkyl). Alkyl groups may be independently selected from C₅ to C₂₀ alkyl, C₅ to C₁₀ alkyl, C₅ to C₈ alkyl, C₅ to C₁₅ alkyl, C₈ to C₂₀ alkyl, C₅ alkyl, C₆ alkyl, C₇ alkyl, C₈ alkyl, C₉ alkyl or C₁₀ alkyl. One or more hydrogen atoms of an alkyl group may be replaced by halogen atoms, such as fluorine, bromine or chlorine atoms. An alkyl group may be substituted or unsubstituted. In an embodiment, an alkyl group may be a “fluoroalkyl” group, i.e., an alkyl group in which some or all of the hydrogen atoms have been replaced by fluorine atoms, or a “perfluoroalkyl” group, i.e., an alkyl group in which fluorine atoms have been substituted for each hydrogen atom.

Many different anchoring polymer blocks may be used in amphiphobic block copolymers of the invention. Without wishing to be limited by theory, such an amphiphobic block copolymer can be attached to a substrate via an anchoring block by three mechanisms: (a) a grafting reaction between an anchoring block and a substrate; (b) a crosslinking of an anchoring block around a substrate; and (c) a combination of both (a) and (b). Anchoring polymer blocks may thus comprise crosslinkable polymer blocks, grafting polymer blocks, and/or polymer blocks which comprise both crosslinking and grafting functions, such as sol-gel forming polymer blocks.

Choice of anchoring blocks to be used in an amphiphobic block copolymer according to the invention varies depending on properties of the desired substrate. For example, in the case of substrates bearing hydroxyl, amino, thiol and/or carboxylic acid groups, amphiphobic block copolymers can attach to a substrate via a grafting reaction between anchoring blocks and substrate. Non-limiting examples of such anchoring blocks which can graft onto a substrate using mechanism (a) include: (i) aldehyde and ketone-functional polymers such as polyacetal polymers, polyacrolein polymers, poly(methyl isopropenyl ketone) polymers, poly(vinyl methyl ketone) polymers, aldehyde-terminated poly(ethylene glycol) polymers, carbonylimidazole-activated polymers, and carbonyldiimidazole-terminated poly(ethylene glycol) polymers; (ii) carboxylic acid anhydride-functional polymers such as poly(acrylic anhydride) polymers, poly(alkalene oxide/maleic anhydride) copolymers, poly(azelaic anhydride) polymers, poly(butadiene/maleic anhydride) copolymers, poly(ethylene/maleic anhydride) copolymers, poly(maleic anhydride) polymers, poly(maleic anhydride/1-octadecene) copolymers, poly(vinyl methyl ether/maleic anhydride) copolymers, and poly(styrene/maleic anhydride) copolymers; (iii) carboxylic acid chloride-functional polymers such as poly(acrylolyl chloride) polymers and poly(methacryloyl chloride) polymers; and (iv) chlorinated polymers such as chlorine-terminated polydimethylsiloxane polymers, chlorinated polyethylene polymers, chlorinated polyisoprene polymers, chlorinated polypropylene polymers, poly(vinyl chloride) polymers, epoxy-terminated polymers, epoxide-terminated poly(ethylene glycol) polymers, isocyanate-terminated polymers, isocyanate-terminated poly(ethylene glycol) polymers, oxirane functional polymers, poly(glycidyl methacrylate) polymers, hydrazide-functional polymers, poly(acrylic hydrazide/methyl acrylate) copolymers, succinimidyl ester polymers, succinimidyl ester-terminated poly(ethylene glycol) polymers, tresylate-activated polymers, tresylate-terminated poly(ethylene glycol) polymers, vinyl sulfone-terminated polymers and vinyl sulfone-terminated poly(ethylene glycol) polymers. Other non-limiting examples of such anchoring blocks include polymers bearing maleic anhydride, other anhydrides, acrylates, methacrylates, acid chlorides, glycidyl groups, silyl halide groups, epoxide groups, isocyanate groups, and/or succinimide groups. These functional groups react with, for example, surface hydroxyl and amino groups. Crosslinking can be done with the aid of a bi-functional additive that reacts with pendant groups.

In other embodiments, anchoring blocks may crosslink around a substrate (mechanism (b)). In this case, an anchoring block forms an integral crosslinked wrapping layer around a substrate. In general, the larger an object to be coated, the larger the area of this wrapping layer is, and also the higher the probability of defect formation. These methods are therefore expected to be best suited for coating nanoparticles such as silica and nanofibers. Notwithstanding, we demonstrate herein that a crosslinked amphiphobic diblock copolymer layer wrapped around cotton fibers is stable and durable against laundering.

In an embodiment, polymers used for forming integral crosslinked wrapping layers around a substrate are crosslinkable polymers, as described above. Crosslinkable polymers include polymers that can be crosslinked themselves without additives as well as polymers that require additives for crosslinking. In an embodiment, a crosslinkable polymer block is a trialkoxysilane-bearing block or trialkoxysilane. In other embodiments, a crosslinkable polymer block comprises 2-cinnamoyloxyethyl methacrylate (CEMA) and/or 2-cinnamoyloxyethyl acrylate (CEA).

In other embodiments, amphiphobic block copolymers attach to a substrate via both a grafting reaction between anchoring blocks and substrate and crosslinking of anchoring blocks around a substrate (mechanism (c)). Any polymers that undergo sol-gel chemistry can be used on surfaces bearing hydroxyl groups and can attach to these surfaces via both a grafting reaction between anchoring blocks and surface/substrate and crosslinking of anchoring blocks around a surface/substrate. Such polymers are contemplated for use as crosslinkable components of amphiphobic block copolymers of the invention. Alternatively, two types of functional units can be incorporated into an anchoring block to provide the desired properties. For example, an anchoring block can include both units which can graft onto a substrate using mechanism (a) and units which crosslink around a substrate using mechanism (b).

In an embodiment, an anchoring block comprises a sol-gel forming block. In another embodiment, a crosslinkable block is a sol-gel forming block.

It should be appreciated that crosslinkable polymer blocks contain functional groups which can undergo a crosslinking reaction among units of the crosslinkable block (i.e., crosslinking to each other), forming a network. In some cases, these functional groups can also undergo a grafting reaction to a substrate surface, or crosslinkable polymer blocks may contain additional functional groups which graft or attach onto a substrate. In some embodiments therefore, a crosslinkable polymer block contains both types of functional groups, i.e., crosslinkable groups and grafting groups.

As described above, non-limiting examples of functional groups which covalently graft or attach onto a substrate include anhydrides, acrylates, methacrylates, acid chlorides, glycidyl groups, silyl halide groups, epoxide groups, isocyanate groups, and/or succinimide groups. Any group capable of grafting onto a substrate is contemplated for use in amphiphobic block copolymers of the invention. In an embodiment, a functional group which covalently grafts or attaches onto a substrate is introduced as an end group to a crosslinkable polymer block.

As used herein, the term “unsubstituted” refers to any open valence of an atom being occupied by hydrogen. Also, if an occupant of an open valence position on an atom is not specified, then it is hydrogen.

As used herein, when content is indicated as being present on a “weight basis” or at a “weight percent (wt %),” the content is measured as the percentage of the weight of component(s) indicated, relative to the total weight of all components present in a coated object. In some embodiments, amphiphobic block copolymers are typically present in a range selected from about 0.5 wt % to about 5 wt %, from about 1 wt % to about 15 wt %, from about 1 wt % to about 3 wt %, from about 1 wt % to about 5 wt %, from about 6 wt % to about 10 wt %, from about 1 wt % to about 15 wt %, or from about 0.5 wt % to about 1 wt %.

Amphiphobic block copolymer coatings may be applied using any methods known in the art. Methods of application are selected by a skilled artisan based on, for example, form of an amphiphobic coating (e.g., solid, liquid, aerosol, paste, emulsion, dispersion, etc.), substrate, intended application, etc. For example, coatings may be sprayed, brushed, painted, printed, stamped, wiped (e.g., applied to a cloth or a wipe which is used to wipe a coating onto a substrate), sponged, rolled, spin-coated or electrostatically sprayed onto a substrate, or a substrate may be dipped, submerged or soaked in a solution containing amphiphobic block copolymers of the invention, etc. Coatings may also be applied by soaking a substrate, e.g., particles, fabric, cotton, etc., in a coating solution and then removing solvent, for example by distillation or rota-evaporation.

Amphiphobic coatings prepared using amphiphobic block copolymers and methods described herein can have a broad range of thicknesses, depending for example on copolymers or compositions employed and application processes used. In some embodiments, amphiphobic block copolymer coatings have a thickness in a range of less than 1 nm, from about 1 nm to about 15 nm, or from about 3 nm to about 10 nm. Amphiphobic block copolymer coatings may also have a thickness of about 3 nm, about 4 nm, about 5 nm, about 6 nm, about 7 nm, about 8 nm, about 10 nm, about 13 nm, about 15 nm, or about 20 nm. In an embodiment, amphiphobic coatings form a monolayer on a substrate. In other embodiments, when particles coated by amphiphobic block copolymers are used to coat a second substrate, particle thickness may range from nanometers to millimeters in thickness.

In some embodiments, multiple coatings may be applied to a substrate, e.g., multiple coating layers may be applied.

Performance of amphiphobic coatings described herein may be measured by any of a variety of tests, which are relevant to a coating's ability to perform under a variety of circumstances. In an embodiment, amphiphobic coatings described herein provide water- and oil-repellency and/or water- and oil-resistance. In some embodiments, coatings described herein can resist loss of amphiphobicity when challenged in a mechanical abrasion test. Mechanical durability of coatings described herein may be assessed using either manual or automated tests (e.g., Taber Abraser testing). In other embodiments, coatings described herein can withstand laundry washing cycles. Coatings described herein may also be UV-resistant in some embodiments. In other embodiments, coatings described herein are stable and/or durable to environmental conditions such as low temperatures, wetting, salt resistance, ice formation, or the like, indicating that they can be employed in a variety of harsh environments for purposes such as prevention of ice formation and accumulation.

In still other embodiments, coatings provided herein are flexible, allowing use to coat materials such as cables, flexible tapes, and so on.

Amphiphobic coatings of the invention may be tested for performance, stability, durability, resistance to washing, acid and base-resistance, etc. using methods described herein (e.g., in the examples) as well as methods known in the art. Appropriate performance testing and parameters are selected by a skilled artisan based on several factors, such as desired properties, substrate, application, etc. In some embodiments, properties of amphiphobic coatings are determined using standardized techniques known in the art, such as ASTM tests or techniques described in Example 9. In an embodiment, amphiphobic coatings provide performance parameters given in Example 9.

The terms “robust” and “durable” are used interchangeably herein to refer to amphiphobic coatings which do not readily come off a substrate or a material surface. These terms are used to refer to coatings which do not generally degenerate or deteriorate, i.e., which do not readily undergo a progressive impairment in quality, functioning or physical condition. Sometimes the words “stable” and “stability” are also employed herein in this context. Requirements for robustness and durability vary depending on application. Performance parameters are generally set and tested based on industry standards and using conventional techniques. In one embodiment, robustness and durability refers to ability to withstand washing, e.g., laundry washing cycles. In other embodiments, robustness and durability refer to ability to withstand environmental conditions, such as abrasion, cold, ice, salt, and/or wind, which may generally cause coatings to peel, crack, fall off or otherwise deteriorate. In a particular embodiment, durability refers to ability to retain at least 90%, 80%, 70%, 50%, or 10% functionality after 3000 hours at a temperature of 85° C. In another embodiment, durability or other parameters are determined based on results in an ASTM (ASTM International) test.

The terms “resistance” and “repellence” are used interchangeably herein to refer to ability of a coating to resist or repel a substance. Amphiphobic block copolymers of the invention may be prepared using known methods. Typical techniques for preparing such amphiphobic block copolymers include controlled radical and anionic polymerizations. For example, amphiphobic block copolymers can be directly prepared by ionic polymerization, ring-opening polymerization, controlled free radical polymerization and group transfer polymerization. Ionic polymerization can be further divided into anionic and cationic polymerization. Ring-opening can be accomplished by a cationic, anionic or metathesis mechanism. Current controlled free radical polymerization techniques include atom transfer radical polymerization, reversible addition-fragmentation chain transfer polymerization, and TEMPO polymerization. Amphiphobic block copolymers can also be prepared by step or condensation polymerization. In addition, amphiphobic block copolymers can be prepared by coupling pre-made polymer blocks that bear end functional groups. This end coupling can be achieved by click chemistry, amidization, esterification, etc.

To coat a surface or material, an amphiphobic block copolymer of the invention may be used in any of the forms described herein, e.g., in a solvent (e.g., an organic solvent), in aqueous solution, as an emulsion, a dispersion, in combination with a plasticizer and/or additives, in coating formulations (such as a paste or a paint), as coated particles, etc. Non-limiting examples of organic solvents which may be used to solubilize or disperse an amphiphobic block copolymer include alkanes, alkenes, aromatics, alcohols, ethers, ketones, esters, aldehydes, halogenated alkanes, halogenated alkenes, halogenated aromatics, halogenated alcohols, halogenated ethers, halogenated ketones, halogenated esters, or combinations thereof. In an embodiment, a solvent is trifluorotoluene (TFT) or tetrahydrofuran (THF). In another embodiment, a solvent is an aqueous solvent, e.g., water. A solvent is chosen by a skilled artisan based on blocks present in the copolymer, desired reaction conditions, substrate to be coated, and so on.

In an embodiment, an amphiphobic block copolymer is used with a plasticizer. Many plasticizers are known in the art. Plasticizers may be naturally occurring or man-made. Non-limiting examples of plasticizers for use with copolymers described herein include THF, amyl acetate, dimethyl phthalate, dibutyl phthalate, butyl acetate, glyceryl triacetate, dibutyl oxylate, diethyl oxylate, triethyl phosphate, tributyl phosphate, xylene, chloroform, 1,2-dichlorethane, and bromoform. In one embodiment, a phthalate-based plasticizer is used, such as bis(2-ethylhexyl) phthalate (DEHP), diisononyl phthalate (DINP), bis(n-butyl)phthalate (DnBP, DBP), butyl benzyl phthalate (BBzP), diisodecyl phthalate (DIDP), di-n-octyl phthalate (DOP or DnOP), diisooctyl phthalate (DIOP), diethyl phthalate (DEP), diisobutyl phthalate (DIBP), di-n-hexyl phthalate and dimethyl phthalate.

A plasticizer is chosen by a skilled artisan based on blocks present in a copolymer, desired reaction conditions (e.g., organic solvent vs. aqueous solution), and so on. It should be understood that a chosen plasticizer should solubilize copolymer blocks. In a particular embodiment, a plasticizer is miscible with water. In another embodiment, a plasticizer is immiscible with water. In one embodiment, a plasticizer which is immiscible with water is used to swell an amphiphobic block copolymer phase that is dispersed in water by a surfactant.

In other embodiments, an amphiphobic block copolymer is used with an additive. Additives may be used, for example, to stabilize an emulsion, to stabilize a formulation, to provide additional functional properties, to facilitate crosslinking, etc. Non-limiting examples of additives include thermo- or photo-initiators, redox initiators, fluorinated initiators, catalysts, dihalogenated hydrocarbons, diamines, UV-absorbers, particles, softeners, surfactants, anti-static compounds, and dyes. In some embodiments, amphiphobic block copolymers are used with both a plasticizer and an additive. In certain embodiments, one or more than one additive is used.

Amphiphobic block copolymers may be provided in many different forms for use to prepare an amphiphobic coating on a surface. For example, amphiphobic block copolymers may be provided in solid form, e.g., as a powder. Alternatively, amphiphobic block copolymers may be provided in liquid form, for example in a solvent, with or without a plasticizer and/or other additives. In an embodiment, an amphiphobic block copolymer is provided in an aqueous solution in presence of a plasticizer, with or without other additives. In other embodiments, amphiphobic block copolymers are provided in an emulsion, a dispersion, a solution and/or a paste. As another alternative, amphiphobic block copolymers may be provided in aerosol form. Amphiphobic block copolymers according to the invention may also be provided in coating formulations, such as water-based paints, oil-based paints, varnishes, finishes, resins, polishes, pastes, wax forms, gel forms, etc.

In an embodiment, amphiphobic block copolymers are provided in a Volatile Organic Compound (VOC)-free aqueous solution comprising about 98% water, an amphiphobic block copolymer, a plasticizer and a surfactant. In some embodiments, amphiphobic block copolymers are provided in a Volatile Organic Compound (VOC)-free aqueous solution comprising about 90% water, about 95% water, about 90% to about 99% water, about 95% to about 99% water, or about 95% to about 98% water; an amphiphobic block copolymer; a plasticizer; and a surfactant.

In some embodiments, amphiphobic block copolymers are first coated onto particles, and coated particles are then used to prepare an amphiphobic coating on a surface. Coated particles may be provided in many different forms. For example, coated particles may be provided in solid form, e.g., as a powder. Alternatively, coated particles may be provided in a suspension in a liquid or in aerosol form. Coated particles may also be provided in coating formulations, such as water-based paints, oil-based paints, pastes, wax forms, gel forms, etc.

Many types of particles are known in the art, and any particles suitable for coating by an amphiphobic block copolymer of the invention may be used. Non-limiting examples of such particles include silica particles, nanoparticles, metal oxide particles, clay particles, metal particles, wood dust, cement particles, salt particles, ceramic particles, sand particles, mineral particles, polymer particles and microspheres. In an embodiment, any particles bearing surface groups that undergo H-bonding or covalent bond formation with PIPSMA may be used.

As used herein, the term “particles” refers to spheres, such as microspheres or spheres of any size, beads, cubes, and other three-dimensional structures of generally regular or irregular shape, and the like. Particles are generally commercially available, although modifications may be made before use. Particles may comprise a substrate of materials such as metals, metal oxides, such as iron oxide, inorganic oxides, silica, alumina, titania and zirconia, chemically bonded inorganic oxides, such as organosiloxane-bonded phases, hydrosilanization/hydrosilation bonded phases, polymer coated inorganic oxides or metal oxides, porous polymers, such as styrene-divinylbenzene copolymer, polyolefins, such as polyacrylates, polymethacrylates, and polystyrene. Particles may include, for example, octadecyl silane (ODS) particles, agarose beads, fluorinated beads, and silica based particles. The particles may be porous, mesoporous, or non-porous, or a combination. Porous or mesoporous particles may have pores of less than about 100 angstroms in diameter, in the range of about 100 to about 300 angstroms in diameter, or greater than about 300 angstroms in diameter, or a combination.

Particles may optionally bear substituents that confer desirable chemical properties to the particles so that, e.g., the particles are suitable for coating with amphiphobic block copolymers of the invention. Substituents may include, e.g., ketone groups, aldehyde groups, carboxyl groups, such as carboxylic acid, ester, amide, and acid halide groups, chloromethyl groups, cyanuric groups, polyglutaraldehyde groups, epoxide groups, thiol groups, amine groups, silanol groups, hydroxyl groups, sulphonic acid groups, phosphonic acid groups, and/or unsubstituted or substituted aliphatic or aromatic hydrocarbons. Particles may be modified chemically and/or physically in order to be suitable for coating. Particles may be used without modification if they already have chemical and/or physical properties desirable for coating. It will be understood that different properties may be demonstrated by the same particles in different conditions, such as different solvent conditions. In certain embodiments, particle diameters are in the range of about 0.01 to about 100 micrometers, or in the range of about 0.05 to about 60 micrometers, or in the range of about 0.1 to about 30 micrometers. In some embodiments, particle diameters are about 100 nanometers.

Amphiphobic block copolymers may be used in any of the forms listed herein, e.g., in combination with latex or water-based paint or oil-based paint, dispersed in a solvent, in an emulsion, etc. Typically, amphiphobic block copolymers provided in solid form (e.g., as a powder), are combined with a solvent or liquid before use to prepare an amphiphobic coating on a surface.

Amphiphobic coatings prepared using amphiphobic block copolymers of the invention may have a variety of finishes. A coating finish may be transparent, translucent, or opaque. In some embodiments, coatings are prepared without particles (i.e., a coating is applied directly to a surface, without being coated onto particles first). In an embodiment, a finish is transparent and colorless.

Amphiphobic coatings may also be permanent or temporary, depending on methods used for application onto a substrate. In general, curing or annealing a coating onto a substrate (e.g., by heating or exposing to UV) will provide a permanent coating which is durable, as defined herein. Alternatively, certain coatings applied without curing or annealing may be temporary, removable and/or short-lived, since chains that are not crosslinked or covalently attached to a substrate may be lost due to surface scratching or may be rinsed away by solvents or water.

A variety of substrates can be coated using amphiphobic copolymers described herein, including but not limited to metal oxides, semi-conductor oxides, metals, metalloids, metal oxides, concretes, clay particles, sand particles, cement particles, saw dust, semiconductors, particles, glasses, ceramics, papers and textile fibers. In some embodiments surfaces to be coated are in the form of metal plates, metal sheets or metal ribbons. In some embodiments, substrates are particles. For example, amphiphobic copolymers of the invention may be coated onto particles, and the coated particles may then be used for coating another substrate.

Many applications are anticipated for amphiphobic surfaces and coatings. For example, buildings (e.g., skyscrapers) with amphiphobic walls would require no or minimal cleaning. Ice would not likely form or build up on amphiphobic surfaces of power cables, which can minimize damage from freezing rain or ice storms. Amphiphobic coatings on metal surfaces can reduce metal rusting and corrosion. Amphiphobic coatings can be used to produce paper and paperboard for food-contact applications, such as pizza boxes and sandwich wraps. Amphiphobic coatings may be used to prepare glasses and ceramics that are self-cleaning, or to provide arc-resistant coatings on insulators used in electrical transmission systems where dirt or salt deposits, alone or in combination with water, can allow arcing with significant electrical energy losses. For cement and masonry products, amphiphobic coatings can provide products and surfaces resistant to damage in freezing weather from water that has penetrated the surfaces. As another example, amphiphobic coatings can be used to prepare paper products and fabrics which are resistant to water and moisture, including, but not limited to: paper and fabric moisture barriers used for insulation and under shingles or roofing; cardboard tubes or pipes, for example used to cast concrete pillars (water penetrating the seams of such tubes can leave seams and other defects in the pillars that need to be fixed by grinding operations); and water-resistant paper and cardboard packaging. Amphiphobic coatings can be used to prepare products which are salt-water-resistant, for example for underwater applications such as ship hulls, submarines, and other marine applications.

In some embodiments, amphiphobic coatings described herein can be used to prepare surfaces which are anti-wetting, anti-icing, anti-corrosion, anti-rust, anti-scratching, anti-staining, anti-bacterial, abrasion resistant, anti-fingerprint marking, anti-smudging, anti-graffiti, acid-resistant, base-resistant, resistant to chemicals, resistant to organic solvents, resistant to etching and/or self-cleaning. Surfaces coated with copolymers described herein may resist spills, resist stains, resist soiling, release stains, have improved cleanability, have improved alkaline resistance, have improved acid resistance, have improved resistance to organic solvents, have improved resistance to chemical penetration (e.g., improved resistance to organic chemicals), have improved resistance to corrosion, and/or have improved durability compared to uncoated surfaces.

In some embodiments, amphiphobic coatings described herein can be used to prepare plastic or glass surfaces which are smudge-resistant, scratch resistant and/or stain resistant. Such plastic and glass surfaces may be found, for example, on electronic devices. Electronic devices can be portable (e.g., cellular phones; smartphones (e.g., iPhone™, Blackberry™); personal data assistants (PDAs); tablet devices (e.g., iPad™); game players (e.g., PlayStation Portable (PSP™), Nintendo™ DS); laptop computers; etc.), or not portable (e.g., computer monitors; television screens; kitchen appliances; etc.).

In some embodiments, amphiphobic coatings described herein provide surfaces which are highly water- and oil-repellant. Contact angle of water and/or oil on a coated surface or material may be about 90 degrees or greater, about 100 degrees or greater, about 110 degrees or greater, about 120 degrees or greater, about 130 degrees or greater, about 150 degrees or greater, about 90 degrees, about 110 degrees, about 120 degrees, about 150 degrees, about 160 degrees, or about 170 degrees. It should be understood that contact angles cannot be greater than 180 degrees, which is the theoretical maximum angle possible.

In further embodiments, amphiphobic coatings described herein provide surfaces which resist adhesion of biological materials. For example, anti-adherent surfaces comprising amphiphobic block copolymers of the invention are provided which repel proteins, bacteria, dirt, grime, soil, fungi, viruses, microbes, yeast, fungal spores, bacterial spores, gram negative bacteria, gram positive bacteria, molds and/or algae. Such surfaces may also resist adherence of biological or bodily fluids such as blood, sputum, urine, feces, saliva, and/or perspiration/sweat. In a particular embodiment, amphiphobic coatings reduce or prevent microscopic animals such as dust mites and bedbugs from colonizing in mattresses, bedding, upholstery and/or carpeting.

Amphiphobic block copolymer coatings, or particles coated with amphiphobic block copolymers of the invention, can be applied to any surface to which an amphiphobic block copolymer of the invention can adhere, either temporarily or permanently. The surfaces may be flexible or rigid. In some embodiments a surface can be made from a material which is fabric, glass, metal, metalloid, metal oxide, ceramic, wood, plastic, resin, rubber, stone, concrete, a semiconductor, a particle or a combination thereof. In some embodiments, surfaces may comprise metalloids (e.g., B, Si, Sb, Te and Ge).

Any glass can be employed as a substrate for amphiphobic coatings according to the invention, including, without limitation: soda lime glass, borosilicate glass, sodium borosilicate glass, aluminosilicate glass, aluminoborosilicate glass, optical glass, fiberglass, lead crystal glass, fused silica glass, germania glass, germanium selenide glass, and combinations thereof.

Any metal can be employed as a substrate for amphiphobic coatings according to the invention, including, without limitation: iron, nickel, chrome, copper, tin, zinc, lead, magnesium, manganese, aluminum, titanium silver, gold, platinum, and combinations thereof, or alloys comprising those metals. Metal oxides may also be present in the substrates. In one embodiment, a metal forming a surface comprises steel or stainless steel. In another embodiment, a metal used for a surface is chromium, is plated with chromium, or comprises chromium or a chromium coating.

Any ceramic can be employed as a substrate for amphiphobic coatings according to the invention, including, without limitation: earthenware (typically quartz and feldspar), porcelain (e.g., made from kaolin), bone china, alumina, zirconia, and terracotta. For the purpose of this disclosure, a glazing on a ceramic may be considered either as a ceramic or a glass.

Any wood can be employed as a substrate for amphiphobic coatings according to the invention, including, without limitation, hard and soft woods. In some embodiments, woods may be selected from alder, poplar, oak, maple, cherry, apple, walnut, holly, boxwood, mahogany, ebony, teak, luan, and elm. In other embodiments woods may be selected from ash, birch, pine, spruce, fir, cedar, and yew.

Any plastic or resin can be employed as a substrate for amphiphobic coatings according to the invention, including, without limitation, polyolefins (such as a polypropylene and polyethylene), polyvinylchloride plastics, polyamides, polyimides, polyamideimides, polyesters, aromatic polyesters, polycarbonates, polystyrenes, polysulfides, polysulfones, polyethersulfones, polyphenylenesulfides, phenolic resins, polyurethanes, epoxy resins, silicon resins, acrylonitrile butadiene styrene resins/plastics, methacrylic resins/plastics, acrylate resins, polyacetals, polyphenylene oxides, polymethylpentenes, melamines, alkyd resins, polyesters or unsaturated polyesters, polybutylene terephthlates, combinations thereof, and the like.

Any rubber can be employed as a substrate for amphiphobic coatings according to the invention, including, without limitation: natural rubber, styrene-butadiene rubber, butyl rubber, nitrile rubber, chloroprene rubber, polyurethane rubber, silicon rubber, and the like.

Any type of stone, concrete, or combination thereof can be employed as a substrate for amphiphobic coatings according to the invention, including, without limitation, igneous, sedimentary and metamorphic stone (rock). In one embodiment the stone is selected from granite, marble, limestone, hydroxylapatite, quartz, quartzite, obsidian and combinations thereof. Stone may also be used in the form of a conglomerate with other components such as concrete and/or epoxy to form an aggregate that may be used as a surface upon which an amphiphobic coating may be applied.

Non-limiting examples of types of coatings which may be prepared using amphiphobic block copolymers and methods described herein include: fabric coatings, textile coatings, decorative coatings, transportation coatings, wood finishes, powder coatings, coil coatings, packaging finishes, general industrial finishes, automotive paint (including refinishing paint), industrial maintenance and protective coatings, marine coatings, and other industrial coatings.

Non-limiting examples of applications of these types of coatings include: furniture (e.g., wood and metal furniture, outdoor furniture, office or commercial furniture, fixtures, casual furniture); motor vehicles; metal building components; industrial machinery and equipment; appliances (e.g., kitchen appliances, laundry appliances); aerospace equipment; packaging (e.g., interior and exterior of metal cans, flexible packaging, paper, paperboard, film and foil finishes); electrical insulation coatings; consumer electronic products (e.g., cell phones, tablet devices, MP3 players, cameras, computers, displays, monitors, televisions); coil coatings (e.g., coils, sheets, strips, and extrusion coatings); automotive refinishing (e.g., aftermarket repair and repainting); industrial settings (e.g., protective coatings for interior and exterior applications); routine maintenance to protect buildings (e.g., protection from corrosive chemicals, exposure to fumes, and temperature extremes); process industries (e.g., protection from corrosive or highly acidic chemicals); roads and bridges; and marine applications (e.g., boats, antifouling, ice resistance, equipment anticorrosion). It is apparent from these examples that coatings may be applied to articles pre-market, i.e., before, during or after manufacturing and before sale, or post-market, e.g., for maintenance and protective uses.

Coatings described herein can be applied to surfaces using any means known in the art, including but not limited to, brushing, painting, printing, stamping, rolling, dipping, wiping, sponging, spin-coating, spraying, or electrostatic spraying. Generally, surfaces are rigid or semi-rigid, but surfaces can also be flexible, for example in the instance of wire and tapes or ribbons.

Coatings described herein can be applied to virtually any substrate to provide amphiphobic properties. Choice of coating forms and processes for applying coatings are determined by a skilled artisan, based on factors such as chosen substrate, application, etc. Coatings may take any desired shape or form. In some embodiments, a coating completely covers a surface. In other embodiments, coatings cover only a portion of a surface, such as one or more of a top, side or bottom of an object. In one embodiment, a coating is applied as a line or strip on a substantially flat or planar surface. In such an embodiment, the line or strip may form a spill-resistant border.

Shape, dimensions and placement of coatings on surfaces can be controlled by a variety of means including the use of masks which can control not only portions of a surface that receive a coating, but also portions of a surface that may receive prior treatments such as application of a primer layer or cleaning by abrasion or solvents. For example, sand blasting or chemical treatment may be used to prepare a portion of a surface for coating, e.g., to generate desired surface roughness or to clean a surface. Where a portion of a surface is prepared in this way, a mask resistant to those treatments would be selected (e.g., a mask such as a rigid or flexible plastic, resin, or rubber/rubberized material). Masking may be attached to a surface through use of adhesives, which may be applied to a mask agent, a surface, or both.

In another embodiment a coating is applied to a ribbon, tape, or sheet that may then be applied to a substrate by any suitable means including adhesive applied to the substrate, the ribbon, tape, or sheet, or a combination thereof. Ribbons, tapes and sheets bearing an amphiphobic coating may be employed in a variety of applications, including forming spill-proof barriers on surfaces. Such ribbons, tapes, and sheets can be applied to any type of surface including metal, ceramic, glass, plastic, or wood surfaces, for a variety of purposes.

In some embodiments, coatings may be used to form a border on a surface. An amphiphobic “border” is a portion of a surface forming a perimeter around an area of the surface that has lower amphiphobicity than the border. Amphiphobic borders can prevent water and other liquids from spilling, spreading or flowing beyond the position of the border. A spill-resistant border could be prepared, for example, by applying an amphiphobic coating to a portion of a surface (with or without use of a mask), or by applying a tape or a ribbon to a surface, where one surface of the tape or ribbon is treated with an amphiphobic coating.

To improve adherence of coatings to a surface, a surface may be treated or primed, such as by abrasion, cleaning with solvents or application of one or more undercoatings or primers. In some embodiments where metals can be applied to surfaces (e.g., by electroplating, vapor deposition, or dipping) and it is deemed advantageous, surfaces may be coated with metals prior to application of a coating described herein.

As discussed above, a wide variety of articles may be coated with amphiphobic block copolymers of the invention. Non-limiting examples of such articles include metal plates, metal sheets, metal ribbons, wires, cables, boxes, insulators for electric equipment, roofing materials, shingles, insulation, pipes, cardboard, glass shelving, glass plates, printing paper, metal adhesive tapes, plastic adhesive tapes, paper adhesive tapes, fiber glass adhesive tapes, boats, ships, boat hulls, ship hulls, submarines, bridges, roads, buildings, motor vehicles, electronic devices, machinery, furniture, aerospace equipment, packaging, medical equipment, surgical gloves, shoe waxes, shoe polishes, floor waxes, furniture polishes, semiconductors, solar cells, solar panels, windmill blades, aircraft, helicopters, pumps, propellers, railings, and industrial equipment.

In some embodiments, a coated article's breathability, flexibility, softness, appearance, feel and/or hand is substantially the same as that of an uncoated article.

In some embodiments, a coated article has improved cleanability, durability, water-repellence, oil-repellence, soil-resistance, biological species-resistance, bodily fluid-resistance, ice-resistance, salt-resistance, salt-water-resistance, acid-resistance, base-resistance, stain-resistance, organic solvent-resistance, flame-resistance, anti-fouling properties, anti-bacteria adhesion properties, anti-virus-adhesion properties, anti-adhesion properties (e.g., anti-contaminant adhesion properties), anti-flow resistance (e.g., for underwater uses, swimming), anti-flame properties, self-cleaning properties, anti-rust properties, anti-corrosion properties, anti-etching properties, anti smudge properties, anti-fingerprint properties, and/or ability to control moisture content, compared to an uncoated article.

In some embodiments, highly water and oil repellent textiles can be obtained by depositing an amphiphobic coating on fibrous substrates or fabrics. It should be understood that any fibrous substrate or fabric which can bind amphiphobic block copolymers of the invention may be used. Fibrous substrates according to the present invention include fibers, woven and non-woven fabrics derived from natural or synthetic fibers and blends of such fibers, as well as cellulose-based papers, leather and the like. They can comprise fibers in the form of continuous or discontinuous monofilaments, multifilaments, staple fibers and/or yarns containing such filaments and/or fibers, and the like, which fibers can be of any desired composition. The fibers can be of natural, manmade or synthetic origin. Mixtures of natural fibers and synthetic fibers can also be used. Included with the fibers can be non-fibrous elements, such as particulate fillers, binders and the like. Fibrous substrates of the invention are intended to include fabrics and textiles, and may be a sheet-like structure comprising fibers and/or structural elements. A sheet-like structure may be woven (including, e.g., velvet or a jacquard woven for home furnishings fabrics) or non-woven, knitted (including weft inserted warp knits), tufted, or stitch-bonded.

Non-limiting examples of natural fibers include cotton, wool, silk, jute, linen, ramie, rayon and the like. Natural fibers may be cellulosic-based fabrics such as cotton, rayon, linen, ramie and jute, proteinaceous fabrics such as wool, silk, camel's hair, alpaca and other animal hairs and furs, or otherwise. Non-limiting examples of manmade fibers derived primarily from natural sources include regenerated cellulose rayon, cellulose acetate, cellulose triacetate, and regenerated proteins. Examples of synthetic fibers include polyesters (including poly(ethylene glycol terephthalate)), polyamides (including nylon, such as Nylon 6 and 6,6), acrylics, polypropylenes, olefins, aramids, azlons, modacrylics, novoloids, nytrils, spandex, vinyl polymers and copolymers, vinal, vinyon, and the like, and hybrids of such fibers and polymers. Leathers and suedes are also included.

Amphiphobic coated textiles may reject most pollutants (e.g., naturally-occurring pollutants, chemical pollutants, biological pollutants, etc.) and are not easily soiled. They may show improved properties such as water resistance, soil resistance, oil resistance, grease resistance, chemical resistance, abrasion resistance, increased strength, enhanced comfort, detergent free washing, permanent press properties such as smoothness or wrinkle resistance, durability to dry cleaning and laundering, minimal requirement for cleaning, and/or quickness of drying. Such textiles can be used to make, for example, contamination-free canvases, tents, parachutes, backpacks, flags, handkerchiefs, tablecloths, napkins, kitchen aprons, bibs, baby clothes, lab coats, uniforms, insignias, rugs, carpets, and ties.

In some embodiments, an advantage of amphiphobic coatings provided herein is that coatings may be thin and/or do not affect desirable properties of a fabric such as breathability, flexibility, softness, and/or the feel (hand) of the fabric. Amphiphobic fabrics can thus be used to make clothing and apparel. For example, socks, hosiery, underwear, garments such as jackets, coats, shirts, pants, uniforms, wet suits, diving suits and bathing suits, fabrics for footwear, and shoes can be coated. Home furnishing fabrics for upholstery and window treatments including curtains and draperies, bedding items, bedsheets, bedspreads, comforters, blankets, pillows or pillow coverings, fabrics for outdoor furniture and equipment, car upholstery, floor coverings such as carpets, area rugs, throw rugs and mats, and fabrics for industrial textile end uses may also be coated. Coating of materials such as cotton may, for example, alter properties of the cotton, such as water/soil repellence or permanent press properties. Cotton-containing materials may be coated after procedures such as dyeing of the cotton. Cotton materials may be provided as a blend with other natural and/or synthetic materials.

In further embodiments, amphiphobic coatings are used on leather products, such as leather jackets, leather shoes, leather boots, and leather handbags. Amphiphobic coatings may also be used on suede products.

There are provided herein coating methods using an amphiphobic block copolymer of the invention to render fabrics, e.g., cotton fabrics, amphiphobic. In an embodiment, P1 is used to render cotton fabrics amphiphobic. To our knowledge, this represents the first report on use of amphiphobic block copolymers to coat textiles. Without wishing to be bound by theory, it is believed that a PIPSMA block is sol-gel forming (Brinker, C. J. and Scherer, G. W., Sol-Gel Science: The Physics and Chemistry of Sol-Gel Processing, Academic Press, Inc., Boston, 1990) and can be hydrolyzed to yield silanol groups that can condense with cotton surface hydroxyl groups (Salon, M. C. B. et al., Magnetic Resonance in Chemistry, 2007, 45: 473-483; Tshabalala, M. A. et al., Journal Of Applied Polymer Science, 2003, 88: 2828-2841) and with one another, yielding a crosslinked, covalently-grafted layer around cotton fibers. Amphiphobicity is rendered because of exposure of PFOEMA blocks at the surface.

Coatings may be applied to textiles before manufacture of an article, e.g., before manufacture of an article of clothing, or coatings may be applied after an article has been made. In some cases, coatings may be applied by a retailer or by a consumer after purchase.

### EXAMPLES

The present invention is more readily understood by referring to the following examples, which are provided to illustrate the invention and are not to be construed as limiting the scope thereof in any manner.

Unless defined otherwise or the context clearly dictates otherwise, technical and scientific terms used herein have the same meaning as commonly understood by one of ordinary skill in the art to which this invention belongs. It should be understood that any methods and materials similar or equivalent to those described herein can be used in the practice or testing of the invention.

### Example 1

### Preparation of an Amphiphobic Block Copolymer. Polymer Synthesis and Characterization

The materials used herein were sourced as described below and as follows: IPSMA was prepared as reported (Ozaki, H. et al., Macromolecules, 1992, 25:1391-1395). FOEMA was purchased from Aldrich; prior to use it was purified by vacuum distillation according to the method reported in the literature (Ishizone, T. et al., Polymer Journal, 1999, 31:983-988).

An amphiphobic fluorinated crosslinkable block copolymer was prepared as described below using anionic polymerization. A polymer comprising 10 IPSMA units and 10 FOEMA units was used. A relatively short FOEMA block was used to ensure solubility of the resultant amphiphobic diblock copolymer in solvents such as chloroform and deuterated chloroform, which were used for SEC and ¹H NMR analyses of the polymer.

After drying, the yield of product was essentially the same as the amount of reactants used.

Polymer was eluted as a single symmetric SEC peak. Based on polystyrene standards, polydispersity index (M_{w}/Mₙ) and number-average molecular weight (Mₙ) values were 1.16 and 8.6×10³ g/mol, respectively. The latter value agreed with the targeted molecular weight.

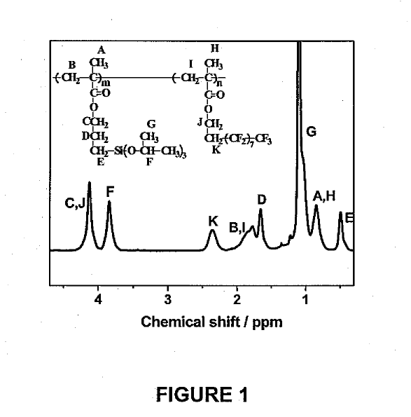

FIG. 1 shows a ¹H NMR spectrum of the amphiphobic diblock copolymer and peak assignments. The integral ratio of peak E to peak K was 1.0:1.0. This suggested a repeat unit ratio of 1.0:1.0 for PIPSPMA and PFOEMA, a conclusion fully supported by the integral ratios of the other peaks. By combining the ¹H NMR data with the SEC results, we determined that each of the PIPSPMA and PFOEMA blocks had 10 repeat units. Thus, the structure of the polymer was (IPSMA)₁₀-(FOEMA)₁₀ (referred to as P1 herein).

### Example 2

### Silica Particle Synthesis and Characterization

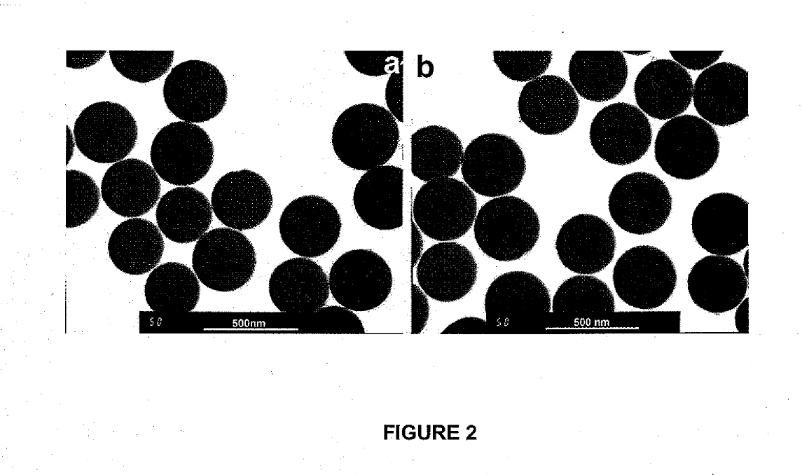

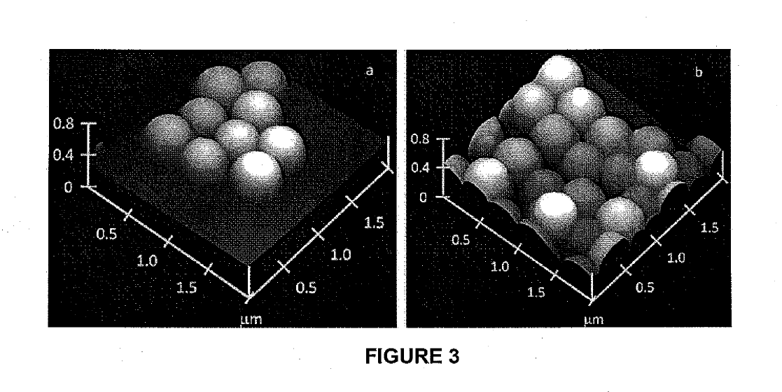

Silica particles were prepared from tetraethoxysilane via sol-gel chemistry using a modified Stober procedure (Sheen, Y. C. et al., J. Polym. Sci., Part B: Polym. Phys., 2008, 46: 1984-1990; Stober, W. et al., J. Colloid Interface Sci., 1968, 26: 62). This process involved ammonia-catalyzed hydrolysis of the ethoxy groups of tetraethoxysilane to yield silanol groups and then condensation of the resultant silanol groups into siloxane bonds. FIGS. 2a and 3a show a TEM image and an AFM topography image, respectively, of silica particles that were prepared. By analyzing over 100 particles, we determined that the particles had an average TEM diameter of 325±10 nm. The small (10 nm) standard deviation of the particle diameter suggested a narrow size distribution for the particles.

TEM images also revealed that surfaces of the silica particles were not completely smooth, but bore craters and bumps. These craters and bumps were also visible in AFM images. The presence of bumps and craters was not surprising, because these particles were formed via incorporation into them of smaller SiO₂ particles formed from TEOS sol-gel chemistry (Brinker, C. J. and Scherer, G., W., Sol-Gel Science: The Physics and Chemistry of Sol-Gel Processing, Academic Press, Inc.: Boston, 1990; Pope, E. J. A. and Mackenzie, J. D., J. Non-Cryst. Solids, 1986, 87: 185-198).

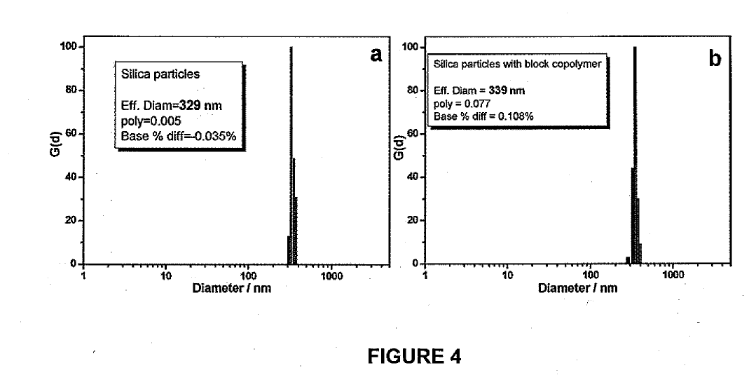

A dynamic light scattering (DLS) study was also performed on samples of particles which were dispersed in methanol. Distribution of hydrodynamic diameters of these particles was plotted in FIG. 4a. The average hydrodynamic diameter was 328 nm, which agreed well with the TEM diameter. A DLS polydispersity index of 0.005 confirmed low polydispersity of the particles.

### Example 3

### Silica Coating by P1 and Determination of Grafted Polymer Amount by TGA

Silica was coated by P1 in TFT/THF using HCl as catalyst (Sun, T. et al., J. Am. Chem. Soc., 2003, 125: 14996-14997; Brinker, C. J. and Scherer, G., W., Sol-Gel Science: The Physics and Chemistry of Sol-Gel Processing, Academic Press, Inc.: Boston, 1990). Trifluorotoluene (TFT) was used to ensure dispersion of the final particles, which bore a PFOEMA corona. Unless otherwise mentioned, silica particles were always coated using standard conditions, which involved performing a grafting reaction at 21° C. for 8 h in TFT/THF at a THF volume fraction (f_{THF}) of 9.1%. The molar ratio between IPSMA, HCl, and added water was 1:1:2 (n_{Si}/n_{HCl}/n_{H2O}). The mass ratio used between P1 and SiO₂ (m_{P}:m_{S}) was 0.08:1.

Silica nanoparticles were modified with amphiphobic block copolymer as follows: 3.0 mL of α,α,α-trifluorotoluene and 5.0 mg of silica nanoparticles were placed in a 20 mL vial, and the vial was placed in an ultrasonic cleaner device for 60 seconds to allow the silica particles to disperse throughout the α,α,α-trifluorotoluene. A 5.0 mg/mL tetrahydrofuran solution of the amphiphobic block copolymer (IPSMA)₁₀-(PFOEMA)₁₀ was made up. A 4.0 mol/L hydrochloric acid dioxane solution was diluted with tetrahydrofuran into a 0.2 mol/L solution. While stirring, to the silica nanoparticle solution were successively added 0.08 mL of polymer solution, 0.14 mL of tetrahydrofuran, 0.08 mL hydrochloric acid solution and 3.0 μL water, before reacting for 10 hours at 22° C. to yield a modified silica nanoparticle crude product. After centrifugation and separation, the crude product was washed twice with α,α,α-trifluorotoluene to remove unreacted polymer, catalyst and by-products. The product was dried for 2 hours in a 100° C. oven to obtain a white powder, the white powder being modified silica nanoparticles.

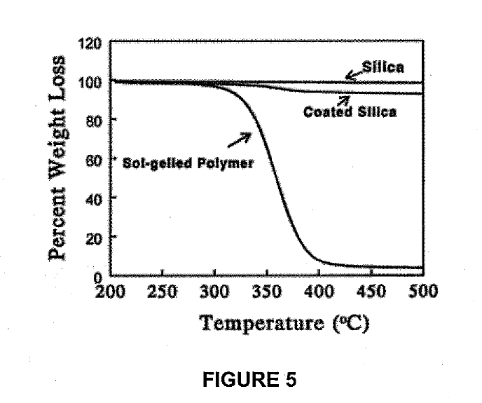

Grafted Polymer Amount was determined by thermo-gravimetric analysis (TGA). FIG. 5 shows a comparison of TGA traces of silica, P1-coated silica, and sol-gelled P1, which was prepared by sol-gelling P1 without silica under conditions otherwise identical to the standard conditions used to graft P1 to silica. When samples were heated from 200° C. to 500° C., the percentile mass residue Rₛ for silica at 500° C. was 99%. This suggested thermal stability of the silica. Over the same temperature interval, the percentile weight changed for the sol-gelled P1 sample from 99.0% to 3.79%. Thus, this polymer sample had a percentile mass residue Rₚ of 3.79%/99.0% or 3.82% at 500° C. Our analyses of 9 P1-coated silica samples yielded a mass residue R_{PS} of (93.5±0.3) % at 500° C.

Assuming that the P1 which was grafted onto silica and the sol-gelled P1 had the same TGA characteristics and that the polymer weight fraction in a P1-coated sample was x, the following equation applies:

Rₛ×(1−x)+Rₚ×x=R_{PS} (1)

For R_{PS}=(93.5±0.3) %, x was calculated to be (5.8±0.3) %.

If all isopropyloxyl groups of PIPSMA were hydrolyzed and the resultant silanol groups were fully condensed to form siloxane (Si—O—Si) bonds, the effective chemical formula for a sol-gelled IPSMA unit would be C₇H₁₁SiO_{3.5}, where the oxygen number is not an integer because each of the 3 siloxane oxygen atoms are shared by two Si atoms. Using this effective formula, we calculated that 0.080 g of P1 should yield 0.066 g of grafted polymer. Under standard silica coating conditions, a P1 to silica mass ratio of 0.080/1.00 was used, and polymer mass fraction in the coated particles should be 0.066/(0.066+1.00) or 6.2%. This value agreed well with the value of (5.8±0.3%) determined by TGA and supported validity of the TGA method for quantifying grafted polymer amount. It is likely that (5.8±0.3%) was slightly lower than 6.2% because not all of the copolymer was grafted onto silica surfaces under standard coating conditions. Rather, it is likely some of the copolymer had formed sol-gel micelles and was removed during particle purification.

### Example 4

### Investigation of Factors Affecting P1 Grafting

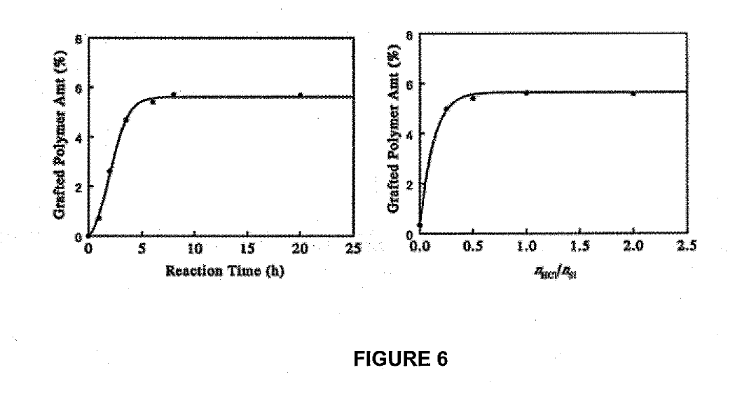

Using TGA, we determined grafted polymer amounts Q under different silica coating conditions. FIG. 6a shows how Q changed with reaction time under otherwise standard coating conditions. Q initially increased with reaction time and leveled off after 6 h, suggesting that the grafting reaction required approximately 6 h to complete. FIG. 6b shows how Q changed with molar ratio (n_{HCl}/n_{Si}) between HCl and IPSMA under otherwise standard conditions. Q was low without HCl but was constant after HCl addition. This behavior was reasonable because not much HCl was required to lower the reaction mixture pH.

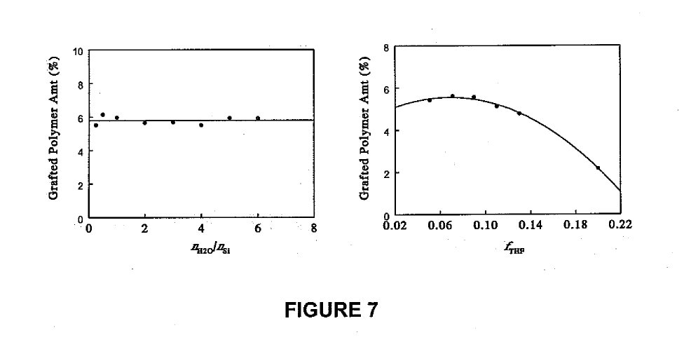

Theoretically, one water molecule is required for formation of one Si—O—Si linkage from two ethoxysilane groups. FIG. 7a suggests that Q changed little with n_{H2O}/n_{Si}, the molar ratio between water and IPSMA. This is likely because a trace amount of water either already existed in the solvent or was absorbed from the atmosphere during the grafting reaction.

FIG. 7b shows that Q decreased after the THF volume fraction (f_{THF}) in the TFT/THF solvent mixture increased beyond ˜9%. The PFOEMA corona was not soluble in THF but was in TFT. As f_{THF} is increased, the grafted PFOEMA chains should collapse, and hence the different silica particles should fuse together. The fusion of these particles should slow down the copolymer chain grafting, and thus reduce Q.

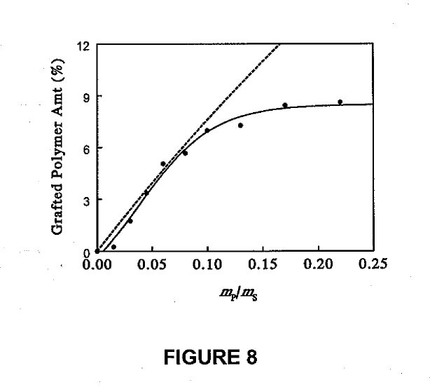

FIG. 8 shows change in Q as a function of feed mass ratio between P1 and silica (m_{P}/m_{S}). If added polymer were fully grafted and each IPSMA unit were fully sol-gelled to possess an effective formula of C₇H₁₁SiO_{3.5}, Q should increase linearly with m_{P}/m_{S}, as denoted by the dashed line in FIG. 8. Calculated and determined Q values agreed with one another at intermediate m_{P}/m_{S} values. However, at low m_{P}/m_{S} values, Q was lower than calculated values. At high m_{P}/m_{S} values, Q leveled off and reached a maximum value of −8.5%.

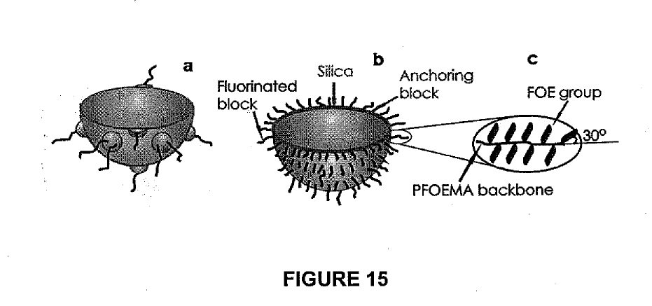

Q was lower than calculated values at low m_{P}/m_{S} values, most likely because grafted P1 formed islands under these conditions (see FIG. 15a). It is likely these sol-gelled PIPSMA islands were exposed and might react with moisture during the washing step; this could cause their siloxane bond(s) with substrate to cleave and a severed island would readily detach from a silica surface.

It is expected that a continuous copolymer monolayer formed on silica surfaces at intermediate and high m_{P}/m_{S} values (FIG. 15b). Polymer chain dissociation during the rinsing step from this monolayer is expected to be much more difficult because it would require cleavage of not only Si—O—Si bonds between a polymer chain and a silica substrate but also Si—O—Si bonds between a polymer chain and its neighbors. We found that predicted and observed Q's agreed with one another at intermediate m_{P}/m_{S} values. Once a dense monolayer had formed, it rejected further incorporation of copolymer chains, and thus Q reached a theoretical maximum value.

### Example 5

### Characterization of P1 Monolayers on Silica Particles

Density of silica particles (ρ_{S}) prepared from ammonia-catalyzed reactions of TEOS has been reported to be ˜2.2 g/cm³ (Pope, E. J. A. and Mackenzie, J. D., J. Non-Cryst. Solids, 1986, 87: 185-198). Assuming that this density was the same as the density of a sol-gelled and grafted PIPSMA layer, the density of PFOEMA (ρ₁) should be close to 1.85 g/cm³, which was calculated for poly[2-(perfluorooctyl)ethyl acrylate] using a group contribution method (Kim, J. et al., Macromolecules, 2007, 40:588-597). Density ρ_{P} of a grafted P1 layer including PFOEMA and sol-gelled PIPSMA was thus estimated to be 1.91 g/cm³ using:

1/ρ_{P}=f₁/ρ₁+(1−f₁/ρ_{S} (2)

Here f₁, the mass fraction of a PFOEMA block, was calculated to be 79.6% for P1 with a fully sol-gelled IPSMA block that had an effective formula of C₇H₁₁SiO_{3.5}.

As mentioned previously, average TEM diameter of silica spheres (d_{S}) was 325 nm. If silica particles were assumed to be perfectly spherical, thickness (h) of a uniformly-grafted P1 layer could be calculated using:

$${( \frac{{d}_{S} + 2 h}{{d}_{S}} )}^{3} = \frac{Q / {ρ}_{P}}{( 1 - Q ) / {ρ}_{S}} + 1 \qquad ( 3 )$$

At Q values of 5.8% for coatings prepared under standard conditions and 8.5% for a saturated layer, h values were calculated to be 3.8 and 5.6 nm, respectively.

The total number of repeat units was 20 for P1 chains. Assuming a zig-zag conformation for carbon atoms forming a copolymer's backbone, we calculated a contour length of 5.0 nm for a copolymer backbone. Previous studies suggested that surfaces of a PFOEMA block should be covered by a liquid crystalline 2-(perfluorooctyl)ethyl layer and the 2-(perfluorooctyl)ethyl group of a terminal FOEMA unit should be directed at a tilt angle of ˜30° relative to the radial direction of the sphere (FIG. 15c; Hirao, A. et al., Prog. Polym. Sci., 2007, 32:1393-1438; Genzer, J. et al., Macromolecules, 2000, 33:1882-1887). Thus, a terminal 2-(perfluorooctyl)ethyl unit containing 10 C—C bonds should add another 1.3 nm to the thickness of a dense monolayer. Thus, the theoretically possible maximum thickness for a grafted P1 layer should be 6.3 nm.

The theoretical maximal thickness of 6.3 nm was comparable with the value calculated above for maximum thickness based on experiments, i.e., 5.6 nm. This demonstrated that P1 was indeed grafted as a monolayer. The difference suggests that polymer chains in the monolayer did not assume an energetically unfavorable fully-stretched configuration. It should be further realized that 5.6 nm was determined by assuming that silica particles were perfectly spherical. In reality, silica particles bore surface bumps and craters, and should have a surface area larger than that of an ideal sphere of a similar size. Thus, 5.6 nm represented an over-estimate for the thickness of a densely packed P1 layer.

FIG. 3 also shows an AFM topography image of a silica sample after its coating by P1 at m_{P}/m_{S}=19% under otherwise standard conditions. At this m_{P}/m_{S} value, a coating should be rather thick approaching 5.6 nm. After P1 coating, silica surfaces appeared rather smooth and were free of particles with diameters of ˜10 nm, which should be close to the diameter of sol-gelled P1 nanoparticles that consisted of a PFOEMA corona and a sol-gelled PIPSMA core. Lack of these small particles was consistent with P1 being uniformly grafted as a monolayer.

FIG. 2 shows TEM images of silica particles before and after coating by P1 under standard conditions. Coated particles appeared to be rather smooth. This again suggested that these particles were uniformly coated by P1. Hydrodynamic diameter of this sample was determined to be 338 nm, which represented a 10 nm increase relative to uncoated silica particles, or a solvated coating layer thickness of 5 nm. This value was consistent with a dry coating thickness of 3.8 nm.

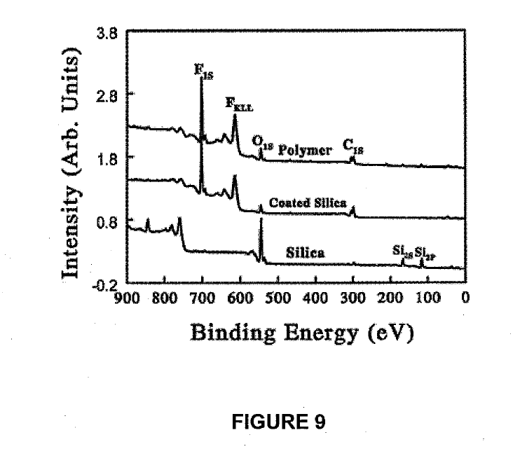

FIG. 9 shows a comparison of X-ray photoelectron spectroscopic (XPS) data of silica, P1, and P1-coated silica. Si and O peaks were predominant for the silica sample, as expected. These peaks were present together with F peaks in the P1 sample, because P1 contained Si, O, and F atoms. Interestingly, intensities of Si and O peaks decreased relative to F peaks in the coated silica sample. This suggests that perfluorooctyl groups constituted the top layer of the coating, even at a moderate coating thickness of 3.8 nm, thus confirming chain and FOE unit packing in FIG. 15c.

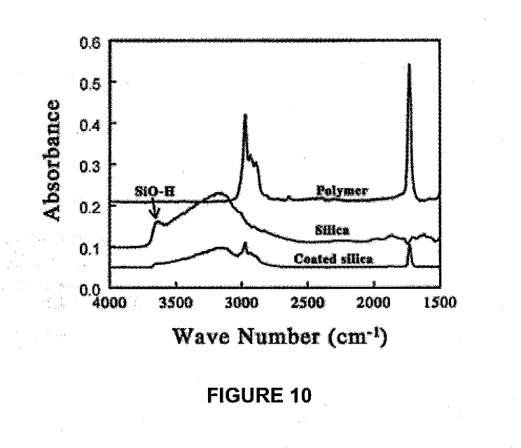

Chemical grafting of P1 was supported by diffuse reflectance infrared spectroscopic data. FIG. 10 shows a comparison of infrared absorption spectra of silica, P1, and P1-coated silica. The coated sample bore peaks of both silica and polymer, as expected. Intensity of the shoulder peak at 3750 cm⁻¹, which was characteristic of silanol units, decreased after the grafting reaction. This suggested that silanol units of the silica surface had condensed with the sol-gelled PIPSMA block. This also suggested that most of the Si—OH units of the hydrolyzed PIPSMA block were condensed.

### Example 6

### Particulate Films

Studies of natural superhydrophobic surfaces, such as lotus leaves and water strider legs, have helped to shed light on important criteria for superhydrophobicity in particular, and superamphiphobicity in general. Aside from a low surface energy, surfaces should also be rough to render large liquid contact angles (Tuteja, A. et al., Science, 2007, 318:1618-1622; Cassie, A. B. D. and Baxter, S., Trans. Faraday Soc., 1944, 40:0546-0550; Wenzel, R. N., Ind. Eng. Chem., 1936, 28:988-994). An easy way to obtain a rough coating or film is to apply fluorinated non-deformable particles onto a substrate.

P1-coated silica particles dispersed in TFT were cast onto microscope cover slips or glass plates to prepare rough particulate films. Particulate films were also applied onto printing paper by soaking printing paper in a coating solution and subsequently withdrawing the paper from the solution.

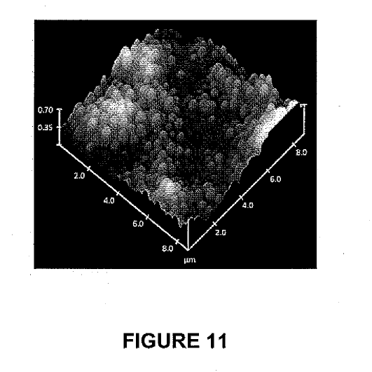

FIG. 11 shows an AFM topography image of a film of P1-coated silica particles prepared on a glass plate. Individual coated silica particles could be clearly discerned, and the film was obviously rough.

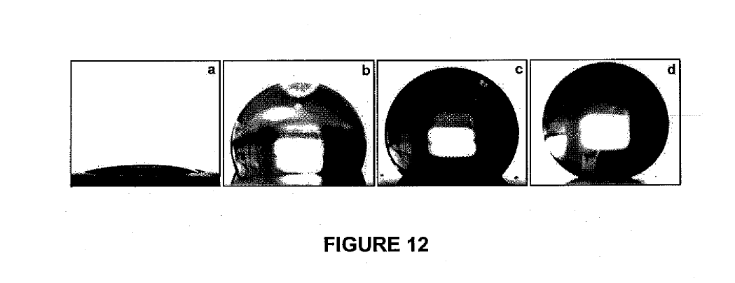

Despite these apparently crude film preparation protocols, we established that determined liquid contact angles changed by less than 2° from one particulate film to another for a given sample. Contact angles were, however, readily changed by using silica particles that were coated using different P1-to-silica mass ratios m_{P}/m_{S}. FIG. 12 shows photographs of water droplets that were dispensed onto films of an uncoated silica particle film, and films of P1-coated silica particles that were prepared using m_{P}/m_{S} values of 0.015, 0.045, and 0.06, respectively. As shown in FIG. 8, these m_{P}/m_{S} values corresponded to Q values of 1.2%, 4.2%, and 5.8%, respectively. Water contact angles increased as Q increased.

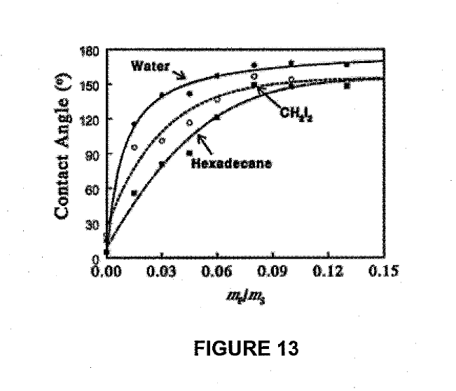

Similar trends were observed for contact angles of methylene iodide and hexadecane droplets on glass-backed films of P1-coated silica particles prepared using different m_{P}/m_{S} values. Plotted in FIG. 13 are the variations in static contact angles of water, methylene iodide, and hexadecane as a function of m_{P}/m_{S} used to coat silica particles. Contact angles seemed to level off for every liquid when m_{P}/m_{S} reached approximately 0.08.

Table 1 shows contact angles for water, methylene iodide, and hexadecane on P1-coated silica particle-coated glass slides. Silica particles described in this table were coated with P1 under standard conditions. Static angles were large for all three liquids, and differences between advancing and receding contact angles, or their hysteresis values, were small. These results indicate that these P1-coated silica particle films were superamphiphobic. This was a direct result of the fact that perfluorooctyl groups decorated silica particle surfaces. Contact angles decreased from water to diiodomethane and to hexadecane because surface tension decreased for these three liquids from 72.8, to 50.8, and 27.5 mN/m, respectively (Jasper, J. J., J. Phys. Chem. Ref. Data, 1972, 1: 841).

TABLE 1
Static, advancing, and receding contact angles for water, diiodomethane,
cooking oil and hexadecane on films made with silica particles that
were coated by P1 under standard conditions.

| | | | |
|---|---|---|---|
| | Static Contact | Advancing Contact | Receding Contact |
| Liquid | Angle (degrees) | Angle (degrees) | Angle (degrees) |

P1-coated Silica Particle Films Applied onto Glass Microscope Slides

| | | | |
|---|---|---|---|
| Water | 167 ± 2 | 170 ± 2 | 163 ± 2 |
| Diiodomethane | 157 ± 2 | 159 ± 2 | 149 ± 2 |
| Hexadecane | 149 ± 2 | 155 ± 2 | 142 ± 2 |

P1-coated Silica Particle Films Applied onto Printing Paper

| | |
|---|---|
| Water | 160 ± 2 |
| Cooking Oil | 153 ± 2 |

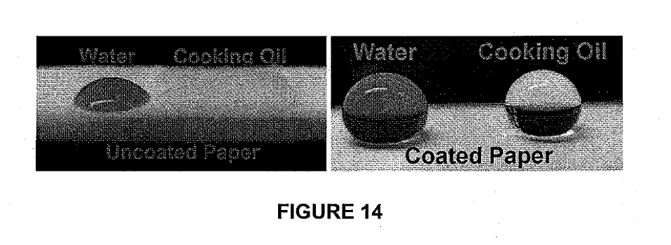

P1-coated silica particles seemed to be able to turn any substrate that can be coated superamphiphobic. FIG. 14 shows photographs taken immediately after rhodamine-B-impregnated droplets of vegetable cooking oil and water were applied on untreated printing paper and paper that was covered by P1-coated silica particles. On untreated paper, both water and oil droplets spread and became absorbed by the paper in less than 1 min. In contrast, no noticeable water or oil absorption was observed after 30 min. on treated paper, and water and oil droplets had equilibrium contact angles of 160 and 153°, respectively.

### Example 7

### Etching Resistance of P1-Coated Silica Particle Films

We tested whether silica particles coated by P1 are more resistant to etchant penetration and degradation than those coated by FEOTREOS or other fluorinated small-molecule coupling agents. Silica particles were coated with FEOTREOS under standard conditions using a FEOTREOS-to-silica mass ratio of 0.080:1.00 and films of the resultant silica particles were applied onto glass plates. Contact angles of water on these films were also large, at 164°.

However, films behaved differently when soaked in 1.0 M NaOH aqueous solution. After films of FEOTREOS-coated silica particles were soaked in 1.0 M NaOH aqueous solution for 3 h, a decrease in film thickness was observed. This decrease in film thickness was likely caused by penetration of the sol-gelled FEOTREOS layer on silica by NaOH and then SiO₂ dissolution.

After those films were dried, contact angles of water droplets on resultant films decreased sharply to below 90°. In contrast, no physical changes were seen for P1-coated silica particle films after immersion in 1.0 M NaOH aqueous solution between 3 and 5 h. After these films were dried, water contact angles on the films did not change, confirming that the films were intact. Further, soaking glass plates that were covered with P1-coated silica particle films in a 1.0 M NaOH aqueous solution for 8 h did not disintegrate the film, but severed it from the glass substrate. This delamination was most likely caused by the fact that the glass substrate was etched. Thus, P1-coated silica was much more resistant to NaOH etching than FEOTREOS-coated silica.

These results demonstrate that films made from P1-coated silica particles have outstanding etching resistance and water and oil repellence.

In summary, in Examples 1-7 we report that P1 was prepared by sequential anionic polymerization of IPSMA and FOEMA. P1 was then used to coat silica particles prepared from tetraethoxysilane via sol-gel chemistry and having an average diameter of 325±10 nm. The amount, Q, of P1 grafted onto silica particle surfaces could be determined by TGA, allowing us to determine effects of varying reaction time, solvent composition, catalyst HCl amount, water amount, and P1 to silica mass ratio (m_{P}/m_{S}) on Q and to optimize P1 coating conditions. This systematic study revealed that Q increased initially with m_{P}/m_{S} and leveled off at higher m_{P}/m_{S} values, suggesting P1 monolayer formation at higher m_{P}/m_{S} values. Monolayer formation was further supported by DLS, AFM, and TEM results. An XPS study revealed that perfluorooctyl groups topped the monolayer, even at a moderate coating thickness of 3.8 nm. Films of P1-coated silica particles were cast onto glass substrates and applied to paper and contact angles for water, methylene iodide, and hexadecane were measured. Contact angles varied as a function of m_{P}/m_{S}, increasing as degree of P1 grafting onto silica particles increased and leveling off for each liquid when m_{P}/m_{S} reached approximately 0.08. Static contact angles in super-repellency regime(150°) were obtained for water and methylene iodide and nearly so for hexadecane(149°), which has a surface tension of 27.5 mN/m. Paper treated with P1-coated silica particles also produced static contact angles in a super-repellency regime for water and cooking oil. P1-coated silica films were determined to be resistant to NaOH etching. After 3 h soaking in a 1.0 M NaOH aqueous solution, water contact angle on the film did not change.

Amphiphobic coatings were prepared as follows: The modified silica nanoparticles were re-dispersed into α,α,α-trifluorotoluene to make up a solution having a concentration of 2.0 mg/mL. This solution was then used to prepare amphiphobic coatings on glass surfaces and on printing paper surfaces. For coating glass surfaces, the solution was directly added dropwise to a glass slide, and after solvent evaporation an amphiphobic coating was formed on the surfaces of the glass slide. For coating surfaces of printing paper, the printing paper was directly immersed in the solution, and after removing and drying the sheets of paper an amphiphobic coating was formed on the surfaces thereof.

Performance testing of amphiphobic coatings was conducted as follows: The contact angle of liquids on the coating surface was tested with a KRÜSS K12 surface tensiometer at room temperature. The apparatus came fitted with image acquisition and analysis software, and the droplet volume was 5 μL. Experiments used the following three liquids: deionized water (surface tension of 72.8 mN/m at 20° C.), diiodomethane (surface tension of 50.8 mN/m at 20° C.), and hexadecane (surface tension of 27.5 mN/m at 20° C.). Results showed that the static contact angles of water, diiodomethane and hexadecane on coated glass surfaces were 166°, 157°, and 150°, respectively. Therefore, coatings of modified silica particles formed on glass surfaces possessed amphiphobicity. After coating the surfaces of printing paper, the contact angle of water droplets was also greater than 150°, indicating excellent hydrophobicity.

Stability testing of amphiphobic coatings was conducted as follows: The small molecule compound FOETREOS was employed in place of (IPSMA)₁₀-(FOEMA)₁₀ to modify silica nanoparticles using the methods described above, and a modified silica nanoparticle solution was then added to a glass surface to prepare a coating. Testing showed that this coating also possessed amphiphobicity. However, after placing this coating in a 1.0 mol/L solution of sodium hydroxide for 3 hours, washing with water and drying for 15 minutes at 100° C., the contact angle of water on the surface was less than 90°, i.e., the coating became hydrophilic. This may be due to the relative thinness of the small molecule coating; fluorine-containing FOE (perfluorooctyl) films can be very thin. Sodium hydroxide could penetrate this film layer and break the silica-oxygen bonds, subsequently destroying the coating, and causing part of the FOETREOS coating to detach from the surface of the silica particles so that amphiphobicity was lost.

The same experiment was performed using silica particle coatings modified with amphiphobic (IPSMA)₁₀-(FOEMA)₁₀ diblock copolymer. After soaking the coating for three hours in 1.0 mol/L sodium hydroxide solution, the surface properties thereof had not changed; after soaking for 5 hours, the coating appeared to have wrinkled but the contact angle of water on the surface remained greater than 130°, indicating that silica nanoparticles with polymer coatings possessed very high stability.

### Example 8

### Amphiphobic-Block-Copolymer-Coated Water and Oil Repellent Cotton Fabrics

An amphiphobic diblock copolymer consisting of 10 IPSMA and 10 FOEMA units (P1) was prepared by anionic polymerization as described above. SEC polydispersity of this sample was low at 1.16 based on polystyrene standards.

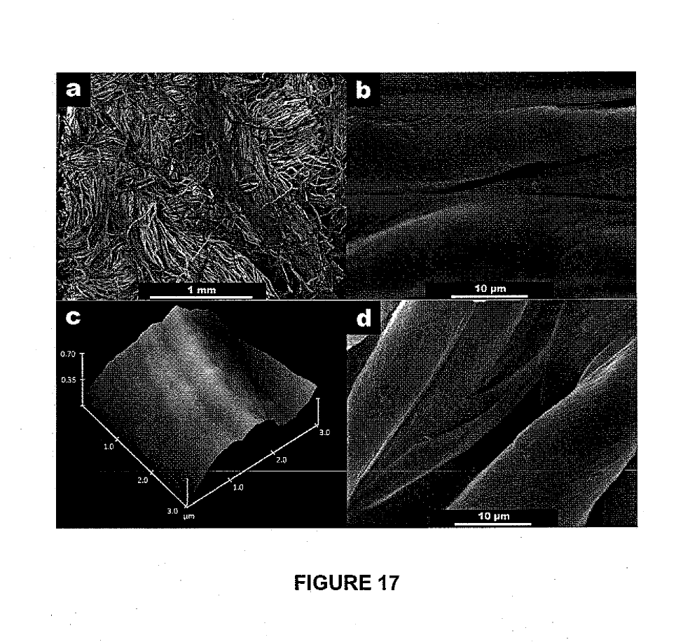

Plain-weave cotton textiles purchased from a local fabric store were used as a coating substrate. Fabric warp and weft thread diameters, as determined from optical microscopy, were 270±10 μm and 620±10 μm. FIG. 17 shows scanning electron microscopic (SEM) and atomic force microscopic (AFM) images of a cotton fabric and fibers, respectively. It can be seen that fibers were imperfect cylinders and had rough rather than smooth surfaces.

Unless mentioned otherwise, coating was done under standard conditions. A standard coating solution consisted of 2.0 mL of a P1 solution at 3.0 mg/mL in THF and 0.10 mL of a 14-M ammonia solution. Fabric used was 1.0 in² in size and weighed (110±3) mg. Coating involved soaking for 1 min a fabric swatch in a sol-gel solution prepared from equilibrating P1 in THF with ammonia between 5 and 15 min. Air at −80° C. from a heat gun was then blown for 30 on the removed fabric to evaporate most of the solvent. The resultant fabric was further heated in an oven at 120° C. for 15 min to anneal the coating.

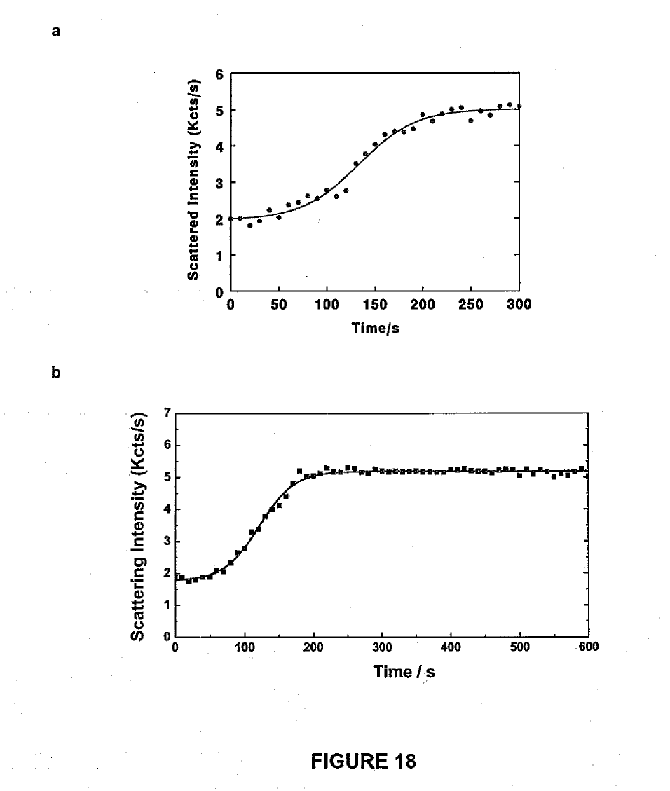

After ammonia addition, a P1 solution was stirred for at least 5 min before cotton swatch immersion to ensure that the PIPSMA block had somewhat hydrolyzed and was ready to undergo grafting reaction with cotton fibers (Brinker, C. J. and Scherer, G. W., Sol-Gel Science: The Physics and Chemistry of Sol-Gel Processing, Academic Press, Inc., Boston, 1990). This timing was selected based on light scattering results. Before ammonia addition, P1 should have existed as single chains and possessed a hydrodynamic diameter of ˜4 nm, as determined by dynamic light scattering. Five min after ammonia addition, average diameter of species present in the mixture was ˜20 nm. In addition, time-dependent intensity measurement indicated that intensity of scattered light from a P1 solution in THF started to increase abruptly, as shown in FIG. 18, about 2 min after ammonia addition. Scattering intensity started to increase with time because silanol units of different polymer chains had started to condense and P1 clusters had started to form. These clusters had a sol-gelled PIPSMA core and a PFOEMA corona, and their hydrodynamic diameter was larger than that of P1 single chains.

A cotton swatch was equilibrated with a P1 sol solution for 1 min to allow the P1 sol solution to be drawn into inter-fiber space, presumably via capillary action. A solvent evaporation step was implemented to force deposition of the drawn P1 onto cotton fibers. Coated fabric was heated at 120° C. because this has been shown in the past to facilitate covalent bond formation between silanols and wood surface hydroxyl groups (Salon, M. C. B. et al., Magnetic Resonance In Chemistry, 2007, 45, 473-483; Tshabalala, M. A. et al., Journal of Applied Polymer Science, 2003, 88, 2828-2841). A similar reaction was expected to occur here because wood and cotton are both made of cellulose.

Two methods were used to determine grafted polymer amounts. Method 1 relied on measuring a weight difference between coated and un-coated cotton fabrics using a microbalance. This method was more convenient but less accurate. Its accuracy improved and produced identical results with those from method 2 as the grafted polymer amount surpassed ˜1.0 wt %. Method 2, based on thermo-gravimetric analysis (TGA), was more accurate at lower amounts and allowed determination of grafted polymer amount down to ˜0.1 wt %.

In Method 2, a sample was heated in air from room temperature to 750° C. and weight residue was normalized to that determined at 150° C. Weight at 150° C. was used as a reference or as intrinsic weight of a sample because moisture sorbed would have evaporated and degradation would not have started at that temperature.

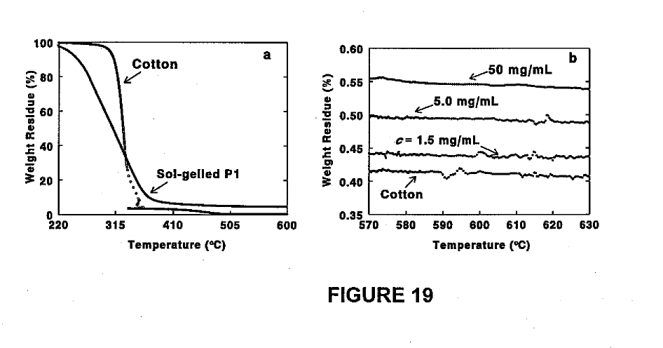

FIG. 19a compares TGA traces of an uncoated cotton sample and a sol-gelled P1 sample. For the latter, P1 should be in the form of nanoclusters due to hydrolysis and condensation of PIPSMA blocks of different P1 chains. Nanoclusters were precipitated by adding sol-gelling solution into methanol, which was a poor solvent for PFOEMA, and then purified and dried. Uncoated cotton was essentially fully pyrolyzed by 600° C. Sol-gelled P1 sample had a residual weight probably because of silicone oxide formation from the sol-gelled PIPSMA block.

FIG. 19b compares TGA traces, in a temperature range of 570 and 630° C., for cotton and cotton coated under otherwise standard conditions but at different P1 concentrations. To remove physically deposited P1, coated samples were extracted with trifluorotoluene overnight. As P1 coating solution concentration c increased, mass residue at 600° C. increased, suggesting that the amount of P1 grafted increased with c.

A straight line was used to fit the fluctuating data in the 570 and 630° C. range for each sample in FIG. 19b. Thus, residue for each sample at 600° C. was read from the fitted straight line; this improved data precision. For example, average residue for 10 uncoated cotton samples at 600° C. normalized to that at 150° C. was (0.403±0.002) %. This is compared to (4.709±0.004) % and (0.421±0.004) % for sol-gelled P1 in the absence of cotton and cotton coated with P1 at c=1.5 mg/mL, respectively. Another reason for high data precision was use of large fabric samples that each weighed more than 60 mg.

Residue values were then used to calculate P1 amounts grafted onto cotton based on the assumption that grafted P1 had the same TGA characteristics as the sol-gelled P1 sample and the cotton part in a coated sample behaved similarly to uncoated cotton. If polymer weight fraction in coated cotton textile was x, the following equation applied:

(1−x)R_{C}+xR_{P}=R_{PC} (1)

where R_{C} was residue of uncoated cotton, R_{P} was residue of sol-gelled P1, and R_{PC} was residue of a P1-coated cotton sample. Using this equation and determined R_{PC} values, deposited polymer amounts under any coating conditions could be calculated.

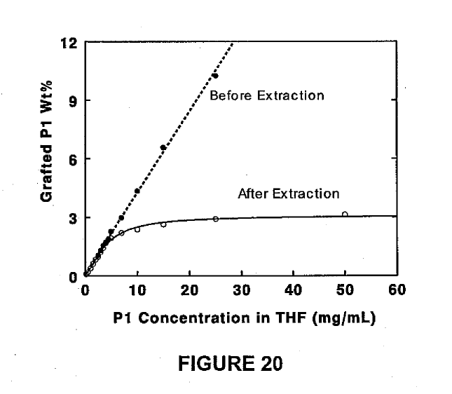

Next, dependence of deposited polymer amount on coating solution concentration was determined. Using methods mentioned above, deposited polymer amounts on cotton fabrics were determined for samples coated at different initial P1 concentrations and plotted in FIG. 20. Two sets of data were obtained because one set of samples was not extracted and the other set was extracted with trifluorotoluene overnight and dried before TGA analysis. Deposited polymer amount increased linearly with P1 concentration c in THF for the first set of samples. For the second set of samples, deposited polymer amount increased initially with c and then leveled off at high c.

Data obtained for samples that were not extracted by trifluorotoluene could be readily explained. Amount of polymer deposited depended on how much polymer solution was drawn into a fabric swatch. Since this drawn volume should change little with polymer concentration, deposited polymer amount increased linearly with c.

The observation that grafted polymer amount initially increased with c but leveled off at high c for the set of samples that were extracted by trifluorotoluene (TFT) suggested that deposited polymer actually consisted of two parts; a part that was chemically grafted was not extracted, and only a physically deposited part was extracted.

Existence of an apparent maximum grafted amount suggested monolayer grafting of P1. As discussed above regarding coating of silica particles, P1 likely deposited on silica particles via PIPSMA blocks and PFOEMA blocks topped the sol-gelled PIPSMA blocks. A similarly-structured monolayer likely formed here on cotton fabrics. Monolayer sorption (chemical grafting in this case) is expected to follow the Langmuir model (Atkins, P., Physical Chemistry, 6th ed., Freeman, New York, 1998; Njikang, G. et al., Langmuir, 2011, 27, 7176-7184), i.e., chain grafting density should increase initially with c. Once a monolayer is saturated, further increases in polymer concentration in bulk phase should insignificantly increase grafted polymer amount. For this system, saturated grafted polymer amount was ˜3.0 wt %.

Physically deposited polymer could be extracted probably because it existed as nanoclusters formed from condensation of silanol groups of different polymer chains. These clusters could not grow into larger particles because of a shielding effect of PFOEMA coronal chains of nanoclusters. Triflouorotoluene was used for cluster removal because it is a good solvent for solvated PFOEMA blocks.

In FIG. 20, the two curves essentially coincided with one another below c 6.0 mg/mL. This was most likely due to the fact that most polymer drawn into inter-fiber space was incorporated into a covalently grafted monolayer at low c's. Therefore, an extra solvent rinsing step was deemed non-essential if cotton was coated at c<6.0 mg/mL, and these coated fabrics, unless mentioned otherwise, were directly used for liquid contact angle measurements without being extracted.

Thinness of grafted layers was next determined. As mentioned above, a grafted P1 layer at saturation had a grafting density of ˜3.0 wt %. Specific surface area for cotton fabrics was estimated as follows: warp and weft thread diameters, dᵣ and d_{f}, were (270±10) and (620±10) μm, respectively. Using a fiber diameter dₒ of (10.0±15) μm and assuming hexagonal packing for fiber cross sections and thus a packing density of 90%, we calculated the fiber number Nᵣ in a warp thread to be

$${N}_{r} = \frac{{d}_{r}^{2}}{{d}_{0}^{2}} \times 90 \% = 656$$

Analogously, the number N_{f} of fibers per weft thread was calculated to be 3460. Since the numbers of warp and weft threads per square inch were 47 and 41, respectively, the total number of fibers per square inch was 656×47+3460×41=1.72×10⁵. Assuming a smooth surface for the fibers, the total surface area S for fibers per in² of fabric is

S=1.72×10⁵×πd₀×2.54=1370 cm²,

since the weight of each square inch of fabric is ˜110 mg. Thus, the specific surface area of cotton fabric was ˜1.25 m²/g.

Thickness of a fully grafted polymer layer was estimated as follows. The density ρ of a dried grafted P1 layer should be close to 1.91 g/cm³. A fully grafted P1 layer has a weight fraction of 3.0% in a fabric sample. This corresponds to 3.4 mg of grafted polymer per in² of fabric. The thickness h of this layer can be calculated from

h=3.4×10⁻³/(1.91×1370)=13×10⁻⁷ cm.

We performed a light scattering study of a sol-gelling P1 mixture after ammonia addition in order to determine sizes of polymer chains before ammonia addition and 5 min after ammonia addition. Hydrodynamic diameters were between 2 and 7 nm initially and increased to ˜20 nm 5 min after ammonia addition. We followed the change in light scattering intensity of 2.0 mL of a P1 solution in THF at 1.5 mg/mL as a function of time after 0.1 mL of 14-M ammonia solution was added. The data are plotted in FIG. 18 and show clearly that the intensity started to increase abruptly about 2 min after ammonia addition and consequent cluster formation. The results suggest that a saturated cluster population was reached about 3.5 min after ammonia addition. Also, the cluster size did not increase with sol-gel time because the clusters were shelled by PFOEMA.

Based on the above estimation methods, specific surface area of cotton fabrics was (1.3±1.0) m²/g, and density of a dried sol-gelled P1 layer was 1.91 g/cm³. Using these values, a grafted polymer layer thickness of (13±10) nm was calculated for a saturated layer. Thus, grafted layers were thin.

FIG. 17d shows an SEM image of cotton fibers coated under standard conditions. No obvious differences were discerned between these fibers and uncoated fibers shown in FIG. 17b. No obvious differences could be identified by AFM either. These results suggested that the coating was conformal and probably uniform. Unfortunately, it was difficult to determine using AFM or SEM a size increase of coated fibers and thus coating thickness, because grafted P1 layers were too thin and fiber cross sections had much variation in size and were not perfectly spherical. Anecdotal evidence supporting thinness of the coatings prepared under standard conditions was that the feel of coated fabrics, when touched by hand, did not change.

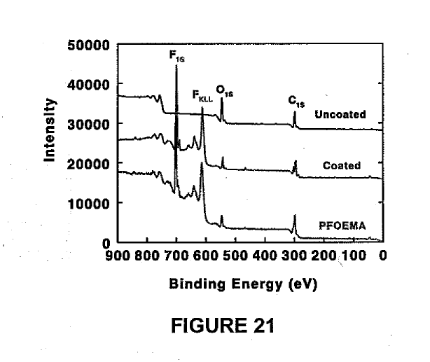

FIG. 21 compares X-ray photo-electron spectroscopic (XPS) spectra of cotton, P1-coated cotton, and a PFOEMA homopolymer. The latter two had almost identical spectra. This suggested that the PFOEMA block of grafted P1 formed an overlayer of the coating and was in agreement with the expected diblock monolayer structure, in which PIPSMA blocks grafted onto and crosslinked around cotton fibers and PFOEMA blocks stretched outwards.

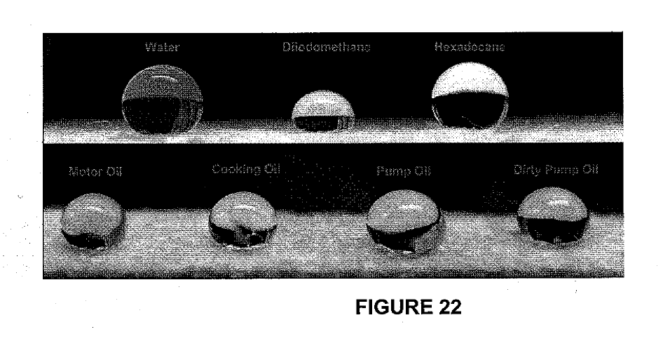

We next determined that, with PFOEMA as a coating overlayer, P1-coated cotton fabrics were amphiphobic. FIG. 22 shows photographs of droplets of different liquids on cotton fabrics that were coated under standard conditions at c=3.0 mg/mL. Water, diiodomethane, hexadecane, motor oil, cooking oil, pump oil, and used pump oil all beaded up with static contact angles of 164°, 153°, 155°, 154°, 156°, 157° and 152° on P1-coated cotton fabrics. It should be noted that droplets used for taking photographs in FIG. 22 were larger than droplets used in contact angle measurements. CH₂I₂ has a high density of 2.28 g/cm³ at 20° C. and its droplet flattened more than the others; aside from droplet deformation, CH₂I₂ droplets would sink more into cotton fabrics than other droplets due to yielding of cotton surface fibers under gravitational force of the droplets (Hoefnagels, H. F. et al., Langmuir, 2007, 23, 13158-13163; Zimmermann, J., Advanced Functional Materials, 2008, 18, 3662-3669).

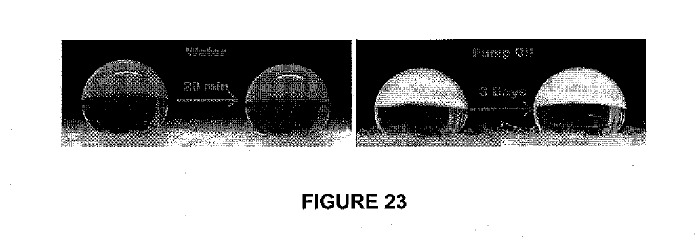

Interestingly, droplets maintained their shape and high contact angles for extended periods. For example, pump oil droplets remained beaded up on coated cotton for months without being absorbed or being drawn into inter-fiber spaces. FIG. 23 compares water and pump oil droplets on coated cotton immediately and 20 min and 3 days after they were applied. A picture was only taken 20 min after the water droplet was applied, not because it was more readily absorbed but because it evaporated over time. These results show that non-volatile liquid droplets could stay on coated cotton for months without being absorbed.

Stability of liquid droplets on coated cotton was in stark contrast to their behaviour on uncoated cotton. On uncoated fabrics, liquids spread and were absorbed within 5 s after their application. Stability of droplets on coated cotton suggested an insignificant surface reconstruction of grafted PFOEMA chains under the droplets, a feature previously attributed to stability of a liquid crystalline phase formed by surface perfluoroctyl groups of PFOEMA chains (Genzer, J. and Efimenko, K., Science, 2000, 290:2130-2133).

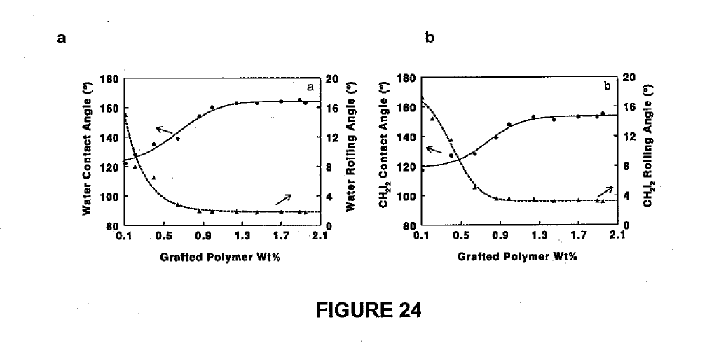

We next investigated the effect of changing grafted polymer amount. H₂O and CH₂I₂ contact angles were measured on cotton that was coated at c between 0.20 and 5.0 mg/mL. Results are shown in FIG. 24. Interestingly, H₂O and CH₂I₂ contact angles were already high at 122° and 117° and their droplets were already stable for >10 min on cotton at a grafted polymer amount of 0.09 wt %. Also, contact angles reached their apparent maximum values of 164° and 153°, respectively, at a grafted polymer amount of only ˜1.0 wt %.

Aside from high contact angles, H₂O and CH₂I₂ rolled readily on coated cotton fabrics. FIG. 24 also plots H₂O and CH₂I₂ rolling angles on coated cotton as a function of grafted polymer amount. Here a rolling angle refers to the minimal angle at which a cotton fabric was inclined to enable droplet rolling. Rolling angles decreased as grafted polymer amount increased. Angles stabilized at 1.8° and 3.1° for H₂O and CH₂I₂ droplets again above a grafted polymer amount of ˜1.0 wt %. These high oil and water contact angles and low liquid rolling angles indicate that cotton fabrics bearing >1.0 wt % grafted P1 were amphiphobic.

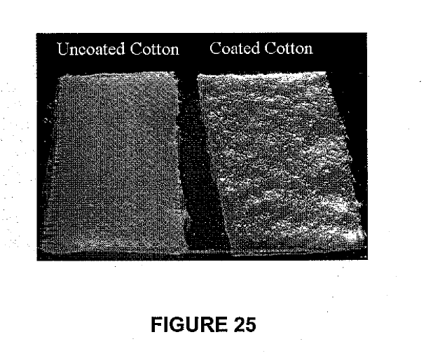

Plastron layer formation and stability were investigated. Amphiphobic cotton was highly water repellent and stayed afloat on water. After being forced into water, a layer of air or a plastron layer was trapped between the cotton and water. This is clearly seen in FIG. 25 where a photograph is shown for an uncoated and a coated cotton fabric submerged in water. While the plain-weave pattern of the fabric was discernible for uncoated cotton, this pattern was not seen for submerged coated fabric due to light reflection by a plastron layer. These plastron layers were retained after the fabrics were submerged in water for months.

Next, we tested washing resistance of a coating. Fabric samples were tested against reference samples to demonstrate durability of our coatings. Reference 1 samples consisted of cotton that was coated by fluorinated silica particles. Silica particles used were 325 nm in diameter, and fluorination was achieved by coating them with P1 using HCl as a catalyst. Analysis indicated that P1 formed a monolayer on the silica particles and that thickness of the grafted P1 layer on silica was 3.8 nm. To coat cotton, cotton fabrics were equilibrated with a silica dispersion in trifluorotoluene and then withdrawn from the coating solution and dried.

Reference 2 samples were obtained from coating cotton with a PFOEMA homopolymer, which had a targeted repeat unit number of 14 and a size-exclusion chromatography polydispersity index of 1.45 against polystyrene standards. The sample was again prepared by equilibrating cotton with a PFOEMA coating solution in trifluorotoluene and then withdrawing and drying the fabrics. These samples had a deposited PFOEMA homopolymer amount of 1.2 wt % as determined by TGA.

Immediately after their preparation, R1 and R2 samples were both amphiphobic, having water contact and rolling angles similar to those observed on P1-coated cotton fabrics.

After extracting R2 samples twice, each time for 15 min in trifluorotoluene, and drying them at 120° C., the water rolling angle on these surfaces increased from 2.5° to 8.1°. On the other hand, stirring P1-coated cotton fabrics in trifluorotoluene for 3 d did not change the water rolling angle noticeably. These results confirmed a durable and possibly covalent attachment of P1 to cotton fibers.

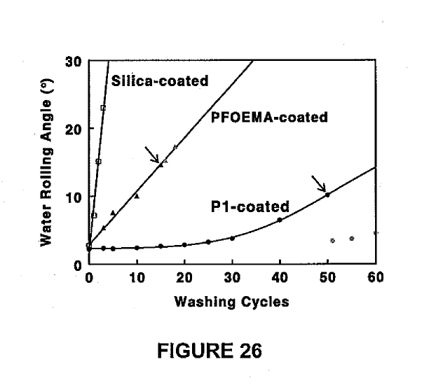

For each washing cycle, P1-coated fabrics as well as R1 and R2 samples were stirred with a 5.0 wt % detergent solution for 15 min and then rinsed with water and dried (Zimmermann, J. et al., Advanced Functional Materials, 2008, 18: 3662-3669). After going through this simulated washing cycle different times, water rolling angles were measured. FIG. 26 plots water rolling angle variation with washing cycles for the three groups of samples. Water rolling angle of R1 samples increased quickly because fluorinated silica particles adhered poorly to the cotton fabric. PFOEMA-coated samples fared better, but much worse than P1-coated fabrics. Water rolling angle barely changed after going through 30 washing cycles for P1-coated fabrics. Angle increased between 30 and 50 washing cycles. Deng et al. (Deng, B. et al., Advanced Materials, 2010, 22: 5473-5477) also reported a decrease in water contact angle on cotton fabrics coated by a grafted fluorinated homopolymer after the coated cotton was washed and discovered that detergent sorption on the coating was the main culprit for this. This was suspected as the cause for water rolling angle increase in our case. Thus, a variation was introduced to one of our washing cycles. This involved stirring P1-coated fabrics that had been washed 51 times with de-ionized water overnight. Upon drying this sample, water rolling angle decreased from 10.2° at cycle 50 to 3.4° at cycle 51, confirming our hypothesis. Since the same rinsing protocol was used in the later cycles, water rolling angle increased again. In contrast, stirring PFOEMA-coated fabrics in de-ionized water overnight after cycle 16 did not decrease water rolling angle at all. This suggested that PFOEMA removal during fabric washing was responsible for water rolling angle increase in this case.

Mechanical properties of coated fabrics were determined. Tensile strength and extension at break of coated and uncoated cotton fabrics were determined and compared, to decide if chemicals used during the coating process degraded and weakened the textiles. Table 2 compares results of such experiments for each sample tested, in triplicate. The data clearly show that stretching properties of coated cotton fabrics were comparable with those of uncoated fabrics. Thus, ammonia-containing media had an insignificant deteriorating effect on cotton.

TABLE 2
Comparison of stretching properties of uncoated and P1-coated cotton fabrics.

| | Uncoated Cotton | | | | Coated Cotton | | | |
|---|---|---|---|---|---|---|---|---|
| Properties | 1 | 2 | 3 | Aver. | 1 | 2 | 3 | Aver. |
| Tensile Strength [MPa] | 7.41 | 7.49 | 7.38 | 7.43 ± 0.05 | 7.40 | 7.29 | 7.35 | 7.35 ± 0.04 |
| Extension at Break [%] | 6.49 | 6.52 | 6.42 | 6.48 ± 0.04 | 6.30 | 6.23 | 6.28 | 6.27 ± 0.03 |

In sum, these experiments show that use of P1 to coat cotton fabrics yielded textiles that were highly oil and water repellent. The coating procedure was simple, in an exemplary embodiment, soaking for 1 min a fabric in a P1 and ammonia solution, blowing off most of the solvent from the fabric with a heating gun, and further annealing the fabric at 120° C. for 15 min. Over a P1 concentration range from 0.20 to 5.0 mg/mL, grafted polymer amount could be increased by increasing P1 concentration. Polymer was most likely grafted as an amphiphobic diblock copolymer monolayer, in which sol-gelling PIPSMA blocks anchored and crosslinked around cotton fibers and PFOEMA blocks stretched outwards. Existence of this fluorinated top layer was confirmed by X-ray photoelectron spectroscopy and by superb oil and water repellency of the coated cotton fabrics. Measurement of water and diiodomethane droplet contact and rolling angles at different grafted polymer amounts revealed that amphiphobic fabrics were obtained when grafted polymer amount reached ˜1.0 wt %. At grafted polymer amounts as low as 1.0 wt %, water, diiodomethane, hexadecane, cooking oil, and pump oil all had contact angles surpassing 150° on the coated cotton fabrics and rolled readily. The liquids were not drawn into the inter-fiber space by the coated fabrics. On amphiphobic cotton, cooking and pump oil droplets remained beaded for months without being absorbed, with minimal contact angle changes. Forcing amphiphobic cotton into water led to trapping of an air or plastron layer between the fabric and water, and this plastron layer was stable for months. In addition, the coating was highly durable against simulated washing in detergent solutions. Finally, amphiphobic properties were obtained at no or minimal cost to mechanical properties of the cotton fabric; in other words, coated cotton fabrics had mechanical properties substantially identical to those of uncoated cotton fabrics.

Alkaline resistance (pH 14) of coated cotton fabrics was also tested. Coated cotton was rinsed with methanol first (otherwise it floats on the surface of the solution during the test) and then put in an alkaline solution. This process allows the alkaline solution to soak into the textile. Samples were stirred for 4 days. We found that the coated cotton was stable, substantially without any hydrolysis, and water repellence remained excellent. In contrast, a piece of uncoated cotton was put in the same alkaline solution. Although the textile was not completely hydrolyzed, substantial changes in shape were observed and the uncoated textile became swollen after one day of stirring.

### Example 9

### Tests to Determine Properties of Amphiphobic Coatings

Properties of amphiphobic coatings may be determined using standardized techniques and methodologies known in the art, such as, for example, American Society for Testing and Materials International (ASTM) standard tests. Appropriate techniques and methodologies to be used, and desired parameters to be achieved, are chosen by a skilled artisan based on substrate, intended use of substrate, etc.

ASTM D6577 provides a standard guide for testing industrial protective coatings. Selection and use of test methods and procedures for evaluating general performance levels of coatings or coating systems on a given substrate, after exposure to a given type of environment, are described therein. As an example, water resistance of coatings is tested: in 100% relative humidity as described in ASTM D2247; using a water fog apparatus as described in ASTM D1735; and/or using a water immersion method as described in ASTM D870. As another example, solvent resistance is tested using solvent rubs as described in ASTM D5402. In an example, immersion testing is performed as described in D6943.

In another example, corrosion resistance is determined using a Salt Spray (Fog) Apparatus (ASTM B117), using test parameters described in ASTM standard B117.

In an example, stain resistance is determined using a nitric acid test as described in ASTM B136.

In another example, chemical resistance (e.g., acid resistance, base resistance, oil resistance, methyl ethyl ketone (MEK) resistance) is tested using a double rub method as described in ASTM D4752.

ASTM F1296 provides a standard guide for evaluating chemical protective clothing. In an example, in the case of amphiphobic block copolymer-coated fabrics to be used, e.g., for protective clothing, liquid penetration resistance is tested under a shower spray while on a mannequin as described in ASTM F1359. In another example, resistance to penetration by liquids of an amphiphobic block copolymer-coated fabric material is tested according to ASTM F903. As an example, an amphiphobic block copolymer-coated fabric is subjected to a test liquid for a specified time and pressure sequence. Resistance to visible penetration by the test liquid is determined with the liquid in continuous contact with the outside surface of the coated fabric. If the test liquid passes through the fabric, the material fails the test for resistance to penetration by the test liquid. In some penetration test apparatuses, the amphiphobic block copolymer-coated fabric may act as a partition separating a hazardous liquid chemical from the viewing side of a test cell. In an example, ASTM F739 is used to determine permeation under conditions of continuous contact with targeted chemicals, including liquids or gases. In another example, amphiphobic block copolymer-coated fabrics are tested as described in ASTM D751.

In an example, abrasion resistance for painted surfaces coated with amphiphobic coatings of the invention is tested using a Norman Tool “RCA” Abrader test as described in ASTM F2357.

The contents of ASTM standard guides and standard test methods mentioned herein are hereby incorporated by reference in their entireties.

### Example 10

### Preparation of PFOEMA-b-PCEMA

The scheme below shows reactions that were used to prepare PFOEMA-b-PHEMA, where PHEMA denotes poly(2-hydroxyethyl methacrylate). The first step involved PFOEMA preparation by atom transfer radical polymerization (ATRP). The prepared PFOEMA macro-initiator was then used to polymerize 2-(trimethylsilyloxy)ethyl methacrylate (HEMA-TMS) to yield PFOEMA-P(HEMA-TMS). The protecting trimethylsilyloxy group was removed by stirring PFOEMA-P(HEMA-TMS) in THF/methanol/water overnight to yield PFOEMA-b-PHEMA.

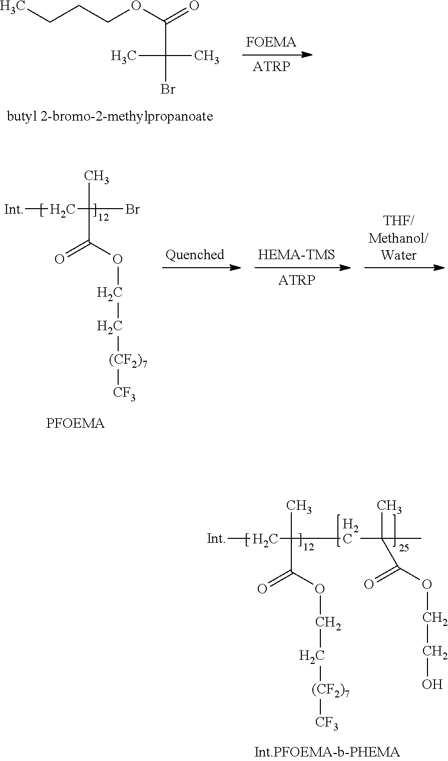

To synthesize PFOEMA-b-PCEMA, where PCEMA denotes poly(2-cinnamoyloxyethyl methacrylate), another reaction step was performed, involving reacting the hydroxyl groups of PFOEMA-b-PHEMA with excess cinnamoyl chloride.

Synthesis of PFOEMA.

FOEMA (0.37 mL), butyl 2-bromo-2-methylpropanoate 15.5 mg), trifluorotoluene (1.0 mL), anisole (0.5 mL), bipyridine (23 mg), and CuBr₂ (1.5 mg) were added into a round-bottomed Schlenk flask. The flask was bubbled with N₂ for ˜4 min before 10 mg of CuBr was added. This mixture was frozen in liquid nitrogen, pumped under vacuum, and thawed to room temperature. This freezing-pump-N₂ backfill-thaw procedure was repeated 4 times. The flask was then placed in a pre-heated oil bath at 85° C. for 1 h. The reaction was quenched by freezing the flask in liquid nitrogen and exposing it to air. After warming to room temperature, the mixture was passed through an alumina column to remove copper residues. The crude mixture was then dialysed to remove the anisole, TFT and left-over monomer. After concentrating to 2.0 mL via rotary evaporation, the mixture was then added into diethyl ether (20 mL) to precipitate the polymer. The precipitate was re-dissolved in 2.0 mL of THF, and the resultant solution was added into another 20 mL of diethyl ether to precipitate the polymer. This was followed by polymer drying under vacuum for 24 h to give 0.21 g of polymer at a 44% yield. ¹H NMR analysis indicated a repeat unit number of 12 for the polymer.

Synthesis of PFOEMA-b-PHEMA.

The PFOEMA macroinitiator (0.20 g), HEMA-TMS (0.25 mL), TFT (0.5 mL), anisole (0.5 mL), bipyridine (10 mg), and CuBr₂(0.5 mg) were added into a Schlenk flask. The mixture was bubbled with N₂ for 5 min before CuBr (4.5 mg) was added. The mixture was subjected to four freeze-pump-N₂ backfill-thaw cycles. After the mixture was stirred for 30 min at room temperature, the flask containing the mixture was immersed into a preheated oil bath at 65° C. for 4 h. The reaction was quenched by immersing the flask into liquid nitrogen and exposing the mixture to air. The crude sample was purified by filtration through a short pad of alumina. The TMS groups of PFOEMA-b-P(HEMA-TMS) were removed by hydrolysis in THF/methanol/water at v/v/v=30/5/1 overnight. The resultant mixture was then dialysed against THF to remove low molecular weight impurities. The dialysed solution was concentrated to 2 mL and was then transferred into a pre-weighed 6 mL flask and dried overnight. The final yield was 0.22 g or 55%. ¹H NMR analysis indicated that the number of repeat units was ˜50 for the PHEMA block. Size exclusion chromatography analysis yielded a polydispersity index of 1.20 for the amphiphobic diblock copolymer based on polystyrene standards.

PFOEMA-b-PCEMA.

PFOEMA-b-PHEMA, 0.10 g, was dispersed in 4 mL of dry pyridine. To it was added 60 mg of cinnamoyl chloride. The mixture was stirred at room temperature in the dark for 16 h before it was centrifuged to settle the pyridium chloride salt formed. The solution was concentrated to ˜1 mL by rota-evaporation and was added to 10 mL of diethyl ether to precipitate the polymer. After supernatant decantation, the solid was re-dissolved in 1 mL of THF and added into another 10 mL of diethyl ether to precipitate the polymer. This polymer re-dissolution and precipitation procedure was repeated once before the polymer was dried under vacuum overnight to yield 0.18 g of PFOEMA12-b-PCEMA-50 at 73% yield. SEC analysis yielded a polydispersity index of 1.2 based on PS standards for this sample.

### Example 11

### Cotton Coating by PFOEMA-b-PCEMA Using an Aqueous Process

PFOEMA-b-PCEMA (15 mg), surfactant poly(ethylene glycol) monolaurate (Mₙ=600 g/mol and 1.5 mg), dimethyl phthalate (1.5 mg), and THF (0.06 mL) were stirred for 10 min. To the mixture was then added dropwise 1.0 mL of water to yield a milky white emulsion. The mixture was stirred for 12 hours before a cotton swatch was immersed for 8 min. The resultant cotton was blown dry with a heat gun and then annealed in 120° C. for 60 min. This was followed with irradiating the cotton fabric on each side by a UV lamp for 40 min. After washing in water and drying, the cotton was found to be superhydrophobic.

### Example 12

### Synthesis and Application of an Amphiphobic Block Copolymer of Formula XIIb (S^{I}ₘ—(FL)ₙ-E)

We synthesized an amphiphobic block copolymer of Formula XIIIb (S^{I}ₘ—(FL)ₙ-E), where E is a 2-(perfluorooctyl)ethyl-bearing or FOE-bearing end group, FL is 2-(perfluorooctyl)ethyl methacrylate or FOEMA, and S^{I} is IPSMA.

Synthesis of the Initiator FOE-Br.

The initiator was prepared by reacting 2-(perfluorooctyl)ethanol with 2-bromoisobutyryl bromide. 2-(perfluorooctyl)ethanol, 1.46 g or 3.1 mmol, was dissolved in 4-mL dichloromethane. Triethylamine (1.3 molar equivalents or 0.58 mL) and 2-bromoisobutyryl bromide (0.465 mL, 3.7 mmol, or 1.2 equivalents) were added and the resultant mixture was stirred for 16 hours at room temperature. Water (5 mL) and an aqueous 0.5 M NaHCO₃ solution (2 mL) were added to the mixture. The mixture was extracted with dichloromethane, 20 mL each time, for a total of three times. The organic layer was combined and washed with a 1.0 M aqueous HCl solution to remove triethylamine if it existed. The rinsed organic layer was then dried on anhydrous sodium sulfate and was concentrated by rota-evaporation before being further evacuated under a mechanical pump overnight. This yielded 1.48 g of a highly viscous brownish liquid at 82% yield. ¹H NMR in CDCl₃ confirmed the structure and purity of the targeted compound FOE-Br.

Synthesis of FEO-(FOEMA)₁₃.

FOE-Br (21 mg, 0.034 mmol), FOEMA (0.38 mL, 18 molar equivalents), trifluorotoluene (0.6 mL), anisole (0.6 mL), bipyridine (16 mg, 3.0 equivalents), and CuBr₂ (˜0.5-0.6 mg) were added to a round-bottom Schlenk flask. The flask was bubbled with N₂ for ˜2 min before CuBr (5.8 mg or 1.2 molar equivalents relative to the initiator) was added. This mixture was frozen in liquid nitrogen, pumped under vacuum, thawed to room temperature, and back-filled with N₂. This free-pump-thaw-N₂ backfill procedure was repeated 4 times. The flask was then placed in a pre-heated oil bath at 85-87° C. for 1 hour. The reaction was quenched by freezing the flask in liquid nitrogen and exposing it to air. ¹H NMR analysis of the crude mixture indicated that the conversion of FOEMA was 66% at this stage. Thus, the number of repeat units for the FOEMA block was 13.

The crude polymer was dissolved in TFT (10 mL) and was then centrifuged at 3900 rpm (3050 g) for 10 min to remove the suspended particles. The supernatant was passed through a short pad of alumina column to remove the copper and the column was rinsed with 8 mL of TFT. The polymer solution (˜14 mL) was then dialysed against distilled THF (50 mL) that was changed 4 times over 2 days. The THF solution was then added into 100 mL of deionized water to precipitate the polymer. After vacuum drying overnight, 277 mg of FOE-FOEMA₁₃ was obtained. The structure of the polymer was confirmed by ¹H NMR analysis.

Synthesis of FOE-(FOEMA)₁₃-(IPSMA)₁₉.

FEO-(FOEMA)₁₃(100 mg, 0.014 mmol), IPSMA (0.11 mL or 20 molar equivalents), TFT (0.6 mL), and anisole (0.4 mL) were mixed in a Schlenk flask. To the flask were then added bipyridine (6.8 mg or 3 molar equivalents relative to FEO-(FOEMA)₁₃), and CuBr₂(˜0.2 mg). The mixture was bubbled with N₂ for 2 min before CuBr (3.0 mg or 1.3 equivalents) was added. The mixture was subjected to four freeze-pump-thaw-N₂ backfill cycles. After the mixture was stirred for 1 h at room temperature to re-dissolve FEO-(FOEMA)₁₃, the reaction flask was placed into a preheated oil bath at 64-67° C. for 3.5 hours. ¹H NMR analysis of the crude product at this stage indicated that 72% of IPSMA was converted and thus the repeat unit number for the PIPSMA block was expected to be 14.

The polymerization was quenched by immersing the flask into liquid nitrogen and exposing the mixture to air. The crude sample was dissolved in THF and was passed through a short pad of alumina. The THF solution of the polymer was concentrated to 3 mL and was added dropwise into 30 mL methanol. After centrifugation at 3900 rpm (3050 g), 102 mg of FOE-PFOEMA-b-PIPSMA was obtained.

¹H NMR analysis of the amphiphobic block copolymer indicated that the actual molar ratio between the FOEMA and IPSMA units was 13/19 rather than 13/14. This was probably due to the poor recovery of the prepared polymer (102 mg of copolymer vs. 100 mg of the first block). It is possible that polymer that was rich in PFOEMA was mostly lost during the column chromatography purification step. Polymer rich in FOEMA is known to be less soluble in THF and would be eluted more slowly than the PIPSMA-rich copolymer. Assuming that the PFOEMA block of the diblock copolymer was 13 repeat units long, the PIPSMA block should consist of 19 units. Thus, the polymer is denoted as FOE-(FOEMA)₁₃-(IPSMA)₁₉.

This Example demonstrates synthesis of an amphiphobic block copolymer using an E-bearing initiator, where the FL monomer is polymerized first and the S^{I} monomer is then polymerized. However, we note that amphiphobic block copolymers, e.g., of Formula XIIb, can also be prepared by alternative methods where S^{I} and FL monomers are polymerized in sequence and polymerization is terminated by an E-bearing terminator.

Cotton Coating by FOE-(FOEMA)₁₃-(IPSMA)₁₉.

FOE-(FOEMA)₁₃-(IPSMA)₁₉, 16 mg, was dissolved in 2 mL of distilled THF. 0.25 mL of a concentrated ammonia solution was then added. After 15 min, two cotton swatches, sized at ˜1.0×1.5 in², were immersed in the solution for 15 min. The cotton pieces were air dried at room temperature for 10-15 min. The coated pieces were then placed in an oven at 120° C. for 20 min. The coated cotton demonstrated superior water and diiodomethane repellency, compared to uncoated cotton (data not shown).

### Example 13

### Synthesis and Application of an Amphiphobic Block Copolymer of Formula XIIb (S^{I}ₘ—(FL)ₙ-E), where FL is 2-(perfluorohexyl)ethyl methacrylate

We synthesized another amphiphobic block copolymer of Formula XIIb (S^{I}ₘ—(FL)ₙ-E), where E is a 2-(perfluorooctyl)ethyl-bearing or FOE-bearing end group, FL is 2-(perfluorohexyl)ethyl methacrylate or F₆EMA, and S^{I} is IPSMA.

In this example, the procedure used to prepare the amphiphobic block copolymer was different from the one used in Example 12 above, as a one-pot synthesis procedure was used. The procedure is referred to as a one-pot synthesis because the first block (F₆EMA)₁₅ was not purified before the second monomer was added and polymerized. This procedure eliminated the purification step for the first block and also re-used the catalyst and ligand that were used for F₆EMA polymerization. The procedure is therefore advantageous for its economy. However, it is possible that the second block (the PIPSMA block) might not be pure, as it may contain some polymerized F₆EMA units, since the IPSMA monomer was added only after ˜80% of the F₆EMA monomer was polymerized and residual F₆EMA could therefore copolymerize with IPSMA. It was not desirable to wait until F₆EMA was fully polymerized before adding the IPSMA monomer, since this would be expected to decrease block copolymer yield and increase the yield of dimerized FOE-(F₆EMA)₁₄ chains. Despite this possible copolymer structure of the second block, the polymer is denoted here as FOE-(F₆EMA)₁₄-(IPSMA)₁₁ for convenience. However, we note that 1 or 2 F₆EMA units may be copolymerized with IPSMA. If 2 of the 14 F₆EMA units were copolymerized with IPSMA, then the correct notation for the amphiphobic block copolymer would be FOE-(F₆EMA)₁₂-(IPSMA_{85%}-r-F₆EMA_{15%})₁₃.

One-Pot Synthesis of FOE-(F₆EMA)₁₄-(IPSMA)₁₁.

The fluorinated initiator or FOE-Br (180 mg or 0.293 mmol), F₆EMA (1.27 mL or 15 molar equivalents), trifluorotoluene (1.6 mL), anisole (1.6 mL), bipyridine (137 mg, 3 equivalents), and CuBr₂(5 mg) were added into a round-bottomed Schlenk flask. The flask was bubbled with N₂ for ˜4 min before 50 mg (1.2 equivalents) of CuBr₂ was added. This mixture was frozen in liquid nitrogen, pumped under vacuum, thawed to room temperature, and back-filled with nitrogen. This free-pump-thaw-N₂ backfill procedure was repeated 4 times. The flask was then placed in a pre-heated oil bath at 85° C. for 75 min. ¹H NMR analysis of a sample taken at this stage showed that 80% of F₆EMA was polymerized. The oil bath temperature was lowered down to 65° C. over 15 min. Degassed IPSMA (2.1 mL or 20 equivalents) was added to the reaction flask and the resultant mixture was stirred at 65° C. for 3.2 hours. The polymerization was quenched by freezing the flask in liquid nitrogen and exposing it to air. ¹H NMR analysis of a sample taken at this stage indicated a 58% conversion for IPSMA. After warming to room temperature, and dilution with 15 mL of THF, the mixture was passed through an alumina column to remove the copper residues. The concentrated solution (5 mL) was then precipitated from methanol. The sample was redissolved in 2 mL of THF, and then re-precipitated into 20 mL of methanol. This dissolution and precipitation procedure was repeated another time before the polymer was dried under vacuum for 20 hours to yield a sticky solid. Overall amphiphobic block copolymer yield, calculated based on an IPSMA conversion of 58%, was ˜80%.

Cotton Coating by FOE-(F₆MA)₁₄-(IPSMA)₁₁.

FOE-(F₆MA)₁₄-(IPSMA)₁₁ (18 mg) was dissolved in 2.5 mL of distilled THF. 0.25 mL of saturated ammonia was then added. After 15 min, two cotton swatches sized at 1.0×0.7 in² were immersed in the solution for 15 min. The cotton pieces were air dried at room temperature for 10-15 min. The coated pieces were then placed in an oven at 120° C. for 20 min. The pieces were shown to possess superb water and dioodomethane repellency, compared to uncoated cotton (data not shown).

### Materials and Methods for Examples

### Materials

In an example, tetrahydrofuran (THF) was refluxed with potassium and a small amount of benzophenone until a deep purple color developed, and was distilled just before use. HCl (4.0 M in dioxane, Aldrich) was diluted with THF to 1.0 M or 0.2 M before use. The monomer IPSMA was synthesized using a known method (Ozaki, H. et al., Macromolecules, 1992, 25: 1391-1395). The monomer FOEMA (97%) and sec-butyllithium (1.4 M in cyclohexane) were purchased from Aldrich. FOEMA was purified by vacuum distillation over calcium hydride before use. Diphenyl ethylene (97%, Aldrich) was purified by distillation with sec-butyl lithium. Tetraethoxysilane (Aldrich, 99.0%), LiCl (Aldrich, 99.99+%), α,α,α-trifluorotoluene (TFT, Acros, 99+%), ammonia (Calcdon, 28˜30%), FOETREOS (Aldrich, 99.0%), and isopropanol (Fisher, 99.5%) were used as received.

### P1 Synthesis

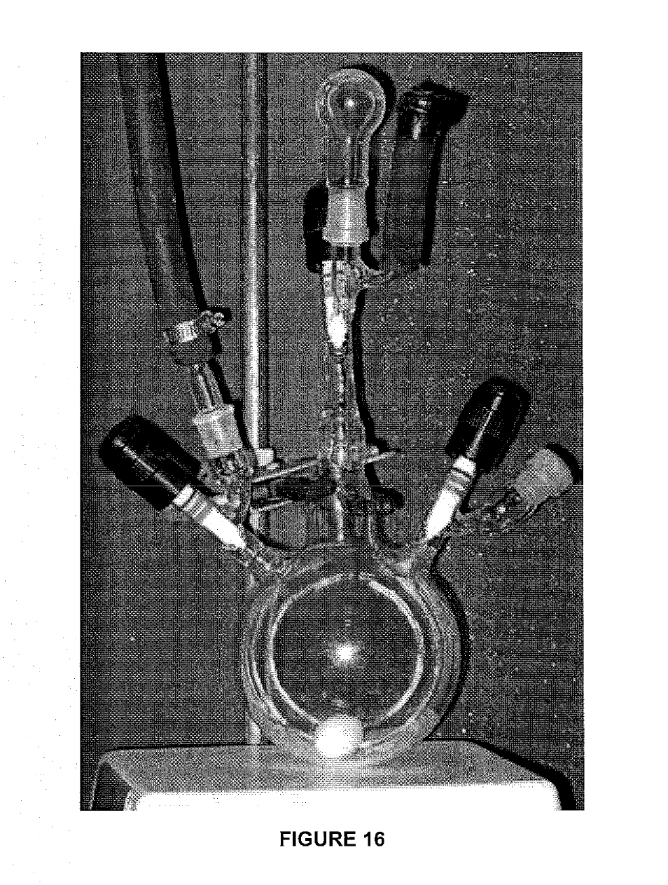

In an example, the amphiphobic block copolymer P1 was prepared by sequential anionic polymerization of IPSMA and FOEMA. Details of P1 preparation are as follows: The 500-mL polymerization flask shown in FIG. 16 was used and contained a magnetic stirrer. First added into this flask was 0.2 g of LiCl. Then, vacuum valves were opened and the system evacuated and flamed. After back-filling the system with argon, the right and top valves were closed and LiCl was pumped overnight. The flask was backfilled with high-purity argon again the next morning. This was followed by closing the left vacuum valve and disconnecting the flask from the vacuum manifold. THF, ˜250 mL, was collected, under Ar flow, into the flask via the right side joint from a THF still. After re-sealing the side joint with the rubber stopper and reconnecting the flask to the vacuum manifold, 0.19 mL of diphenyl ethylene (1.09 mmol) was injected through the rubber stopper into the flask. The flask was cooled in a dry ice/acetone bath, and 1.4-M sec-butyl lithium solution in cyclohexane was added, from a syringe, dropwise until a faint pink color stabilized. Then, 0.60 mL of sec-butyl lithium solution or 0.84 mmol of sec-butyl lithium was added in one aliquot. Fifteen minutes were allowed for the formation of 1,1-diphenyl-3-methyl pentyl lithium from the reaction between sec-butyl lithium and diphenyl ethylene before 2.6 mL (7.3 mmol) of freshly-distilled IPSMA was added dropwise. Two hours were allowed for IPSMA polymerization. This was followed by the addition of FOEMA, 2.6 mL or 7.8 mmol. Again 2 h were allowed for FOEMA polymerization before degassed methanol was added to terminate the polymerization. The resultant polymer solution was concentrated by rotary evaporation of THF. The concentrated polymer solution at ˜30 mL was dropped into 800 mL of methanol under vigorous stirring to yield 6.10 g of a white precipitate.

### Polymer Characterization

In an example, P1 was analyzed at 36° C. by size exclusion chromatography (SEC) using a Waters 515 system equipped with a Waters 2410 differential refractive index detector. The columns used were one Waters μ-Styragel 500 A column and two Waters Styragel HR 5E columns, and the chloroform eluant flow rate used was 0.4 mL/min. The system was calibrated by monodisperse polystyrene standards.

¹H NMR spectra of P1 were recorded on a Bruker Avance 500 MHz spectrometer. The solvent used was a mixture of TFT-d₅ and tetrahydrofuran-d₈ (THF-d₈) at v/v=3/1.

### Silica Particle Preparation

In an example, silica particles were synthesized using known methods (Sheen, Y. C. et al., J. Polym. Sci., Part B: Polym. Phys., 2008, 46: 1984-1990; Stober, W. et al., J. Colloid Interface Sci., 1968, 26: 62). Tetraethoxysilane (2.0 g) was dissolved into 21 mL of isopropanol to yield a homogeneous solution before 0.8 mL of an aqueous ammonia solution (28 wt %) was added with vigorous stirring. This mixture was refluxed at 60° C. for 4 h, and the resultant silica particles were settled by centrifugation for 10 min at 3050 g. After discarding the supernatant, the particles were redispersed into 10 mL of isopropanol. These particles were settled again by centrifugation, and separated from the supernatant by decantation. This rinsing process was repeated thrice, and the final particles were dried overnight under vacuum.

### Coating Silica Particles

In an example, silica coating by P1 was performed in TFT/THF using HCl as catalyst. The standard conditions employed a silica-to-P1 mass ratio of 1.00:0.080. The volume fraction of THF in the trifluorotoluene/THF solvent mixture was 9%, and the molar ratios used for IPSMA, H₂O, and HCl were 1:2:1. 8 h was allowed for the grafting reaction to proceed.

In an example run, 5.0 mg of dry silica particles was mixed with 3.0 mL of TFT in a 20 mL vial and ultrasonicated for 60 s to disperse the particles. To this dispersion was then added 0.080 mL of a 5.0-mg/mL P1 solution in THF, 0.14 mL of THF, 0.080 mL of HCl solution (1.0 M in THF), and 3.0 μL of H₂O. The mixture was stirred at room temperature for 8 h before it was centrifuged at 3050 g for 10 min to settle the particles. After the supernatant was removed, the particles were redispersed in 2.0 mL of TFT and centrifuged again to settle the particles and to remove the supernatant. The particles were rinsed once more to remove the catalyst, by-products, and any residual polymer that had not grafted. The particles were then vacuum-dried for 2 h in a 100° C. oven.

A similar procedure was used to prepare FOETREOS-coated silica particles. The silica-to-FOETREOS mass ratio used was also 1.00:0.080.

### Preparation of a Sol-Gelled P1 Sample

In an example, a P1 sample was allowed to undergo sol-gel reactions under conditions described herein, without silica. After the mixture was allowed to react for 8 h, it was centrifuged at 17,000 g for 10 min to settle the product. After the supernatant was removed, the product was redispersed into 2.0 mL of THF and centrifuged. This rinsing process was repeated once again before the product was dried under vacuum to yield a white powder, which comprised nanospheres possessing a PFOEMA corona and sol-gelled PISPMA core.

### Thermogravimetric Analyses

In an example, thermogravimetric analyses (TGA) were performed using a TA Q500 Instrument. A typical measurement involved heating a sample from room temperature to 650° C. at 10° C./min.

### Diffuse-Reflectance Fourier-Transform Infrared Analyses

In an example, diffuse-reflectance Fourier-transform infrared spectra were obtained for P1, silica particles, and P1-coated silica particles using a Varian 640-IR FT-IR spectrometer. The samples were first dried under vacuum and then ground with KBr using a mortar and pestle to yield a powder.

### X-Ray Photoelectron Spectroscopy

In an example, X-Ray photoelectron spectroscopy (XPS) measurements were performed using a Thermo Instruments Microlab 310F surface analysis system (Hastings, U.K.) under ultrahigh vacuum conditions. The Mg Kα X-ray source (1486.6 eV) was operated at a 15 kV anode potential with a 20 mA emission current. Scans were acquired in the Fixed Analyzer Transmission mode with a pass energy of 20 eV and a surface/detector take-off angle of 75°. Spectra were calibrated to the C₁s line at 285.0 eV, and minor charging effects were observed, which produced a binding energy increase between 1.0 and 2.0 eV. Background of the spectra were subtracted by using a Shirley fitting algorithm and a Powell peak-fitting algorithm (Liu, H. B. and Hamers, R. J., Surf. Sci., 1998, 416:354-362).

### Transmission Electron Microscopy

In an example, TFT solutions of silica particles were aero-sprayed onto carbon-coated copper grids and then dried under vacuum at room temperature for 2 h before transmission electron microscopy (TEM) observation. A Hitachi-7000 instrument was operated at 75 kV for obtaining images.

### Atomic Force Microscopy

In an example, specimen solutions were aero-sprayed onto silicon wafers. Samples were analyzed by tapping-mode atomic force microscopy (AFM) using a Veeco multimode instrument equipped with a Nanoscope IIIa controller. The Nanosensors NCHR-SPL AFM tips used had a tip radius of approximately 5 nm.

### Dynamic Light Scattering

In an example, dynamic light scattering (DLS) measurements were performed at 21° C. using a Brookhaven BI-200 SM instrument equipped with a BI-9000AT digital correlator and a He—Ne laser (632.8 nm). Silica particles were redispersed into methanol, and the P1-coated silica particles were redispersed into TFT for DLS characterization. Concentrations of the silica particles were approximately 0.5 mg/mL. The samples were centrifuged at 1250 g for 15 min for clarification. DLS measurements were performed at 90°, and the data were analyzed using the Cumulant method to determine the hydrodynamic diameters (dₙ) and polydispersity index (K₁²/K₂) values of the samples (Berne, B. J. and Pecora, R., Dynamic Light Scattering with Applications to Chemistry, Biology and Physics; Dover Publications, Inc.; Mineola, N.Y., 1976). The TFT refractive index and viscosity used in these calculations were 1.414 and 0.5505 mPa·S, respectively (DeLorenzi, L. et al., J. Chem. Eng. Data, 1996, 41:1121-1125).

### Superamphiphobic Films

In an example, P1- or FOETREOS-coated silica particles were redispersed into TFT at a concentration of 2.0 mg/mL. Microscope slide cover slips were coated by casting and evaporating several drops of the silica solution onto the slips. To coat printing paper (Lyreco), the paper was immersed into a P1-coated silica solution for 5 s and then withdrawn and dried under ambient conditions.

### Contact Angle Measurements

In an example, contact angles were measured at room temperature (˜21° C.). Static contact angles were measured using 5 μL droplets on a KRUSS K12 tensiometer that was interfaced with image-capturing software. Advancing and receding angles were determined by probing expanding and contracting liquid droplets, respectively. For each sample, contact angles were measured at 5-10 different positions, and the reported values were the averages of these measurements. The precision of these measurements was better than ±2°. Liquids that were used for contact angle measurements were Milli-Q water, diiodomethane (>99%, Sigma-Aldrich), vegetable cooking oil (Mazola), and hexadecane (>99%, Sigma-Aldrich).

### Robustness of P1-Coated Silica Films

In an example, to demonstrate better etching resistance of P1-coated silica particles, cover slips that were coated with films of either P1-coated or FOETREOS-coated silica particles were first wetted by ethanol by immersion in ethanol for ˜3 s. The microscope slides were then withdrawn and quickly immersed in a 1.0 M aqueous NaOH solution. After pre-designated times, films were removed, rinsed with deionized water, and dried under vacuum at 100° C. for 15 min. Contact angles of water droplets on these films were then measured.

### Fabric Coating

In an example, PIPSMA-b-PFOEMA (P1) was dissolved into distilled THF at concentrations ranging from 0.2 to 50 mg/mL. Cotton fabric swatches, 1.0-in² in size and weighing 110±3 mg, were cleaned by stirring at 300 rpm in 5.0 wt % Fisher Sparkleen detergent for 15 min. Swatches were then washed in 500 mL distilled water for 15 min with stirring (300 rpm) and the washing process was repeated for another three cycles before drying at 120° C. for 20 min. Coating solutions were prepared by mixing 2.00 mL P1 solution in THF with 0.10 mL 14-M ammonia. Five min after ammonia addition, a first fabric piece was immersed into the solution. It was removed 60 s later and blown dry for 30 s with hot air at −80° C. from a heat gun. This was followed by immersion of a second piece. This process was repeated until 10 pieces were obtained. Dried pieces were then placed together into an oven at 120° C. for 15 min.

To coat cotton fabric with a PFOEMA homopolymer with number-average molecular weight Mₙ=1.0×10⁴ and polydispersity index M_{w}/Mₙ=1.45 relative to PS standards, polymer was dissolved in trifluorotoluene at 1.5 mg/mL. Soaking time of cotton fabrics in this soaking solution was 5 min. The rest of the sample treatment procedure was the same as that used to coat cotton with P1. Gravimetric analysis indicated that 1.2 wt % of PFOEMA was physically deposited onto cotton fabric using this protocol.

Silica particles used were coated by P1 as described herein. Grafted polymer amount and thickness on silica was about 5.8 wt % and 3.8 nm, respectively. To coat cotton, fabric pieces of 1 in² each were equilibrated with a particle dispersion in trifluorotoluene at 5.0 mg/mL for 5 min before they were removed, dried with a heat gun for 30 s, and annealed in a 120° C. oven for 15 min.

### Sol-gelled P1 Nanoclusters and TGA for Fabric

In an example, to 4.0 mL of a P1 solution in THF at 5.0 mg/mL was added 0.2 mL 14-M ammonia hydroxide. After 10 h, the solution was added into 50 mL methanol and centrifuged at 3050 g for 10 min. After decanting the supernatant, the precipitate was washed with methanol thrice and then dried under vacuum overnight before use for TGA analysis.

For TGA analysis, coated fabric pieces weighing at least 60 mg were stirred in 15 mL of trifluorotoluene overnight, withdrawn, and dried by hot air for 30 s and then in a 120° C. oven for 15 min before they were used for TGA. TGA was performed using a TA Q500 Instrument in air, and involved heating samples from room temperature to 150° C. at 5° C./min, holding at 150° C. for 15 min, and increasing to 750° C. again at 5° C./min. The reported weight residual was normalized relative to that determined at 150° C.

### Contact Angle Measurements for Fabric

In an example, images of 5-μL droplets of water (Milli-Q), diiodomethane (>99%, Sigma-Aldrich), and hexadecane (>99%, Sigma-Aldrich) were captured at room temperature (21° C.) using a Kruss K12 tensiometer, and processed with Image J software (which came with the instrument) to yield contact angles. Images of motor oil (Motomaster Formula 1, 5W-30), cooking oil (Mazola), pump oil (Edwards ultragrade 19 oil) and used pump oil were captured by a Canon PowerShot A700 camera. The reported contact angle for each sample was an average of 10 measurements.

### Rolling Angle Measurements for Fabric

In an example, a cotton fabric was glued onto a glass slide with a double-sided adhesive tape. While one end of the glass plate was placed against a horizontal metal block, the other end was placed on top of a rotatable shaft of a vertical micrometer. After a droplet was applied, slope of the glass plate was gradually increased by changing the height of the micrometer shaft. When a droplet started to roll, the angle made by the fabric and the horizontal line was taken as the droplet rolling angle. For each sample, the reported value was an average from 10 runs measured at different locations on three fabrics.

### Simulated Fabric Washing

In an example, P1-, silica-, and PFOEMA-coated cotton fabrics were always washed together when possible. Washing was done in a 100 mL three-neck flask that contained 60 mL of a 5.0 wt % detergent aqueous solution and 5 balls that were made of folded aluminum foil and 1.0-cm in diameter. 300-rpm stirring was rendered by a hemispherical Teflon® blade that was 4.8 cm wide and 2.0 cm tall and lasted for 15 min. After detergent treatment, fabric pieces were flushed with running distilled water for 5 min and dried in a 120° C. oven for 20 min before they were used for surface property evaluation and/or subjected to a new cycle of washing. After 50 washing cycles for a cotton fabric sample coated using P1 under standard conditions and 15 washing cycles for a PFOEMA-coated sample, fabric pieces were stirred with a magnetic stirrer at 300 rpm in 500 mL de-ionized water for 24 h. This step was completed to remove physically sorbed detergent from P1 coating.

### Other Techniques for Analyzing Fabrics

In an example, surface morphologies of cotton fibers before and after coating were analyzed in tapping mode by a Veeco multimode AFM equipped with a Nanoscope 111a controller. X-Ray Photoelectron Spectroscopy (XPS) measurements were performed using a Thermo Instruments Microlab 310F surface analysis system (Hastings, U.K.). A Philips XL-30 ESEM FEG instrument was operated at 2 kV to obtain scanning electron microscopic (SEM) images after samples were coated by Au. Tensile strength was measured using fabric swatches that were 15.0 cm long and 2.0 cm wide and an Instron 3369 instrument at a strain rate of 10 mm/min. A standard ASTM D5035 protocol was used for measurement.

Although this invention is described in detail with reference to embodiments thereof, these embodiments are offered to illustrate but not to limit the invention. It is possible to make other embodiments that employ the principles of the invention and that fall within its spirit and scope as defined by the claims appended hereto.

The contents of all documents and references cited herein are hereby incorporated by reference in their entirety.

We claim:

1. An amphiphobic block copolymer comprising at least one fluorinated polymer block and at least one anchoring polymer block, wherein the at least one anchoring polymer block is capable of undergoing inter-polymer crosslinking, and optionally capable of covalently grafting with a substrate.

2. The amphiphobic block copolymer of claim 1, wherein the amphiphobic block copolymer is an amphiphobic diblock copolymer or an amphiphobic triblock copolymer.

3. (canceled)

4. The amphiphobic block copolymer of claim 1, wherein the at least one anchoring polymer block comprises: a grafting unit; or a sol-gel forming unit that is capable of undergoing inter-polymer crosslinking and covalently grafting with a substrate.

5. (canceled)

6. The amphiphobic block copolymer of claim 1, wherein the at least one anchoring polymer block comprises a crosslinkable unit which is photocrosslinkable, crosslinkable by sol-gel formation, thermo crosslinkable, redox crosslinkable, UV-crosslinkable, and/or requires an additive for crosslinking.

7. (canceled)

8. The amphiphobic block copolymer of claim 1, wherein the amphiphobic block copolymer further comprises an end group (E) at the terminus of the at least one fluorinated polymer block.

9. The amphiphobic block copolymer of claim 8, wherein E is fluorinated alkyl, CF₃(CF₂)₇CH₂CH₂, CF₃(CF₂)₅CH₂CH₂, C₈F₁₇(CH₂)₂O(CH₂)₃, CF₃(CF₂)₇CH₂CH₂OOCCH(CH₃), CF₃(CF₂)₅CH₂CH₂OOCCH(CH₃), CF₃(CF₂)₇CH₂CH₂OOCC(CH₃)₂, CF₃(CF₂)₅CH₂CH₂OOCC(CH₃)₂, H, OH, NH₂, SH, CO₂H, glycidyl, ketone, alkyl, ester, aldehyde, an adamantane group, a cyclodextrin group, an azobenzene group, Br, or Cl.

10. The amphiphobic block copolymer of claim 1, wherein the at least one fluorinated polymer block comprises: 2-(perfluorooctyl)ethyl methacrylate (FOEMA); 2-(perfluorohexyl)ethyl methacrylate; fluorinated poly(alkyl acrylate); fluorinated poly(alkyl methacrylate); fluorinated poly(aryl acrylate); fluorinated poly(aryl methacrylate); fluorinated polystyrene; fluorinated poly(alkyl styrene); fluorinated poly(α-methyl styrene); fluorinated poly(alkyl α-methyl styrene); poly(tetrafluoroethylene); poly(hexafluoropropylene); fluorinated poly(alkyl acrylamide); fluorinated poly(vinyl alkyl ether); fluorinated poly(vinyl pyridine); fluorinated polyether; fluorinated polyester or fluorinated polyamide.

11. (canceled)

12. The amphiphobic block copolymer of claim 1, wherein the amphiphobic block copolymer has the structure shown in Formula X:
Aₘ-(FL)ₙE (X)
wherein A is an anchoring monomer unit; FL is a fluorinated monomer unit; E is an optional end group; m is 1 or greater than 1; and n is 1 or greater than 1; and
wherein A is capable of undergoing inter-polymer crosslinking, and optionally capable of covalently grafting with a substrate.

13. The amphiphobic block copolymer of claim 1, wherein the amphiphobic block copolymer has the structure shown in Formula XI:
(Xₓ-G_{100%-x})ₘ-(FL)ₙ-E (XI)
wherein X is a monomer unit that can undergo inter-polymer crosslinking; G is a grafting unit that can undergo a grafting reaction with a substrate; FL is a fluorinated monomer unit; E is an optional end group; x is from 0% to 100%; m is 1 or greater than 1; and n is 1 or greater than 1.

14. The amphiphobic block copolymer of claim 13, wherein x is 1% or greater and less than 100%.

15. The amphiphobic block copolymer of claim 13, wherein G is selected from the group consisting of anhydrides, acrylates, methacrylates, acid chlorides, glycidyl groups, silyl halide groups, epoxide groups, isocyanate groups and succinimide groups.

16. (canceled)

17. The amphiphobic block copolymer of claim 1, wherein the amphiphobic block copolymer has the structure shown in Formula XIIa:
(S^{I1}ₓ—S^{I2}_{100%-x})ₘ-(FL)ₙ-E (XIIa)
wherein S^{I1} and S^{I2} are sol-gel forming monomer units that can undergo inter-polymer crosslinking, and S^{I1} and S^{I2} are the same or different; FL is a fluorinated monomer unit; E is an optional end group; x is from 0% to 100%; m is 1 or greater than 1; and n is 1 or greater than 1.

18. The amphiphobic block copolymer of claim 17, wherein (S^{I1}ₓ—S^{I2}_{100%-x})ₘ has the formula: 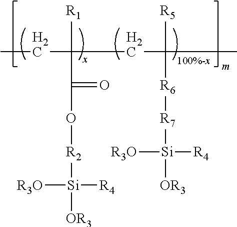
wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring, or methylene; x is from 0% to 100% or x is greater than 1%; and m is 1 or greater than 1.

19. The amphiphobic block copolymer of claim 17, wherein S^{I1} and S^{I2} are the same.

20. The amphiphobic block copolymer of claim 17, wherein S^{I1} and S^{I2} are different.

21. The amphiphobic block copolymer of claim 19, wherein the amphiphobic block copolymer has the structure shown in Formula XIIb:
S^{I}ₘ—(FL)ₙ-E (XIIb)
wherein S^{I} is a sol-gel forming monomer unit that can undergo inter-polymer crosslinking; FL is a fluorinated monomer unit; E is an optional end group; m is 1 or greater than 1; and n is 1 or greater than 1.

22. The amphiphobic block copolymer of claim 1, wherein the amphiphobic block copolymer has the structure shown in Formula I:
(S^{I}ₖ—Xₗ)ₘ—(FL)ₙ-E (I)
wherein S^{I} is a sol-gel forming monomer unit that can undergo inter-polymer crosslinking, X is a monomer unit that can undergo inter-polymer crosslinking, and S^{I} and X are not the same when both are present;
FL is a fluorinated monomer unit;
E is an optional end group;
m is 1 or greater than 1;
l is 0, 1 or greater than 1, k is 0, 1 or greater than 1, and l and k are not both zero; and
n is 1 or greater than 1.

23. The amphiphobic block copolymer of claim 22, wherein:
(i) 1<k<200;
(ii) 1<l<200;
(iii) 1<m<200;
(iv) 1<n<200;
(v) l is 0 and k is 1 or greater than 1;
(vi) m>>1, k<l and l=100%−k;
(vii) m is 10, n is 10, or both m and n are 10;
(viii) k is 0 and l is 1 or greater than 1; or
(ix) m is 1 or greater than 1; n is 1 or greater than 1; l is 1 or greater than 1; and k is 1 or greater than 1.

24-31. (canceled)

32. The amphiphobic block copolymer of claim 12, wherein A, X, S^{I1}, S^{I2} and/or S^{I} is photocrosslinkable, crosslinkable by sol-gel formation, thermo crosslinkable, redox crosslinkable, UV-crosslinkable, and/or requires an additive for crosslinking.

33. (canceled)

34. The amphiphobic block copolymer of claim 12, wherein E is fluorinated alkyl, CF₃(CF₂)₇CH₂CH₂, C₈Fᵢ₇(CH₂)₂—O—(CH₂)₃, alkyl, ester, H, Br or Cl.

35. The amphiphobic block copolymer of claim 22, wherein S^{I} is a trialkoxysilane-containing unit, a dialkoxysilane-containing unit, or an IPSMA (3-(triisopropyloxysilyl)propyl methacrylate) unit.

36. (canceled)

37. The amphiphobic block copolymer of claim 22, wherein X is 2-cinnamoyloxyethyl methacrylate (CEMA) or 2-cinnamoyloxyethyl acrylate (CEA).

38. The amphiphobic block copolymer of claim 12, wherein FL is 2-(perfluorooctyl)ethyl methacrylate (FOEMA).

39. (canceled)

40. The amphiphobic block copolymer of claim 38, wherein E is fluorinated, CF₃(CF₂)₇CH₂CH₂, or C₈F₁₇(CH₂)₂O(CH₂)₃.

41. (canceled)

42. The amphiphobic block copolymer of claim 12, wherein E is not fluorinated, alkyl, H, Br, or Cl.

43. The amphiphobic block copolymer of claim 22, wherein the amphiphobic block copolymer has the structure of Formula II:
S^{I}ₖ—(FL)ₙ-E (II)
wherein n is 1 or greater than 1; and k is 1 or greater than 1.

44. The amphiphobic block copolymer of claim 43, wherein the amphiphobic block copolymer comprises PIPSMA-b-PFOEMA.

45. The amphiphobic block copolymer of claim 22, wherein the amphiphobic block copolymer has the structure of Formula III:
Xₗ(FL)ₙ-E (III)
wherein n is 1 or greater than 1; and l is 1 or greater than 1.

46. The amphiphobic block copolymer of claim 45, wherein the amphiphobic block copolymer comprises PCEMA-b-PFOEMA.

47. The amphiphobic block copolymer of claim 22, wherein the amphiphobic block copolymer has the structure of Formula IV:
S^{I}ₖ—Xₗ—(FL)ₙ-E (IV)
wherein n is 1 or greater than 1; l is 1 or greater than 1; and k is 1 or greater than 1.

48. The amphiphobic block copolymer of claim 1, wherein the amphiphobic block copolymer comprises PIPSMA-b-PCEMA-b-PF₈H₂MA.

49. An amphiphobic block copolymer comprising the structure of PIPSMA-b-PFOEMA: 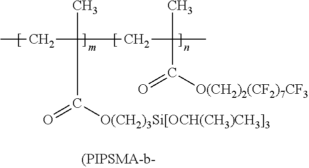
wherein m is 1 or greater than 1 and n is 1 or greater than 1.

50. An amphiphobic block copolymer comprising the structure of P(IPSMA-r-CEMA)-b-PFOEMA, where: 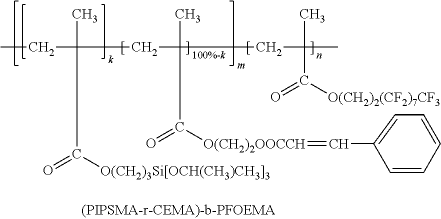
wherein m is 1 or greater than 1; n is 1 or greater than 1; k is from 0% to 100%; and r denotes random.

51. The amphiphobic block copolymer of claim 21,
wherein:
E is not present;
S^{I} has the structure shown in Formula VI: 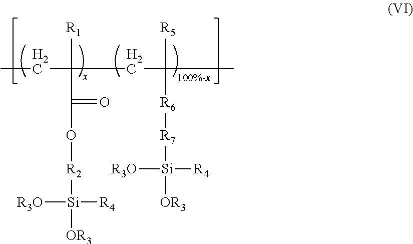
wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; and R₆ is an aromatic ring, pyridine ring, pyran ring, furan ring or methylene;
FL is (heptadecafluorooctyl)ethyl methacrylate;
1<m<200;
1<n<200; and
x is between 0 and 100%.

52. The amphiphobic block copolymer of claim 51, wherein S^{I} is 3-(triisopropyloxysilyl)propyl methacrylate.

53. The amphiphobic block copolymer of claim 1, wherein the at least one crosslinkable polymer block comprises a polyacetal polymer, a polyacrolein polymer, a poly(methyl isopropenyl ketone) polymer, a poly(vinyl methyl ketone) polymer, an aldehyde-terminated poly(ethylene glycol) polymer, a carbonylimidazole-activated polymer, a carbonyldiimidazole-terminated poly(ethylene glycol) polymer, a poly(acrylic anhydride) polymer, a poly(alkalene oxide/maleic anhydride) copolymer, a poly(azelaic anhydride) polymer, a poly(butadiene/maleic anhydride) copolymer, a poly(ethylene/maleic anhydride) copolymer, a poly(maleic anhydride) polymer, a poly(maleic anhydride/1-octadecene) copolymer, a poly(vinyl methyl ether/maleic anhydride) copolymer, a poly(styrene/maleic anhydride) copolymer, a poly(acrylolyl chloride) polymer, a poly(methacryloyl chloride) polymer, a chlorine-terminated polydimethylsiloxane polymer, a polyethylene-chlorinated polymer, a polyisoprene-chlorinated polymer, a polypropylene-chlorinated polymer, a poly(vinyl chloride) polymer, an epoxy-terminated polymer, an epoxide-terminated poly(ethylene glycol) polymer, an isocyanate-terminated polymer, an isocyanate-terminated poly(ethylene glycol) polymer, an oxirane functional polymer, a poly(glycidyl methacrylate) polymer, a hydrazide-functional polymer, a poly(acrylic hydrazide/methyl acrylate) copolymer, a succinimidyl ester polymer, a succinimidyl ester-terminated poly(ethylene glycol) polymer, a tresylate-activated polymer, a tresylate-terminated poly(ethylene glycol) polymer, a vinyl sulfone-terminated polymer and/or a vinyl sulfone-terminated poly(ethylene glycol) polymer.

54. The amphiphobic block copolymer of claim 53, wherein at least one monomer unit in the crosslinkable polymer block is photocrosslinkable.

55. The amphiphobic block copolymer of claim 1, wherein at least one monomer unit in the crosslinkable polymer block is a trialkoxysilane-bearing block or trialkoxysilane.

56-124. (canceled)
